(19) United States
(12) Patent Application Publication
(10) Pub. No.: US 2007/0262140 A1
(43) Pub. Date: Nov. 15, 2007

(54) Apparatus, System, and Method for Delivering Products or Services

(76) Inventor: Kenneth W. Long SR., Monroe, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/673,571

(22) Filed: Feb. 10, 2007

Related U.S. Application Data
(63) Continuation-in-part of application No. 11/624,497, filed on Jan. 18, 2007.
Application No. 11/624,497 is a continuation of application No. 11/347,728, filed on Feb. 3, 2006, now Pat. No. 7,182,253.
(60) Provisional application No. 60/649,828, filed on Feb. 3, 2005.

(51) Int. Cl. G06K 5/00

(52) U.S. Cl. 235/380

(57) ABSTRACT

Various embodiments of the present invention are directed to a system, method, and apparatus for offering products and services based, at least in part, on a continually updating analysis of user accounts held by commercial enterprises such as banks, credit card companies, media service providers, insurance companies, and other institutions that maintain user accounts that are subject to periodic transactions. One embodiment is directed to a system comprising a processor and a memory for storing data coupled to the processor, wherein the memory includes a user account comprising user data, user account data, and relationship data. The processor is configured for calculating a risk score based at least in part on the user data, user account data, or relationship data. The processor is further configured for outputting a set of products or services based at least in part on the risk score. In some embodiments, the processor is configured for calculating an account valuation score based at least in part on the user data, user account data, or relationship data. The processor may then price the set of products or services based at least in part on the account valuation score.

### CROSS-REFERENCE TO RELATED APPLICATIONS

This application is a continuation-in-part of U.S. application Ser. No. 11/624,497 filed Jan. 18, 2007, which is a continuation of U.S. application Ser. No. 11/347,728, filed Feb. 3, 2006, which claims priority from U.S. Provisional Application No. 60/649,828, filed on Feb. 3, 2005, each of which are hereby incorporated herein in their entirety by reference.

### BACKGROUND OF THE INVENTION

As information technology continues to expand and flourish, and as new legislation continues to be enacted to address this growing technology, the banks and other commercial enterprises must also diversify their methods and products to sustain and/or expand their customer bases. Accordingly, it is desirable to develop new products and systems that will provide these results.

Periodically accessible transaction accounts (e.g., checking account, savings account, brokerage account, credit card account, etc.) are significant commercial products. The checking account, for example, is to most people the primary repository of net earnings from month to month. As such, checks and debits drawn against the account represent the life style that account holder can afford, or at least the lifestyle they are trying to afford. The same might also be said for other types of accounts such as credit card accounts. Transactions that occur via these accounts represent life events. For example, checking or credit card transactions may be tied to a child's college tuition payments, a mother's funeral, a young couple's first down payment on a new house, alimony, court settlements, groceries, tithes to churches, etc. Millions upon millions of real life events pass through the bank's reader-sorters in tangible form every night.

Commercial enterprises have much invested in making their consumer transaction accounts cost effective, easy to use, and necessary. For example, over the years, the checking account has evolved from passbooks, to checks, to personalized checks, paper drafts, paperless payments (ACH), automatic payroll deposit, interest on checking, overdraft credit lines, debit cards, online banking/bill payment, free checking, toasters, from simple to complex service charge routines, automatic transfers to savings, etc. These efforts have resulted in the increasing complexity and commoditization of checking accounts. Outside of traditional banking, this commoditization continues with the granting of checking account powers to credit unions, savings banks, and brokerage houses. Now, most any commercial enterprise can offer a consumer transaction account.

In view of the above, it has become imperative for banks and other commercial enterprises to provide consumers with transaction accounts having an enhanced value. It is further desirable for such commercial enterprises to provide systems and technologies related to transaction accounts that guide the consumer into behaviors that provide enhanced value to the enterprise. It would be desirable then to provide an apparatus, system, and or method for providing products and/or services that is based at least in part on consumer account transaction activity.

### BRIEF SUMMARY OF THE INVENTION

Various embodiments of the present invention are directed to a system, method, and apparatus for offering products and services based, at least in part, on a continually updating analysis of user accounts held by commercial enterprises such as banks, credit card companies, media service providers, insurance companies, and other institutions that maintain user accounts that are subject to periodic transactions. For purposes of the foregoing specification and appended claims, the term “products” may include financial products, insurance products, consumer products, and the like while the term “services” may include financial services, insurance services, consumer services, and the like. Further, the phrase “products or services” shall refer to a single product, a single service, two or more products alone, two or more services alone, and one or more products combined with one or more services.

One embodiment of the present invention is directed to a system comprising a processor and a memory for storing data coupled to the processor, wherein the memory includes a user account comprising user data, user account data, and relationship data. The processor is configured for calculating a risk score based at least in part on the user data, user account data, or relationship data. The processor is further configured for outputting a set of products or services based at least in part on the risk score. In some embodiments, the processor is configured for calculating an account valuation score based at least in part on the user data, user account data, or relationship data. The processor may then price the set of products or services based at least in part on the account valuation score.

The “user data” may include the following user information: name, address, social security number, credit score, gender, marital status, dependant information, email address information, phone number, primary preferred language, and other user-related information.

The “user account data” may include the following account (e.g., checking, savings, credit card, mortgage, line of credit, other loan, brokerage account, product account, services account, etc.) information: account number, account name, account type, statement date, statement period, number of time intervals (hours, days, weeks, months, quarters, etc.) in the period, beginning balance, ending balance, average available balance for period, average daily balance for period, number of deposit transactions for period, amount of deposit transactions for period, number of deposit transactions by teller for period, amount of deposit transactions by teller for period, number of direct deposit transactions for period, amount of direct deposit transactions for period, number of automated teller (“ATM”) deposit transactions for period, amount of ATM deposit transactions for period, number of debit transactions for period, amount of debit transactions for period, number of debit transactions by check for period, amount of debit transactions by check for period, number of OLB/ACH transactions for period, amount of OLB/ACH transactions for period, number of signature based transactions for period, amount of signature based transactions for period, number of personal identification number (“PIN”) based transactions for period, amount of PIN based transactions for period, interest paid for period, service charge for period, E-statement receipt, and the like.

The relationship data may include data related to the breadth and scope of a user's relationship with the enterprise that holds the user's account such as a multi-product indicator, savings account indicator, credit card indicator, mortgage indicator, line of credit indicator, other loan indicator, investment indicator, insurance indicator, insurance product information, and the like. The relationship data may also include data related to the breadth and scope of a user's relationship to various third parties, which may include commercial partners (i.e., advertisers, trade association members, etc.) or other affiliated parties. Relationship data may include: the total number of third parties engaged, number of third parties engaged per period, number of third party transactions per period, frequency of third party transactions per period, product category indicators for third party transactions, service category indicators for third party transactions, and the like.

Another embodiment of the invention is directed to a method comprising the steps of: establishing a user account comprised of user data, user account data, and relationship data; calculating a risk score based at least in part on the user data, user account data, or relationship data; and outputting a set of products or services based at least in part on the risk score. In another embodiment, the method may further comprise calculating an account valuation score based at least in part on the user data, user account data, or relationship data and pricing the set of products or services based at least in part on the account valuation score.

Another embodiment of the invention is directed to a system and product that includes the use of a bank checking account that can be connected to insurance coverage. For example, a banking consumer can purchase insurance coverage for unexpected events that may affect the historical deposits and withdrawals relating to the checking accounts. Additionally, insurance coverage other than that of the checking account itself can be included, such as life insurance, so long as the account remains active. Accordingly, the present embodiment can integrate the purchase of insurance into a positive banking experience.

This embodiment allows account holders to purchase through the checking account, insurance coverage that provides for the continuation of the account's historic deposit levels, for a time they deem appropriate, in the event of unforeseen life emergencies. Additionally, the present embodiment can be completely automated and accessible through the Internet, such as through a centralized database.

The above presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that are presented below.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an exemplary diagram of components for an apparatus structured in accordance with one embodiment of the present invention;

FIG. 2 is a schematic illustration of a SASP™ system structured in accordance with one embodiment of the present invention;

FIG. 3 is a schematic illustration of a consumer profile creation process structured in accordance with one embodiment of the present invention;

FIG. 4 is a schematic illustration of an electronic statement or eCatalog creation process structured in accordance with one embodiment of the present invention;

FIG. 5 is a schematic illustration of an online system interface for a bank or other enterprise structured in accordance with one embodiment of the present invention;

FIG. 6 is a schematic illustration of a periodic electronic statement or eCatalog creation process structured in accordance with one embodiment of the present invention;

FIG. 7 is a schematic illustration of a data flow process for a bank or other enterprise structured in accordance with one embodiment of the present invention;

FIG. 8 is a schematic illustration of a “point-click-buy” system interface structured in accordance with one embodiment of the present invention;

FIG. 9 is a schematic illustration of an earned credits process structured in accordance with one embodiment of the present invention;

FIG. 10 is a schematic illustration of a streaming video process flow structured in accordance with one embodiment of the present invention;

FIG. 11 is a schematic illustration of a checking account system structured in accordance with one embodiment of the present invention;

FIG. 12 is a schematic illustration of an account data center structured in accordance with one embodiment of the present invention;

FIG. 13 is a schematic illustration of a checking account system structured in accordance with yet another embodiment of the present invention;

FIGS. 14-21 collectively illustrate a sample account statement or Catalog produced in accordance with various embodiments of the present invention;

FIGS. 22-56 collectively provide additional descriptions of various embodiments of the present invention;

FIGS. 57-72 collectively provide additional descriptions of various embodiments of the present invention;

FIGS. 73-146 collectively provide additional descriptions of various embodiments of the present invention; and

FIGS. 147-157 collectively provide additional descriptions of various embodiments of the present invention.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be apparent in view of this disclosure, various embodiments of the present invention may be embodied as a computer program product. Accordingly, such embodiments may take the form of an entirely hardware embodiment, an entirely software embodiment or an embodiment combining software and hardware aspects. Furthermore, the present invention may take the form of a computer program product on a computer-readable storage medium having computer-readable program code means embodied in the storage medium. More particularly, the present invention may take the form of web-implanted computer software. Any suitable computer-readable storage medium may be utilized including hard disks, CD-ROMs, optical storage devices, or magnetic storage devices.

The present invention is described herein with reference to various decision criteria, guidelines, functions, and algorithms. It will be understood that each decision criterion, guideline, rule, function, or algorithm, can be implemented by computer program instructions. These computer program instructions may be loaded onto a general purpose computer, special purpose computer, or other programmable data processing apparatus to produce a machine, such that instructions that are executed on the computer or other programmable data processing apparatus create means for implementing the function or functions specified above.

These computer program instructions may also be stored in a computer-readable memory that can direct a computer or other programmable data processing apparatus to function in a particular manner. For example, instructions stored in the computer-readable memory may provide a computer implemented system or method for offering products and services based, at least in part, on a continually updating analysis of user account associated data. The computer program instructions may also be loaded onto a computer or other programmable data processing apparatus to cause a series of operational steps to be performed on the computer or other programmable apparatus to produce a computer implemented process such that the instructions that execute on the computer or programmable apparatus provide steps for implementing the function specified.

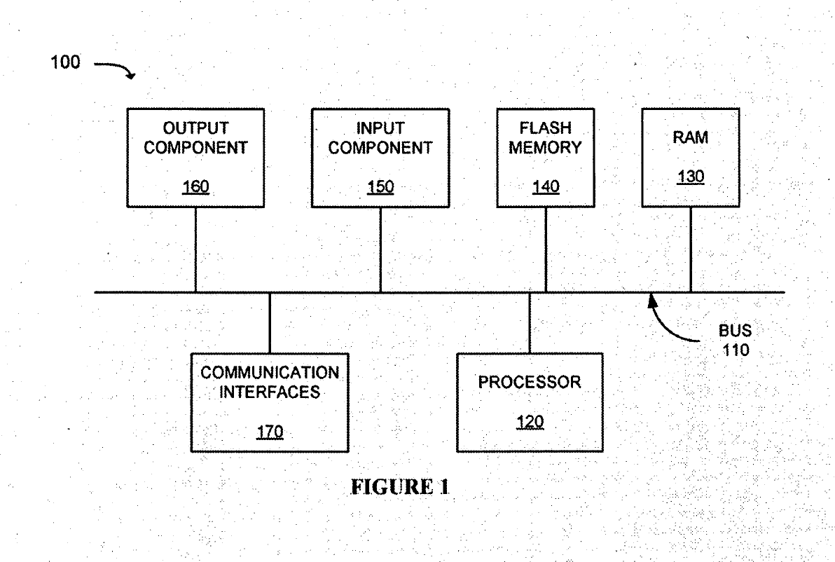

FIG. 1 is an exemplary diagram of components for an apparatus 100 structured in accordance with various embodiments of the present invention. The apparatus 100 may include a bus 110, a processor 120, a random access memory 130, a flash memory 140, an input component 150, an output component 160, and communication interfaces 170. Bus 110 may include a path that permits communication among the elements of the apparatus 100.

Processor 120 may include a processor, microprocessor, or processing logic that may interpret and execute instructions. RAM 130 may include any type of dynamic storage device that may store information and instructions for execution by processor 120. Flash memory 140 may include any type of non-volatile storage device that may store information for use by processor 120.

Input component 150 may include a mechanism that permits an operator to input information to the apparatus 100, such as a button, switch, input key, etc. Output component 160 may include a mechanism that outputs information to the operator, such as a display, one or more light emitting diodes (LEDs), a speaker, a report, a print-out, etc. Communication interfaces 170 may include any transceiver-like mechanisms that enable the apparatus 100 to communicate with other devices and/or systems. For example, communication interfaces 170 may include one or more Ethernet interfaces, optical interfaces, coaxial interfaces, or the like.

As will be apparent in view of the present disclosure, apparatus 100 may perform one or more of the steps, methods and operations described through the present specification. The apparatus 100 may perform these methods and/or operations in response to processor 120 executing software instructions contained in a computer-readable medium, such as RAM 130. A computer-readable medium may be defined as a physical or logical memory device and/or carrier wave.

The software instructions may be read into RAM 130 from another computer-readable medium, such as flash memory 140, or from another device via communication interfaces 170. The software instructions contained in RAM 130 may cause processor 120 to perform processes described above or those set forth in the drawings and figures accompanying the present specification. Alternatively, hardwired circuitry may be used in place of or in combination with software instructions to implement processes described herein. Thus, implementations described herein are not limited to any specific combination of hardware circuitry and software.

Various embodiments of the present invention are directed to a system comprising a processor and a memory for storing data coupled to the processor, wherein the memory includes a user account comprising user data, user account data, and relationship data. In one embodiment, the processor is configured for calculating a risk score based at least in part on the user data, user account data, or relationship data. In another embodiment, the processor may be configured for outputting a set of products or services based at least in part on the risk score. In some embodiments, the processor is configured for calculating an account valuation score based at least in part on the user data, user account data, or relationship data. The processor may then price the set of products or services based at least in part on the account valuation score.

As noted above, the accounts discussed herein may be any account that is periodically accessed by a user and through which the user may conduct various transactions. Accounts of this type are commonly held by commercial enterprises such as banks, credit card companies, media service providers, insurance companies, brokerage houses, mortgage companies, and the like.

In some embodiments, as referred to periodically herein for illustration purposes, a system, method, and/or apparatus is provided for offering products and/or services based, at least in part, on a continuing analysis of a consumer checking account held by a bank. Various benefits and advantages may be achieved though adoption of such embodiments as described, for illustration purposes, in the exemplary Checking Account Analytics Overview provided below. As will be apparent to one of ordinary skill in the art, the benefits and advantages described below may be realized through application of the present invention to various additional types of user accounts. Thus, the present invention is not limited to application with checking accounts.

### Checking Account Analytics Overview

In one embodiment of the present invention, analytics are applied that continuously value a consumer's core account with a bank, namely, the traditional checking account. Through this valuation a “checking account earned credits value” is established and a “risk score” for a particular consumer is defined. Based at least in part on these two factors and using a predetermined formula selected by the bank, systems structured in accordance with various embodiments of the invention may calculated a consumer's earned purchase credits for use in offsetting the cost associated with income continuation protection, other risk protection products, security solutions, and/or other products or services (including third party products or services) offered by or though the bank. In this regard, various embodiments of the present invention deliver products and services that have real value to the consumer while also guiding consumer behavior toward goals preferred by the bank as discussed in greater detail below.

Banks and other institutions that adopt one or more embodiments of the present invention may be afforded at least two powerful tools (e.g., earned purchase credits and income continuation protection) to form a new social contract between the consumer and the financial institution. The act of providing “rainy day” protection for the consumer is significant for the bank and for the consumer.

Adoption of various embodiments of the present invention provides a convergence of banking and risk at the consumer level that forms a durable relationship with the consumer and opens the door to a whole new family of revenue opportunities, which were never before available to the bank. Embodiments of the present invention provide technology, products, and services that allow banks and other financial institutions to use consumer and small business checking account checks and deposits and credit card transaction histories to create an account level deposit value (e.g., an account valuation score) and insurable risk score (e.g., risk score). In one exemplary embodiment, a bank can use a consumer's need for household/income stream protection and other risk coverage as a strategic marketing tool in the acquisition of new customers, deposit growth, the retention of existing relationships, and the generation of fee income. These benefits may be realized within the framework of an enhanced customer experience at the most commoditized of banking touch points—the checking account.

Various embodiments of the present invention reengineer the bank statement channel to become a primary marketing channel. More particularly, in one embodiment, a continually updating analysis of a checking account is undertaken to calculate earned purchase credits and a risk score based on an individual bank's checking account value structure. The bank may offer its customer a self-administered, highly-personalized, personal risk/insurance offer (point, click, and buy) at that critical point when they are most apt to consider such protection. The account level personalization of the bank statement channel as a marketing opportunity is a breakthrough in financial services. The blending of risk products and banking as integrated pieces of the customer's financial life also creates convergence in the mind of the consumer.

Today's consumers of financial services have higher expectations of banks than previous generations and also define banking differently. They see the need for banking services and insurance products but not necessarily the need for traditional banking or insurance company agent relationships. Various embodiments of the present invention provide a quantum shift in how banks might attempt to distribute insurance products. An efficient (point, click, and buy) delivery of unique household income protection products may be provided that is tied to the value of a consumer's deposits and which triggers an association in the mind of the consumer to consider the bank as a primary source for additional insurance needs. Various embodiments also provide a framework for the bank or other institution to participate in the profits of risk as well as commissions.

In one embodiment, SASP™ (Secondary Applications Services Platform) uses novel technology that encompasses a variety of disciplines including banking, information technology, marketing, and insurance risk management. SASP™ may include four distinct lines of business: 1) the Business of Scoring Income-Risk; 2) the Business of Privately Insuring Checking Accounts; 3) the Bank Statement Channel Marketing Business; and 4) the Risk Marketplace Business/the Profit Opportunity.

### The Business of Scoring Income-Risk

Various embodiments of the invention use transaction data derived from conventional consumer demand deposit accounts in combination with commercially available data sources and various demographic factors characterizing individual households. A unique scoring methodology is provided to characterize loss-of-income risk across various households. Unlike prior art risk methodologies that measure consumer default risk in a static manner using historical credit information, various embodiments of the present invention use an income-risk scoring methodology that captures consumer risk in real time using the continuously-updated consumer transaction data. This income-risk score permits the bank to price loss-of-income insurance protection and other insurance products quickly and accurately, while dynamically updating the pricing of such risk in real time at the individual and household levels.

### The Business of Privately Insuring Checking Accounts

The Federal Deposit Insurance Corporation insures deposit accounts against bank failure. Why not insure these accounts against temporary account holder failure?

In one embodiment, income continuation is offered to client banks as a co-branded bank group insurance product. The group insurance base coverage allows affordable premiums and avoids the problem of anti-selection and rejected applications that are problematic for individual products. Various embodiments of the present invention may be applied by banks to custom design their own benefit matrix in line with their strategic marketing objectives. Each bank can then say that their version of income protection (deposit stream history) and/or check and payment coverage (e.g. on-line bill pay incentive coverage) is unique.

Income continuation protects the normal consumer income/transaction stream from unforeseen events such as job loss, death of breadwinner, or physical disability. Unlike traditional income disability insurance policies, income continuation buy-ups in accordance with various embodiments of the invention are priced in real-time based at least partially on an individual's risk score. The premium that is paid by the consumer for buy-ups is calculated periodically to readjust the premium to the current status of that consumer.

The income continuation benefit summary that accompanies each monthly personal risk assessment shows depositors how to earn income insurance purchase credits from the bank to offset the total cost of insurance protection. Varying directly with the depth and breath of client relationship, these purchase or “reward” credits promote more effective cross-selling efforts by the bank or other institution while providing a tangible economic benefit to each retail customer segment that is priced and rewarded in line with their value to the institution.

### The Bank Statement Channel Marketing Business

Various digital print, templating, advanced Web and eBook presentation tools may be used in accordance with various embodiments of the invention to create a personalized customer experience that can replace or compliment a traditional bank statement. Such embodiments of the invention transform traditional monthly statements into a full-featured consumer marketing and communications vehicle that expands and contracts monthly in accordance with varying product promotions and the degree to which the account holder has migrated to the more cost effective, interactive on-line channels. Basic components of such embodiments might include:
Streaming video presentations for product education and point, click, and buy;
Monthly summary of purchase/earnings credits earned and account activity;
Recent bank announcements and news updates by local market;
A personalized loss-of-income risk assessment and various insurance options that each deposit household can use to hedge this risk; and
A variety of third-party merchandising announcements and local and national retailer coupons that feature different products and services uniquely presented to each deposit household.

Rather than the typical, third-party direct mail offers and inserts that accompany most deposit account statements, a Statement Marketing Service (SMS™) designed in accordance with various embodiments of the invention may fully integrate the five design elements listed above into a single, attractive, professional document that can be delivered in either hard-copy or electronic form at the discretion of the depositor or the bank. As a dynamic marketing document, the merchandising opportunities and promotional offers presented to consumers in the SMS™ may be uniquely tailored for each household on the basis of recent household transaction data that is associated with an account. Consumer acceptance of these promotional offers may be enabled by a series of simple point-and-click hyperlink protocols that are embedded directly within the body of the statement. In addition, the SMS™ may be configured to possess a unique look and feel for strong brand recognition and customer acceptance.

### The Risk Marketplace Business/The Profit Opportunity

In one embodiment, a single insurer may be used to retain a portion of the risk for banks or other institutions that implement various embodiments of the invention. However, in other embodiments, “risk scoring” analytics may be used to provide a novel electronic marketplace, organized as a competitive-call auction environment, where insurance underwriters and other financial institutions can bid to offer loss-of-income insurance protection to various aggregations of consumer households. To facilitate accurate and competitive pricing of risk across market participants, individual households may be graded and packaged into homogeneous risk pools. Such pools may be further subdivided according to geographic location and host depository institution. Potential underwriters can bid for participation in these new financial instruments.

Additional exemplary embodiments of the present invention are described, for illustration purposes, in the exemplary Executive Overview provided below. As will be apparent to one of ordinary skill in the art, the benefits and advantages described below may be realized through application of the present invention to various types of consumer accounts and are not limited to those listed.

### Executive Overview

Various embodiments of the invention may be used to assist mid-size and smaller financial institutions to more effectively compete with the cutthroat pricing and savvy marketing tactics of the mega-banks and non-banks through a solution that provides a superior value proposition to the consumer and small business customer.

In a climate of “industry convergence,” various embodiments of the invention may help financial institutions reinforce and, if needed, re-establish their position as the preferred source for all financial products and services to the consumer and small business customer. As described in greater detail below, professional marketing, web marketplace, and eCommerce solutions may be leveraged to provide a distinct way for financial institutions to win the war of industry convergence and effectively compete with the mega-banks and non-banks, such as Wal-Mart, that are now aggressively vying for the financial services business of the retail and small business customer.

Several embodiments of the present invention operate to value a consumer's checking account. Through this valuation the institution may establish credits to offset or lower the cost to protect and secure the consumer's checking account cash flow needs thereby opening the door to a whole new family of financial product and service sales opportunities. In this regard, the institution can create a new social contract and a powerful bond with the consumer to the financial institution.

By offering a superior value proposition, banks or other institutions that apply embodiments of the present invention may achieve greater success at reaching their organizational growth and cost-reduction objectives. They may also further enhance their position in their respective communities as a premier supplier of financial services to the consumer and small business customer. Various embodiments of the present invention focus on transforming such institutions from transaction processors to financial services marketing companies. Upon doing so, institutions may realize one or more of the following benefits:
New organic deposit growth
New fee income growth
Increased online banking adoption
Increased online bill pay adoption
Reduced operational costs through the reduction of paper check processing and statement mailing
More product and service cross sales
Increased customer loyalty and retention
Significant market differentiation

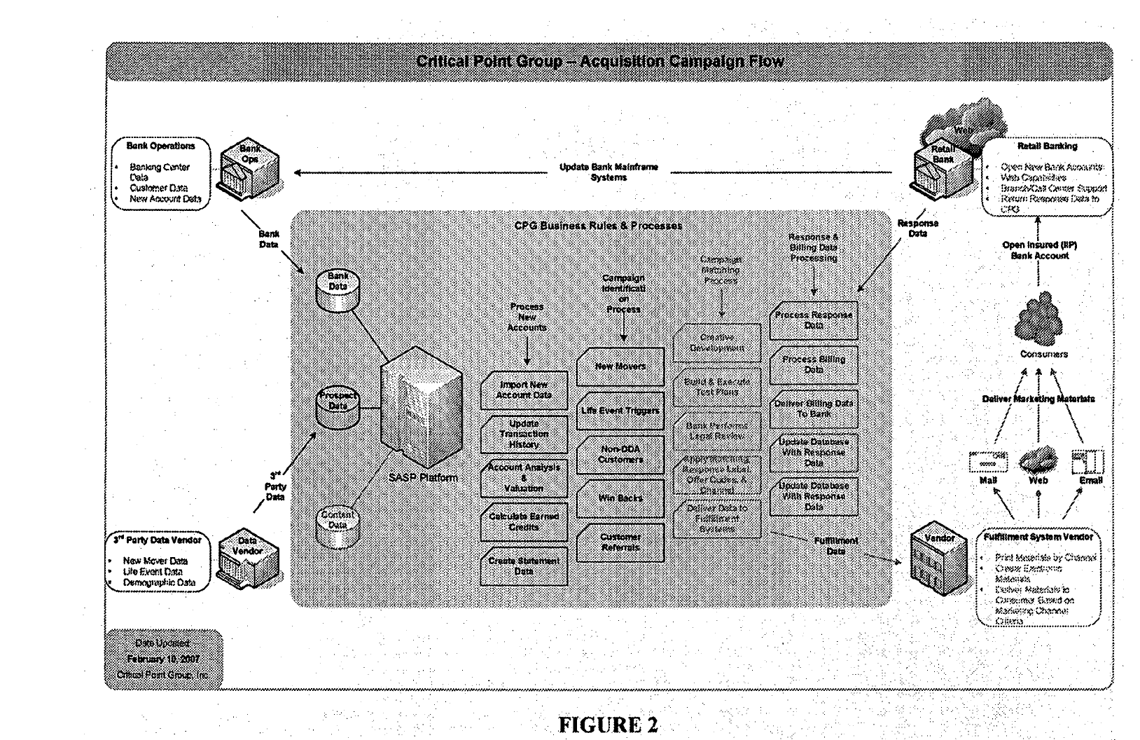

Various embodiments of the present invention allow a bank or other institution to leverage a core checking account to the bank and customer's advantage. In one embodiment, a Secondary Application Services Platform (SASP™) extracts specific checking account data in order to perform extended checking account analysis. FIG. 2 is a schematic flow diagram by which user data, user account data, and/or relationship data may be acquired and processed in accordance with various embodiments of the invention. In the depicted embodiment, data is acquired from a Bank Operations Center, a Retail Banking Branch, a 3^{rd} Party Data Vendor (e.g., insurance company, risk management company, underwriter, etc.), and a Vendor of products or services that are intended to be offered by or through the bank.

As noted above, two important values may be developed from the provided data: 1) an account valuation score, which may be a measure of the account's value to the bank; and 2) a risk score for the account. Based at least partially on this information, various embodiments of the present invention allocate earned purchase credits to offset or lower the cost of products and/or services that may be offered by the bank or other third party vendors such as, for example, income interruption protection solutions. Earned purchase credits and other incentives may be used for more income interruption protection coverage or other products and services and assist to develop highly effective strategic marketing campaigns based on an institution's strategic objectives.

At least one embodiment of the present invention comprises six (6) major components delivered through an outsourced SASP™ system. The six components include: 1) an insured checking account program (income interruption protection) that provides emergency fund protection of the customer's cash flow with the occurrence of specific negative life events; 2) account analysis, as described above, that is used to offer products or services such as, for example, income interruption protection base insurance coverage at little or no cost to the customer by offering a valuable risk score for improved crediting decisions and creating risk pool classification for the secondary re-insurance market; 3) secondary banking and non-banking products and services that a financial institution may not offer but which many customers want and need; 4) an effective set of professional choreographed marketing programs to draw customers to cost-efficient online banking and bill pay platforms, and other strategic organizational objectives such as those illustrated by the exemplary Marketplace eCatalog discussed below; 5) a powerful Internet hosted marketplace to effectively promote products and services, and an eCommerce delivery platform to address the convenience and 24/7 requirements of today's increasingly internet-dependent, post-modern consumer; and 6) professional technology, project management, and marketing support services.

The consumer has two basic financial services needs. First, consumers need the ability to transact their business. The checking account addresses this basic need very well. Second, consumers require a way to insure their assets. Various embodiments of the present invention address this need in a novel way—through income interruption protection solutions.

Income interruption protection may provide an institution the ability to offer a cash flow protection checking account solution that secures the consumer's income in the event of a job loss, temporary disability, or death of a breadwinner. In one embodiment, income interruption protection may provide a low cost, high-value solution that allows checking account customers the flexibility to acquire up to $10,000 of coverage per month, for up to six months. Income interruption protection may turn a negative situation into a positive by enabling customers to protect their income in the event of an unforeseen negative occurrence (e.g., job loss, death of a breadwinner, etc.). By providing the customer with a level of temporary income interruption protection, various embodiments of the invention help reduce the number of customers that would otherwise become delinquent on their loan payments and be turned over to collection departments or agencies. This may reduce collection costs and charge-offs for financial institutions and also increase customer loyalty and retention rates. Each institution's distinct version of income interruption protection can significantly differentiate the respective institution from the competition. More importantly, such protection may create a new social contract and special bond with the customer.

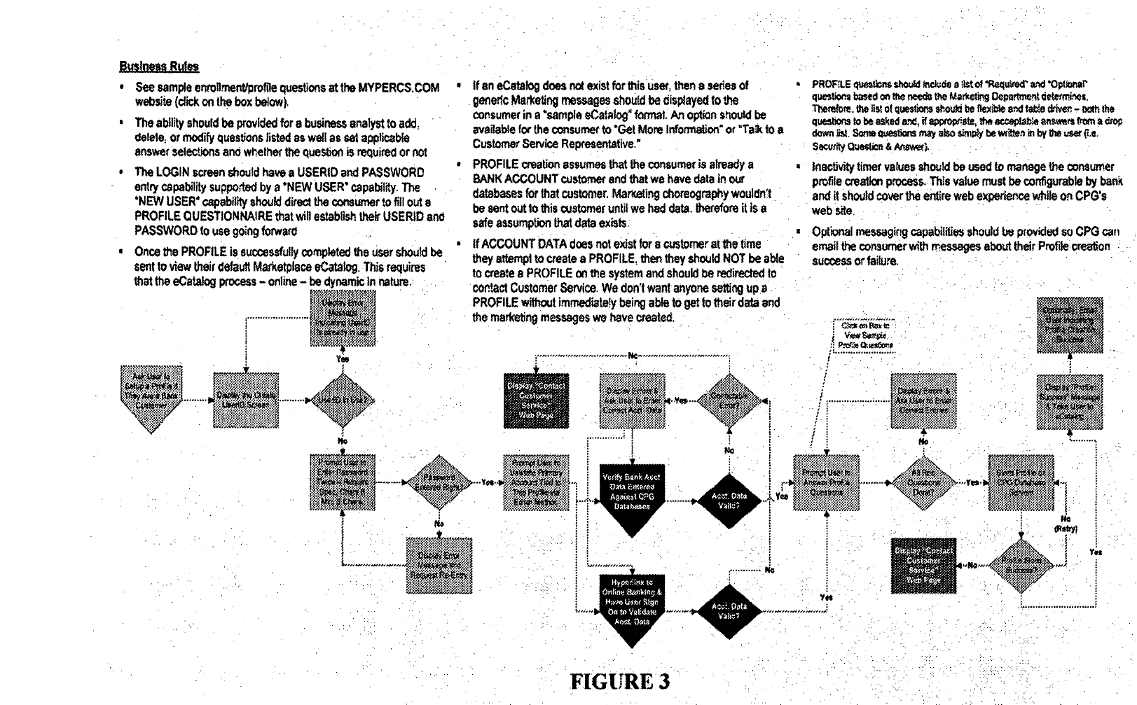

In yet another embodiment, a SASP™ system and consumer account analysis module analyzes and calculates earned purchase credits for each consumer checking account(s) based on account characteristics, such as average available balance and transaction types. Based on an institution's strategic objectives, various embodiments of the invention may apply all or some of these available earnings credits towards vesting the cost of the income interruption protection coverage for the customer's account. The longer they remain as customers and the more earnings credits they accumulate, the more an institution might offset the premium cost of this protection. Earnings credits enable institutions to provide a new valuable checking account feature to its customers, at little or no cost. In one embodiment, existing bank customers may establish consumer or user profiles to be used by the SASP™ system through the process schematically outlined for illustration purposes in FIG. 3.

One objective of various embodiments of the invention is to provide customers with effective reasons to change or modify their banking behavior to meet a bank or other institution's objectives. For example, studies show that customers who pay their bills online are much more profitable customers. They tend to establish multiple product/service relationships and higher deposit balance levels. Most importantly, they tend to be much more loyal and far less likely to change financial institutions.

In one embodiment, an institution may elect to offer additional income interruption protection as an incentive for a customer's use of online banking and bill pay platforms. Alternatively, institutions may elect to offer income interruption protection coverage for all electronic transactions at no premium or a discounted premium. Platforms structured in accordance with embodiments of the invention provide the flexibility needed to leverage earned credits as a valuable incentive for the customer's use and adoption of your desired banking services.

In some embodiments, eCommerce platforms provide institutions the ability to offer any low cost secondary product and/or service through an eCommerce “point, click, and buy” platform. Exemplary products and services may include without limitation:
Income Interruption Protection Solutions
Identity Theft Insurance
Incremental Term Insurance
Supplemental Prescription Drug Insurance
Health Savings Accounts
401K (Deposits Stay in Your Financial Institution)
Stored Value (Gift) Cards
Local Small Business Products and Services
Regional and National Consumer Retail Products
Commercial Payroll
Commercial Cash Management

In one embodiment, a private labeled and branded eCatalog (also referred to as a Marketplace eCatalog that may be produced via the SMS™ noted above) is hosted by a server outside an institution's firewall thereby serving as a web marketplace source for customers and as the launching point to an institution's website for customers to view detailed information on their accounts, institution products and services, enrollment, etc. It is also the location from which the customer launches to secondary product and service websites to “point, click, and buy” other valuable products, services, or to access and print valuable coupon offers from local small businesses and national retailers.

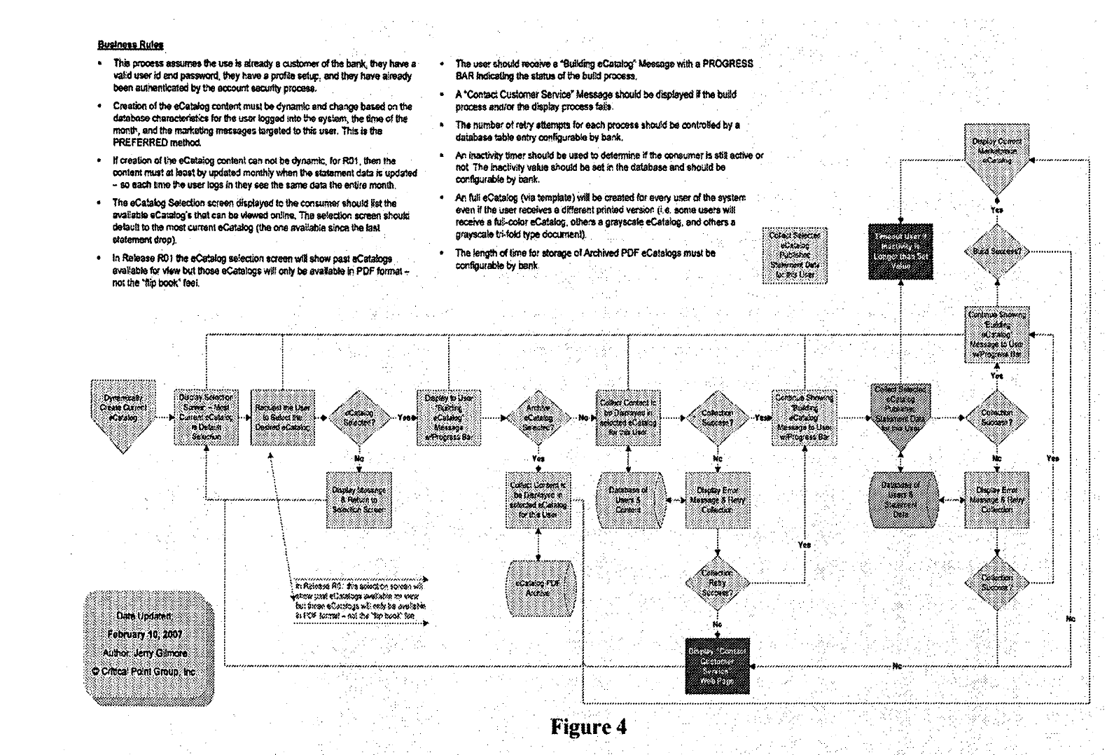

FIG. 4 is a schematic flow diagram illustrating one exemplary process by which an eCatalog may be created in accordance with one embodiment of the invention. Once established, eCatalogs may be structured to provide the following features without limitation:
Customizable Web Marketplace “views” for each customer and/or different classes of customers
Optional inclusion of Checking Account Courtesy Statement (replaces costly mailed statement)
Income Interruption Protection Coverage Summary and Analysis
Current Earned Purchase Credits Summary and Statement
Easy access videos for product promotion and training
Customized offers for products and services
Tailored offers for secondary products and services (e.g., non-competing insurance and investment products, and other third party products and/or services)
Special coupon offers from local and national retailers
Information and news about the institution

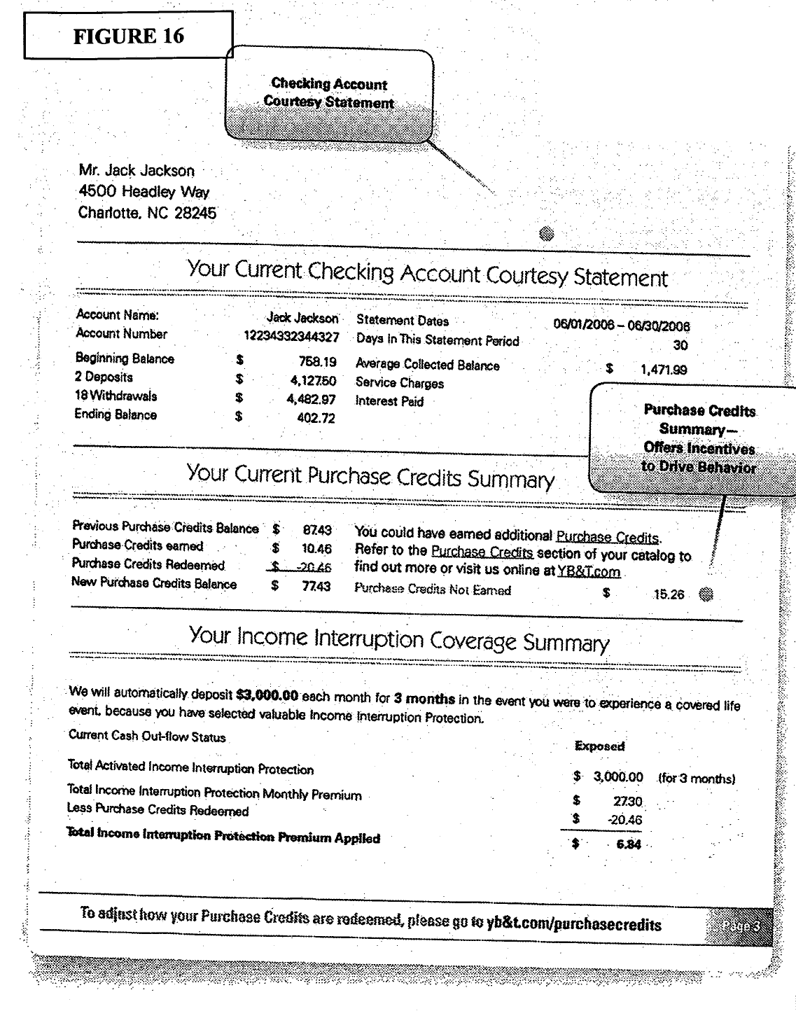

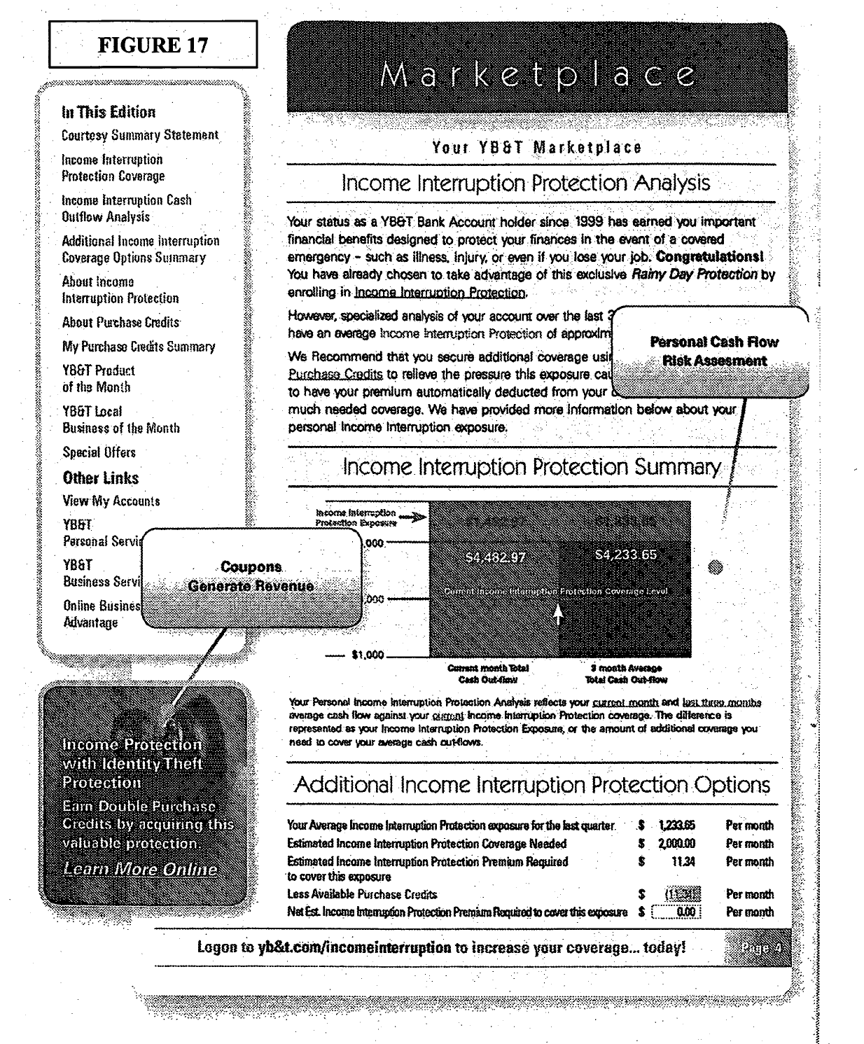

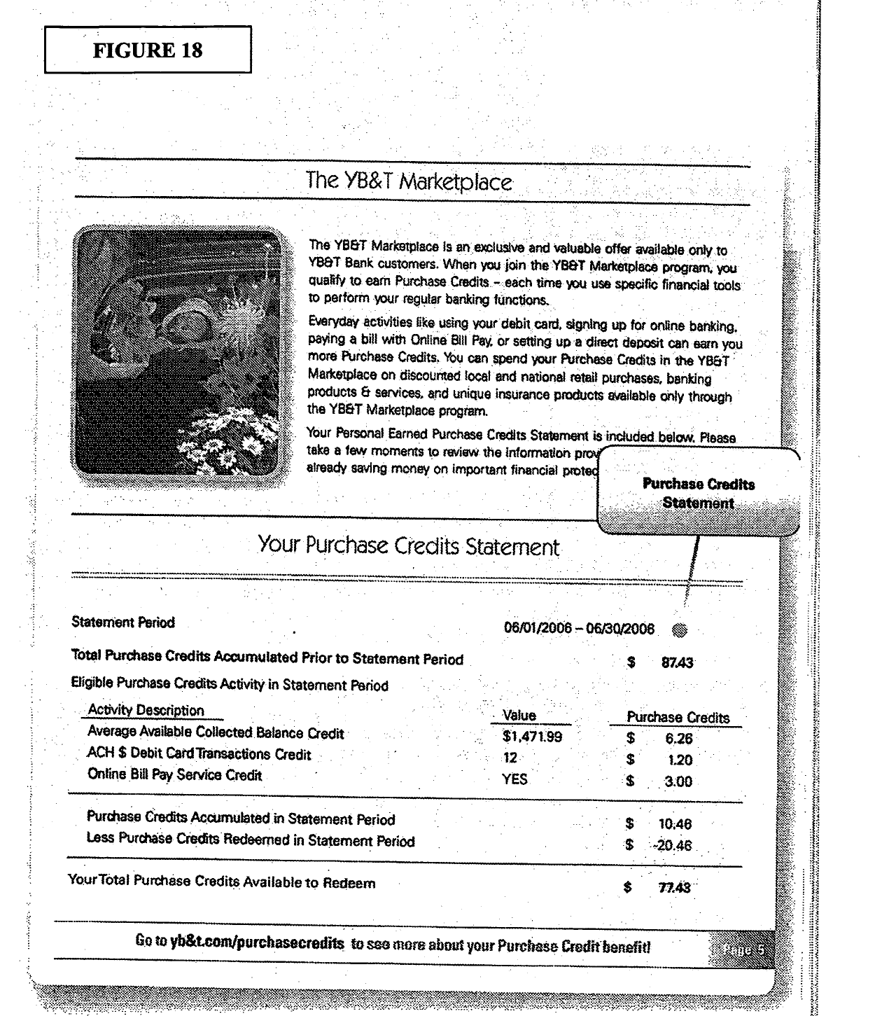

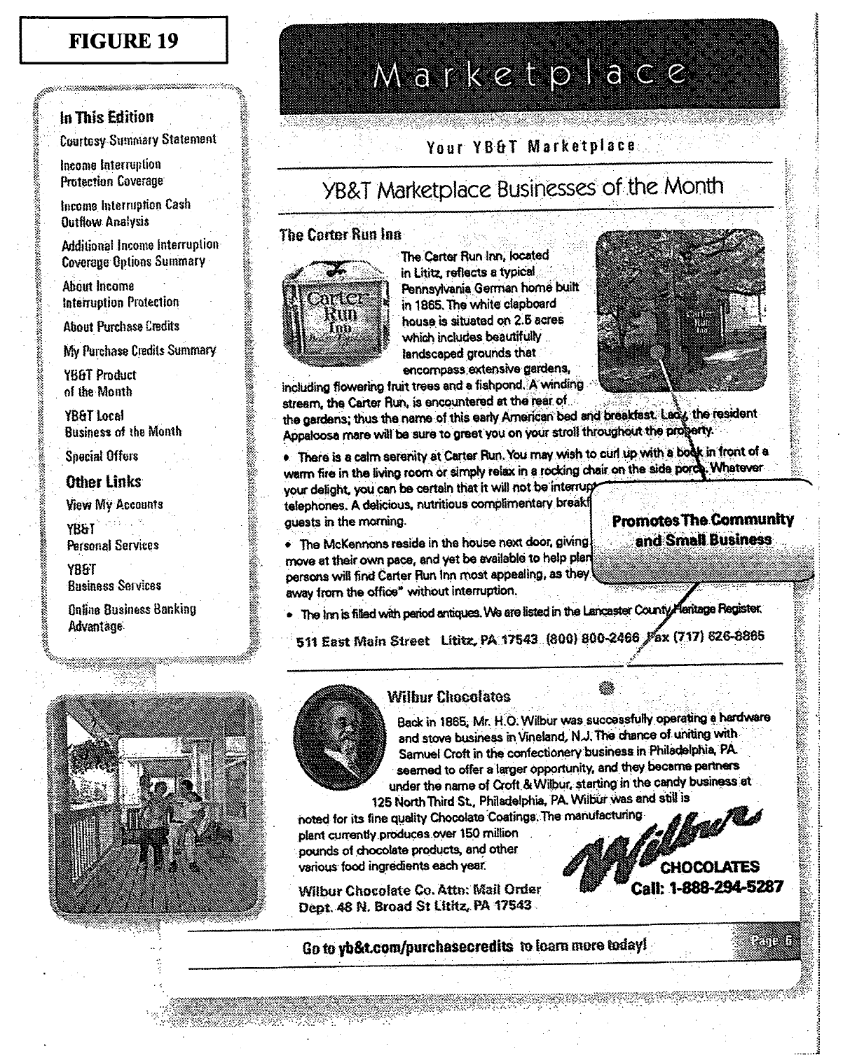

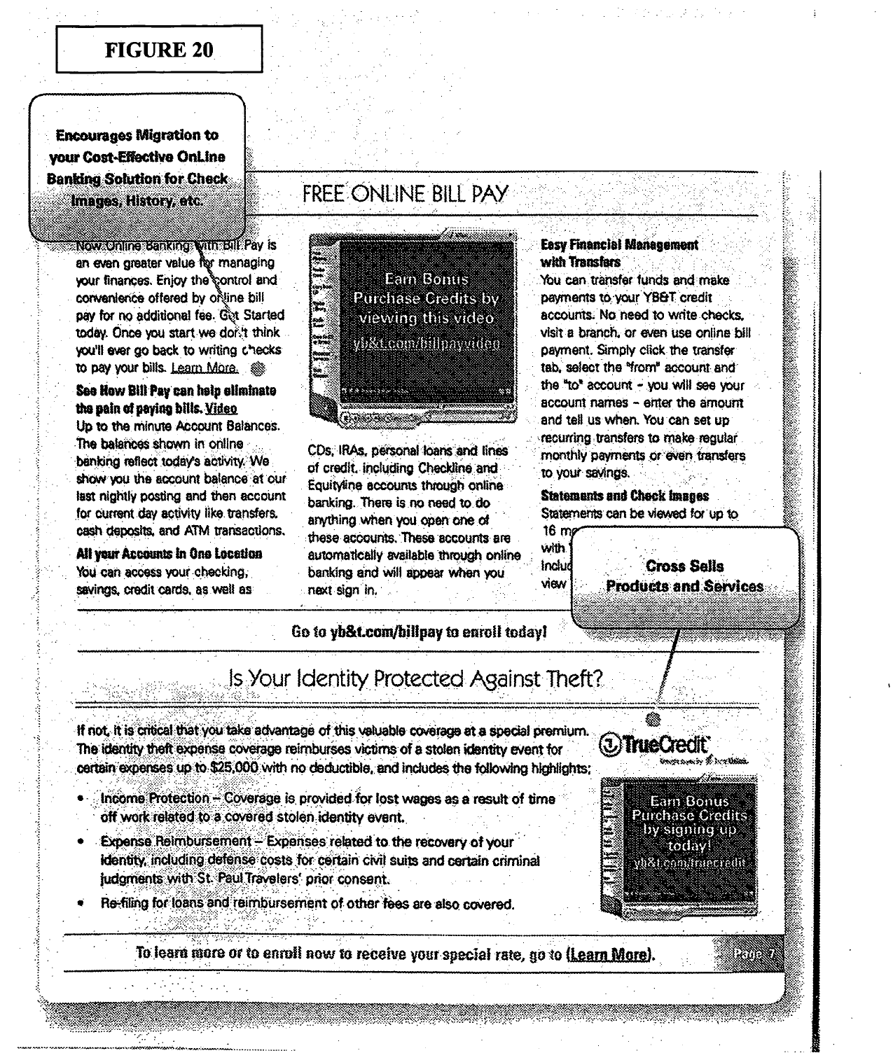

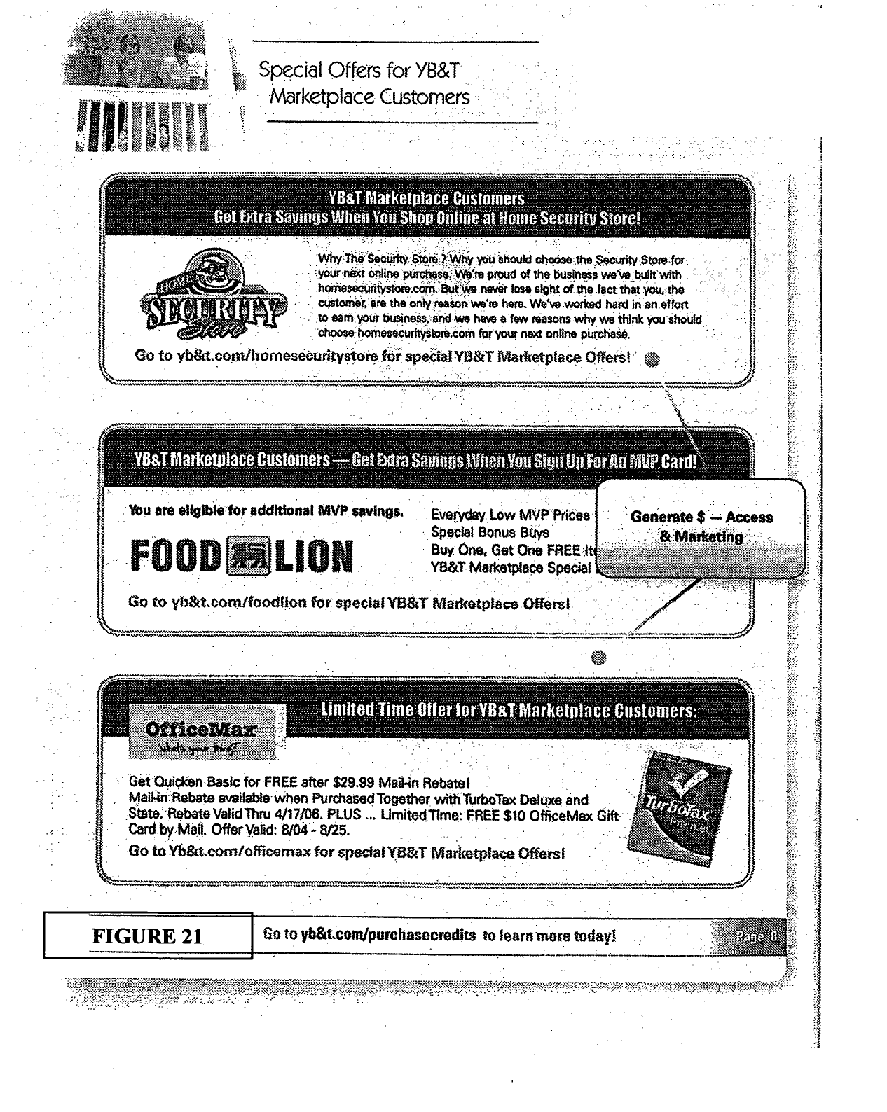

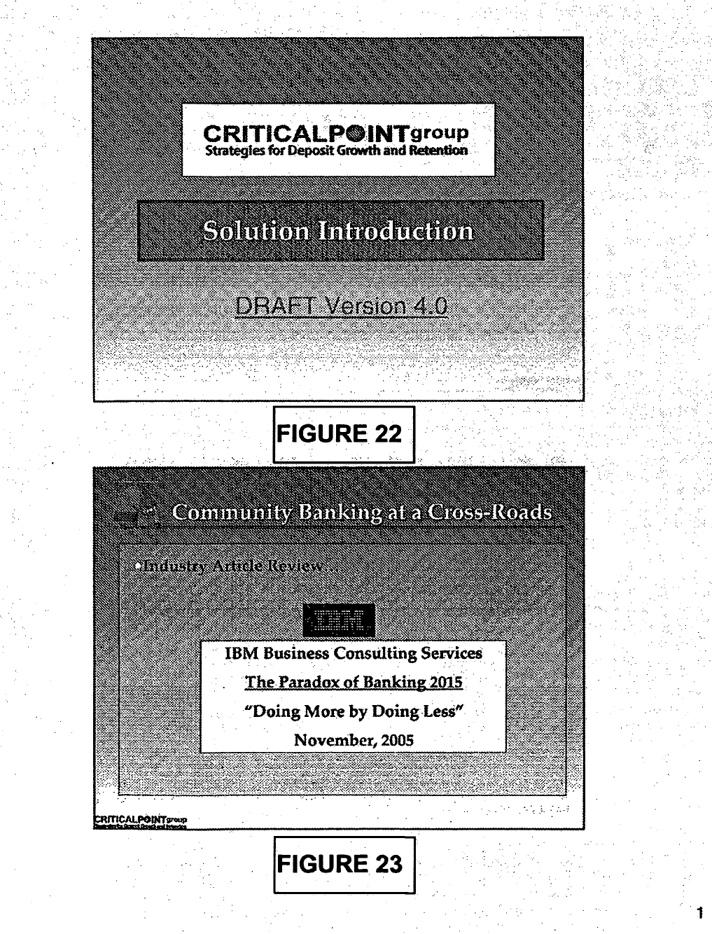

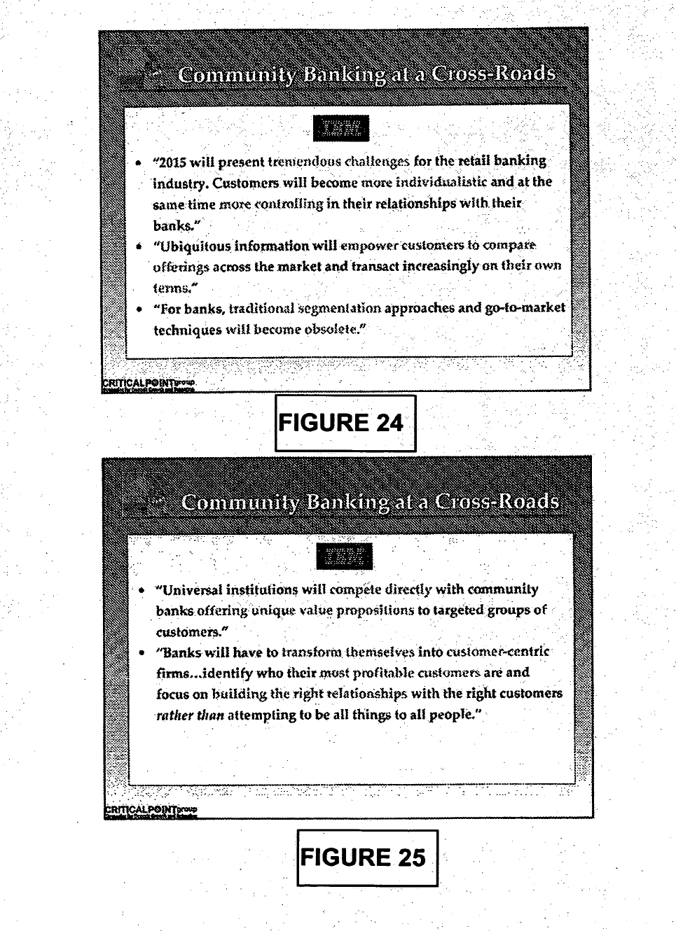

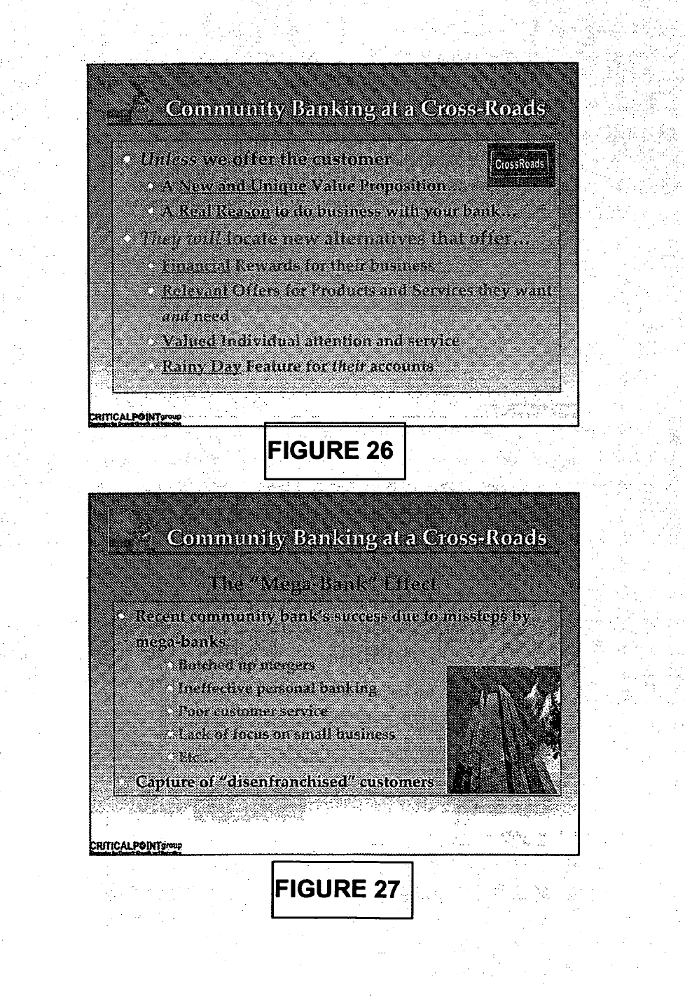

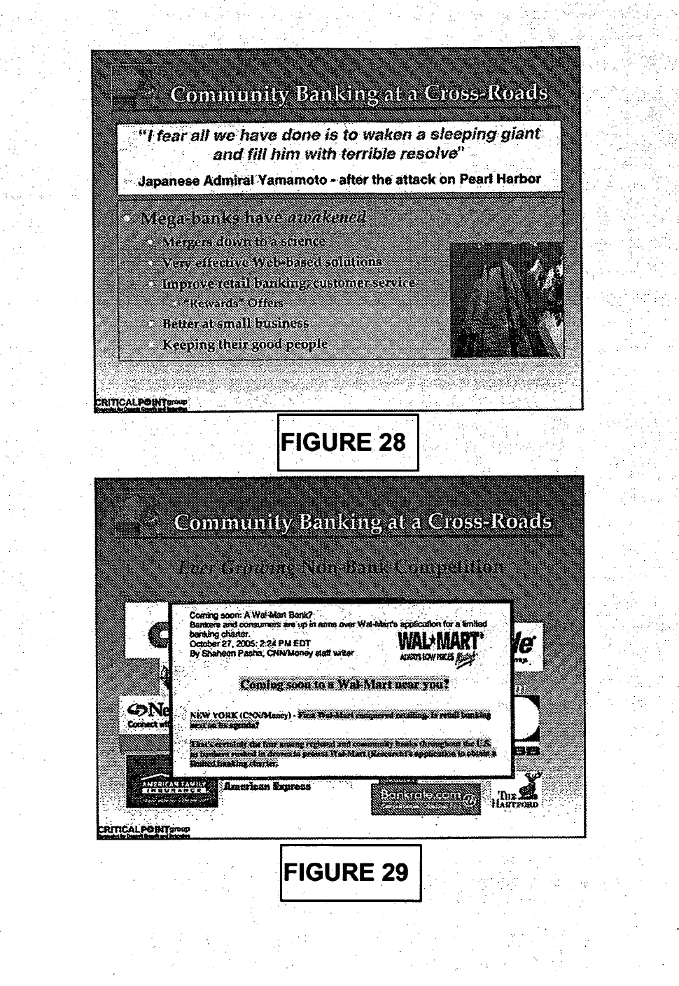

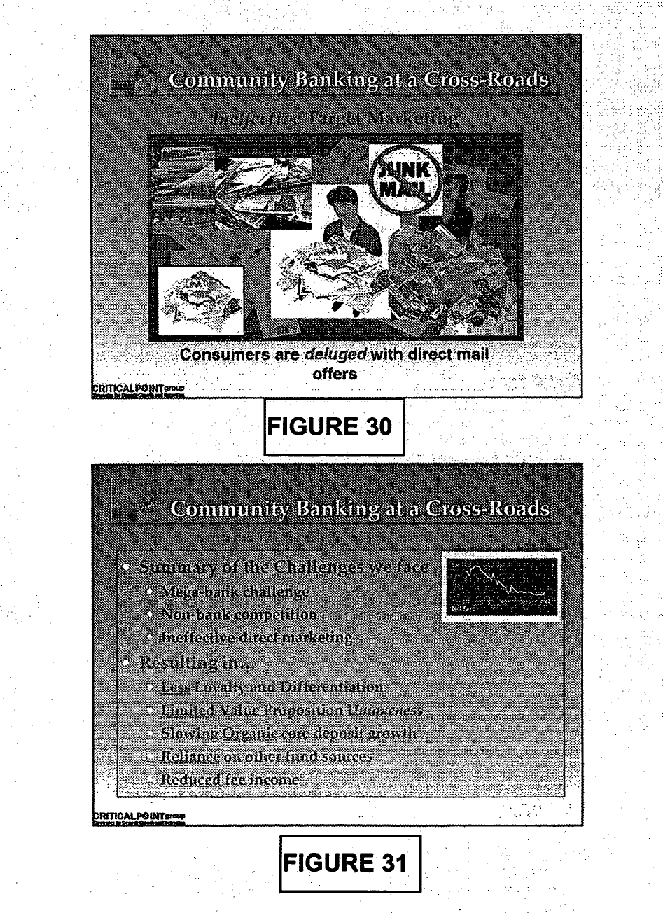

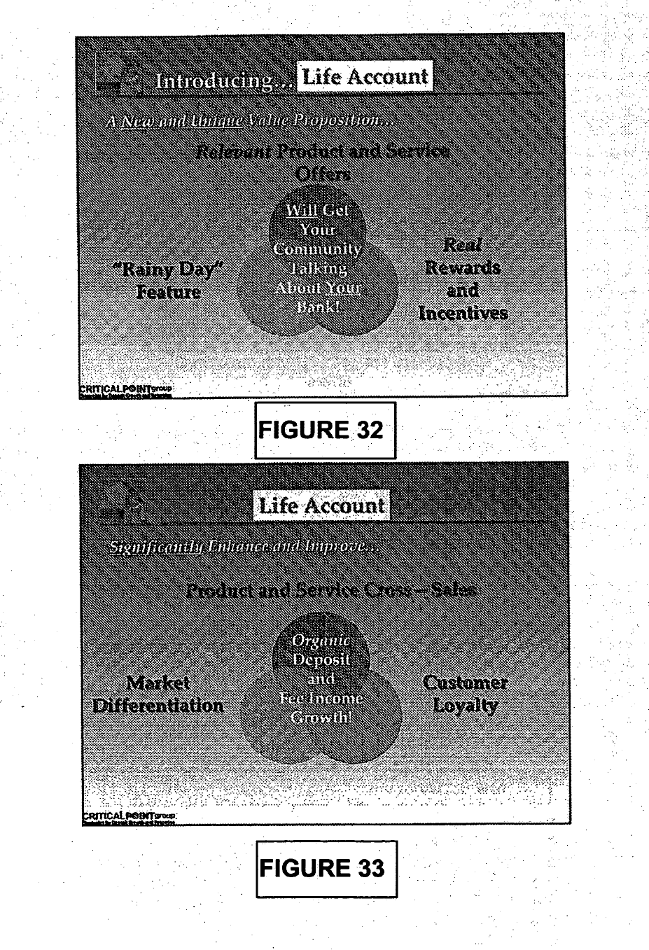

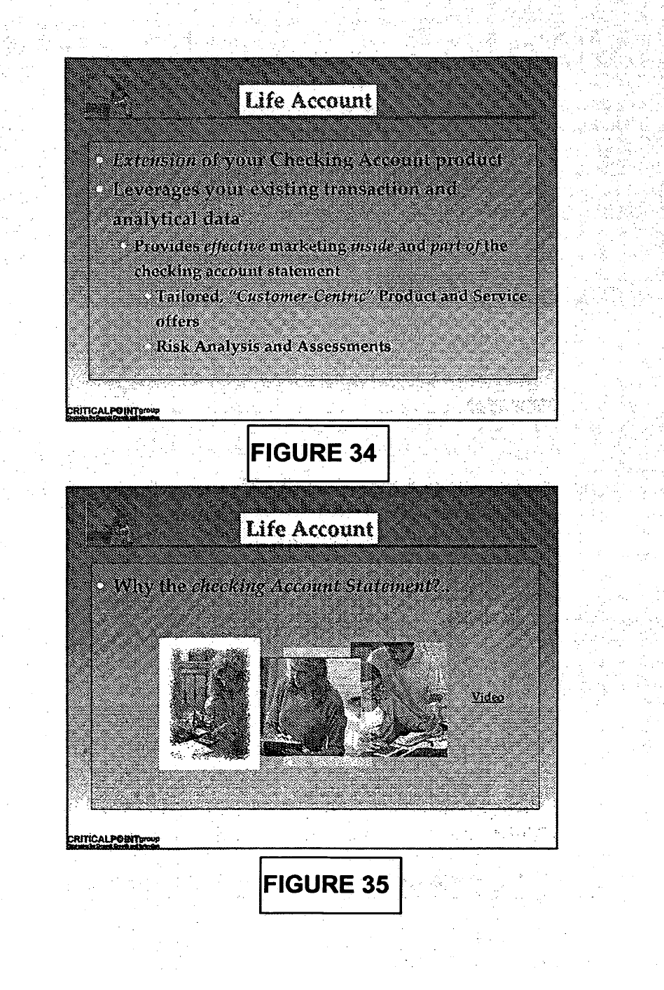

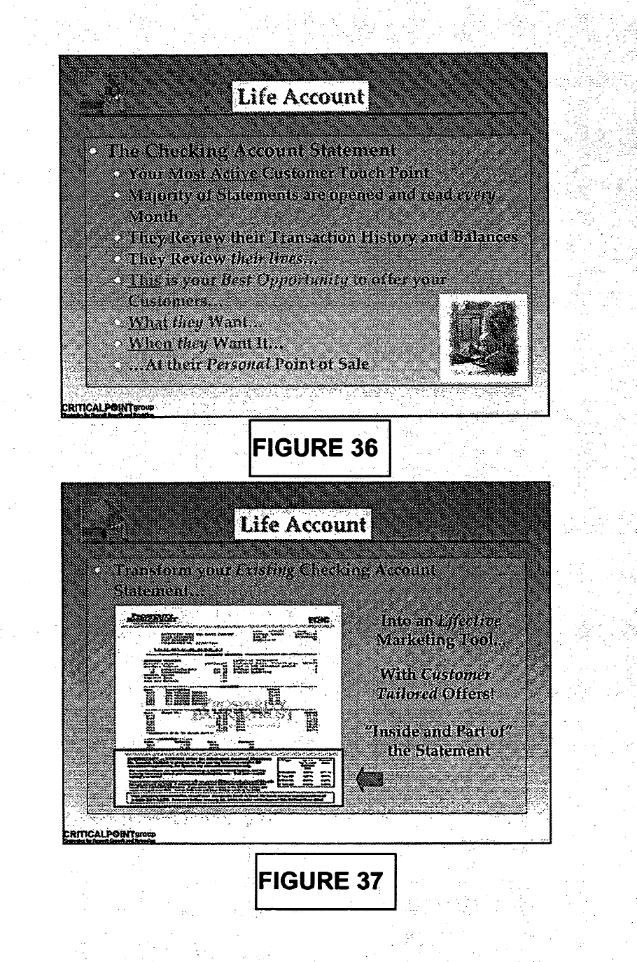

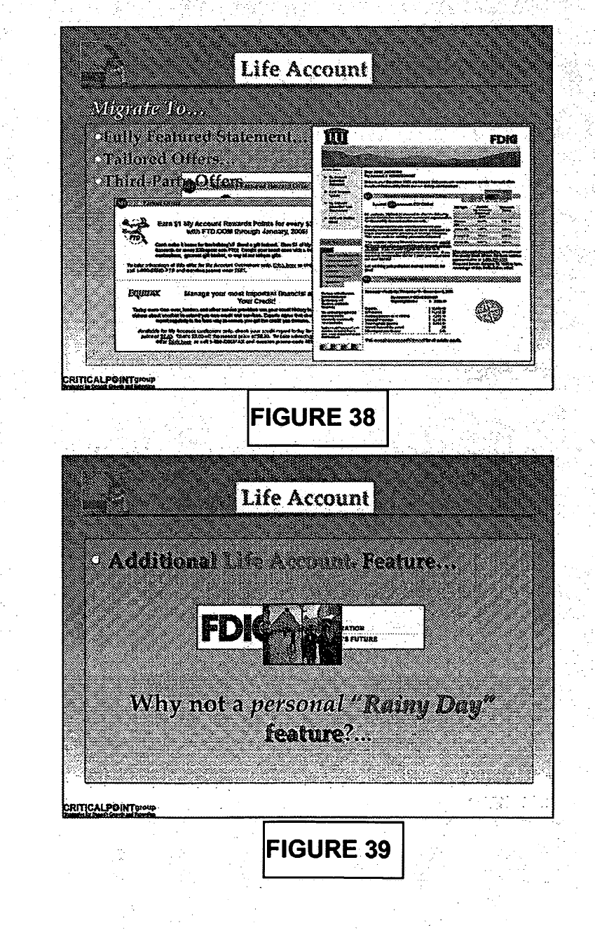

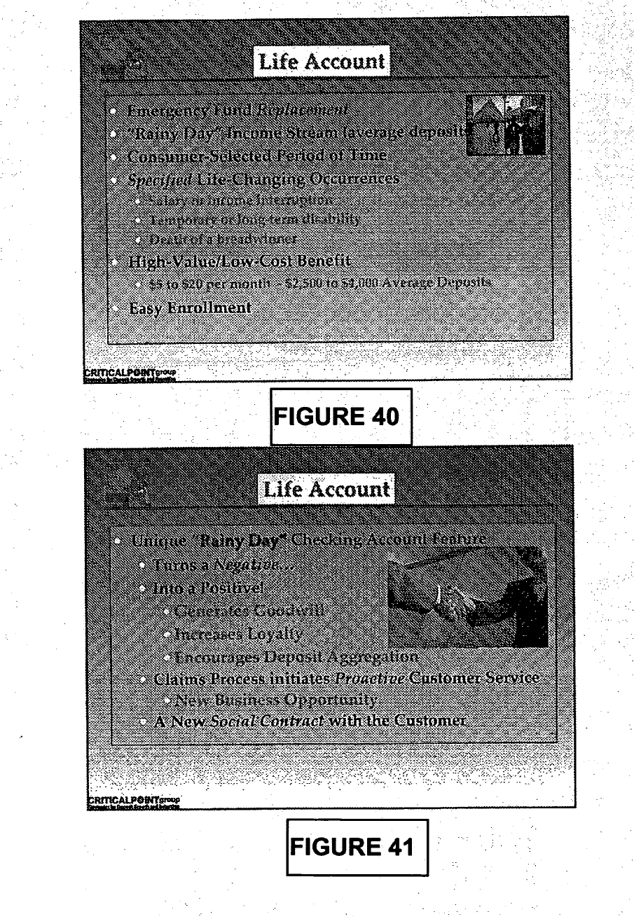

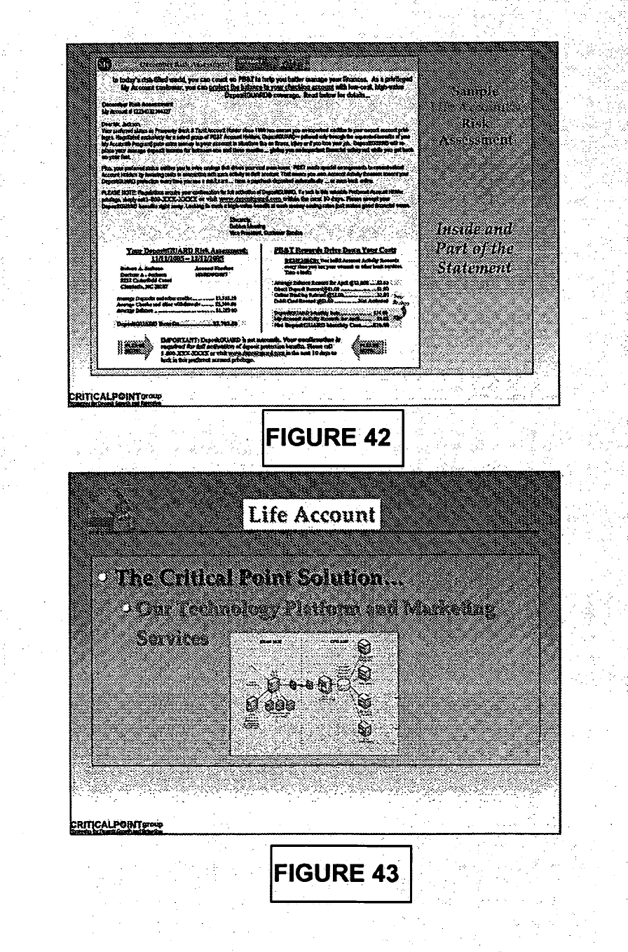

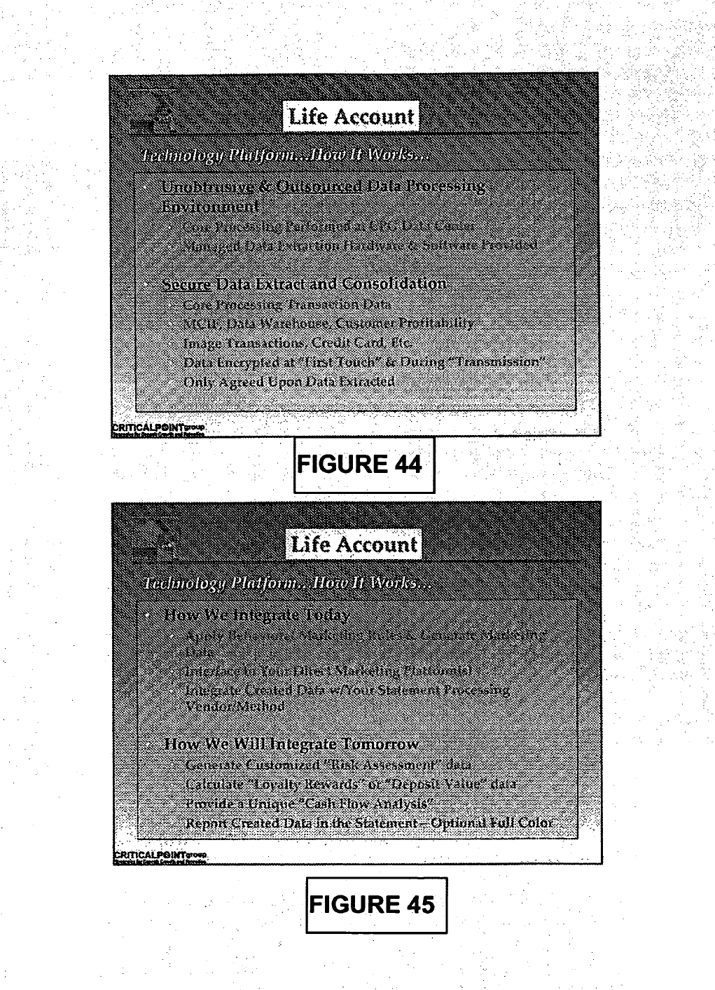

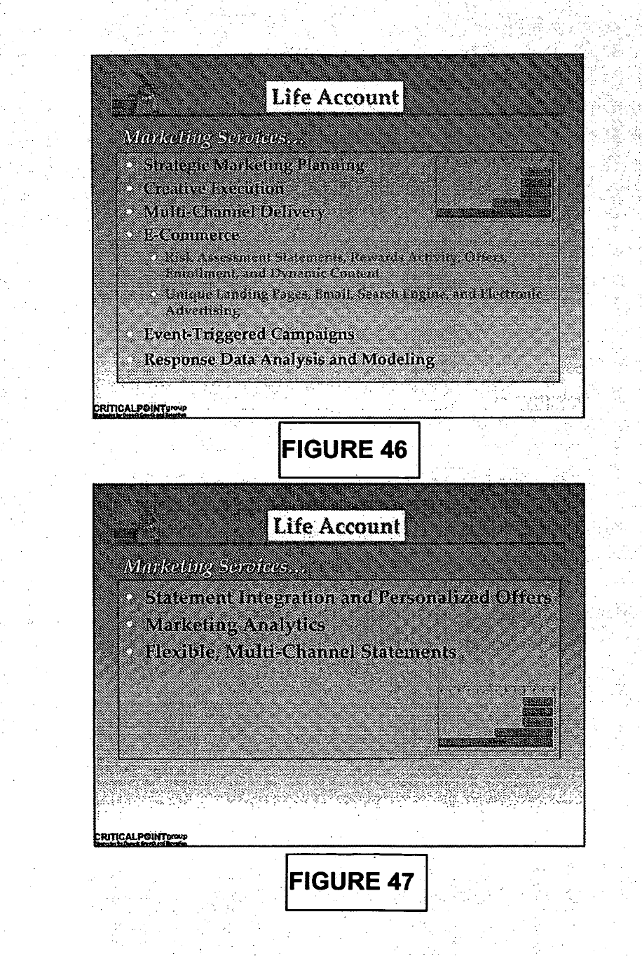

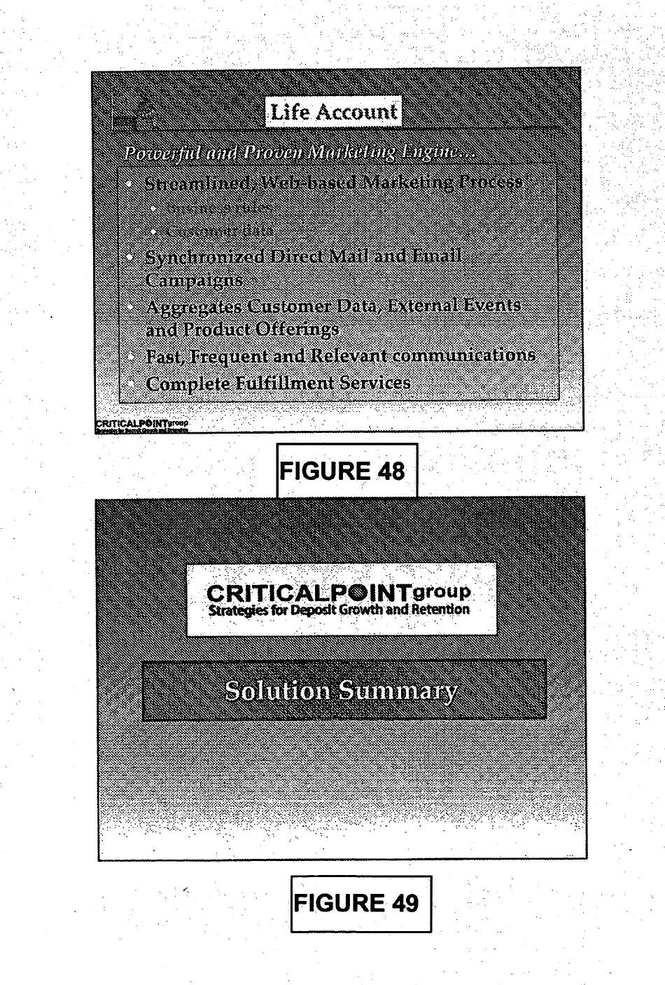

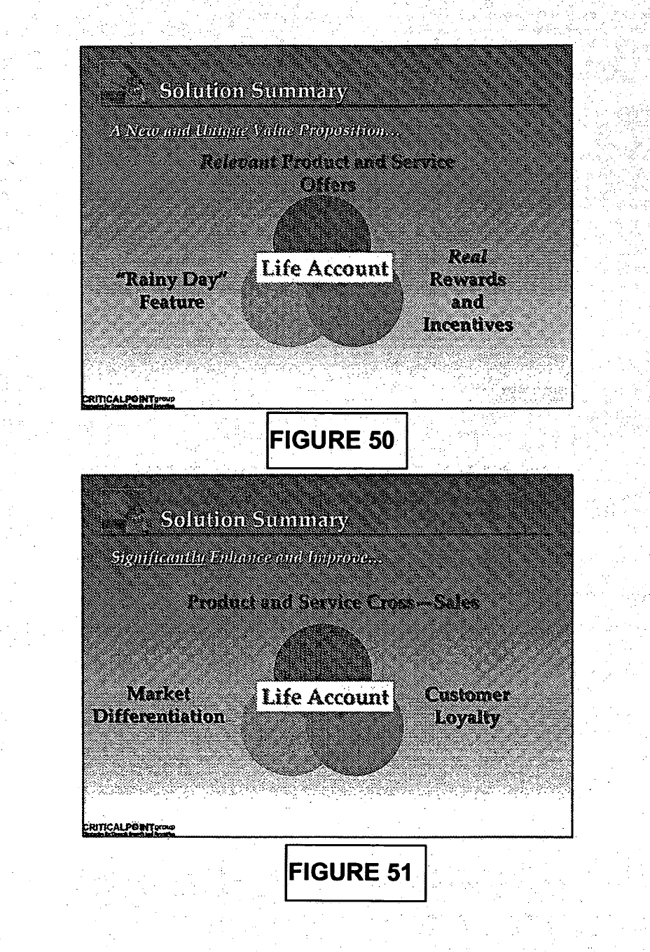

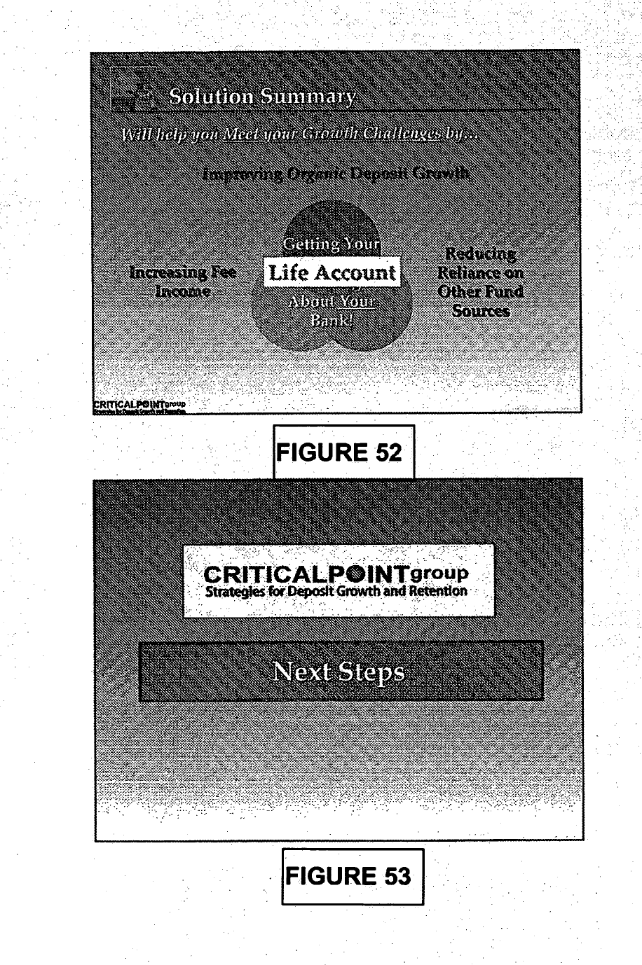

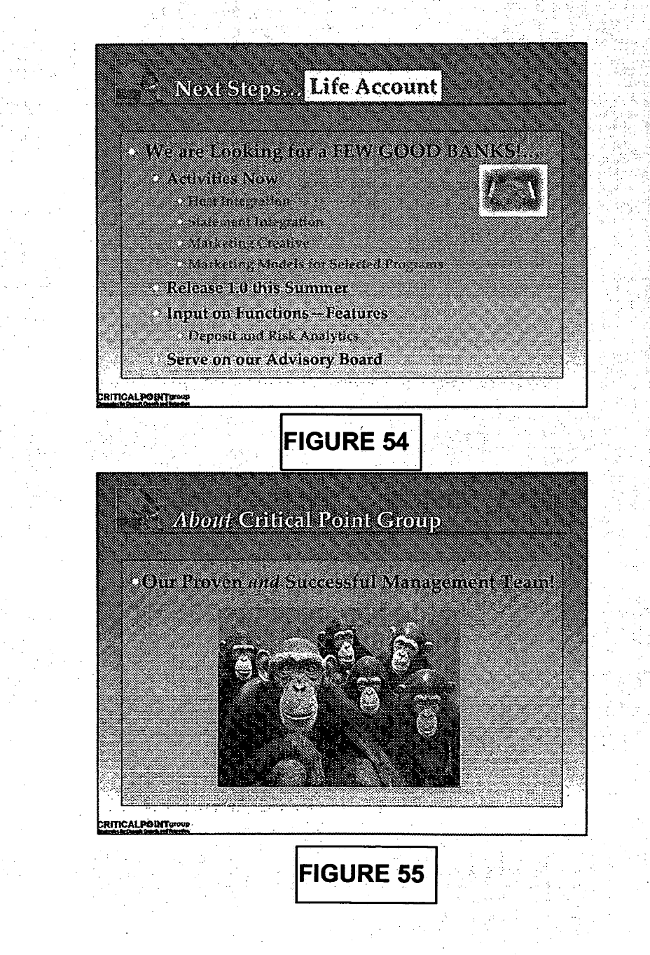

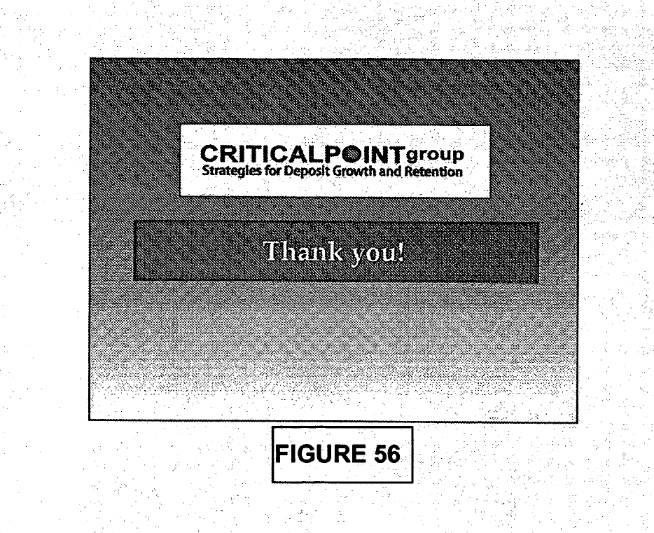

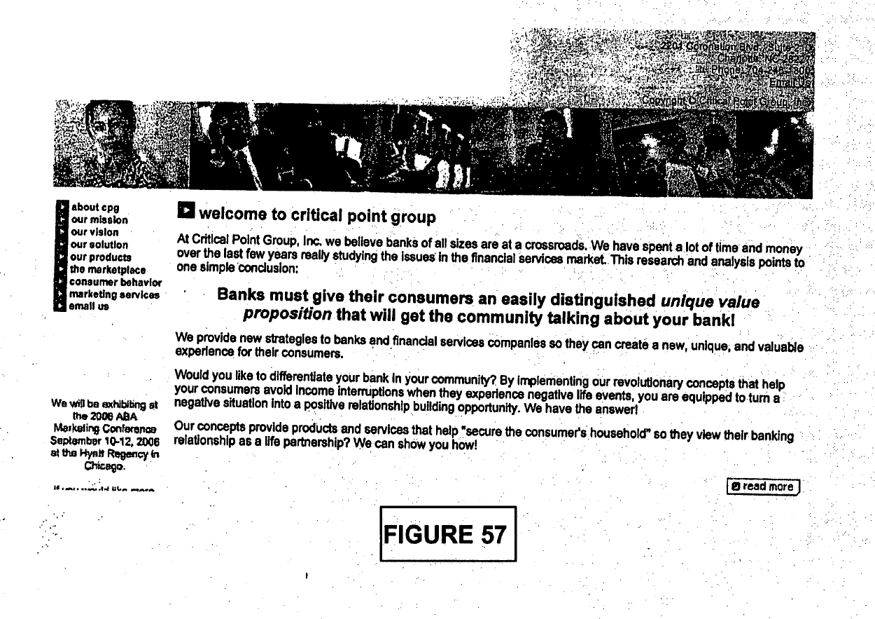

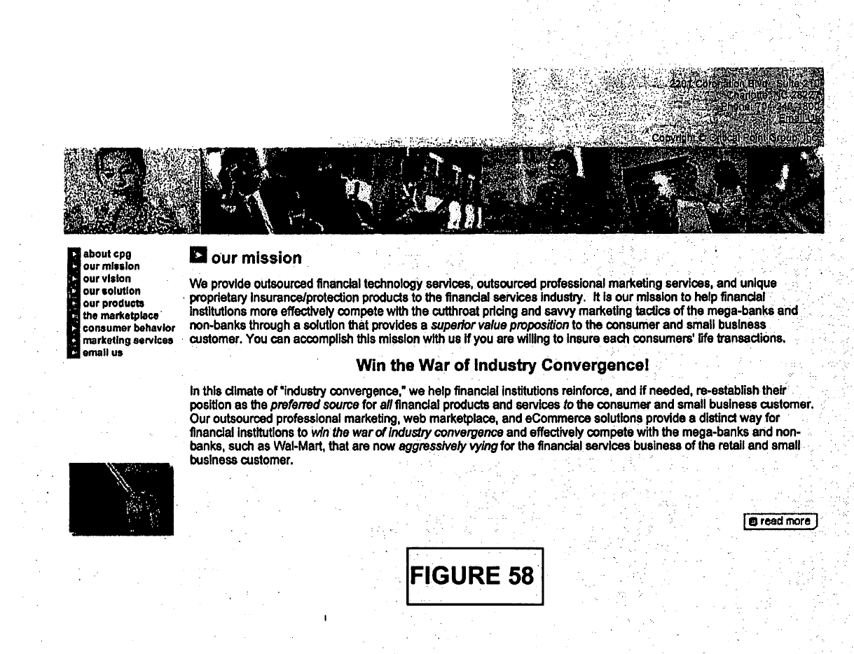

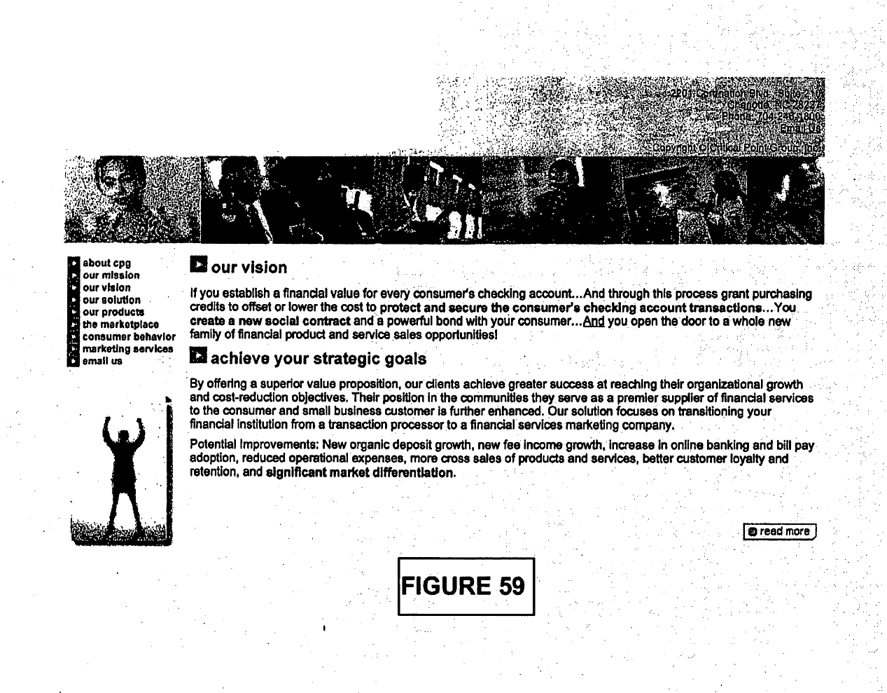

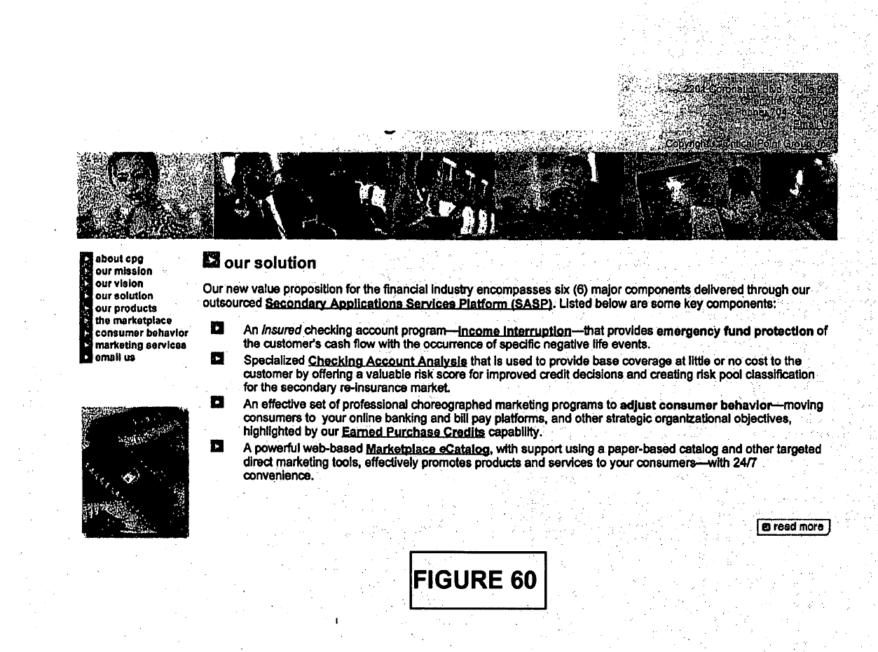

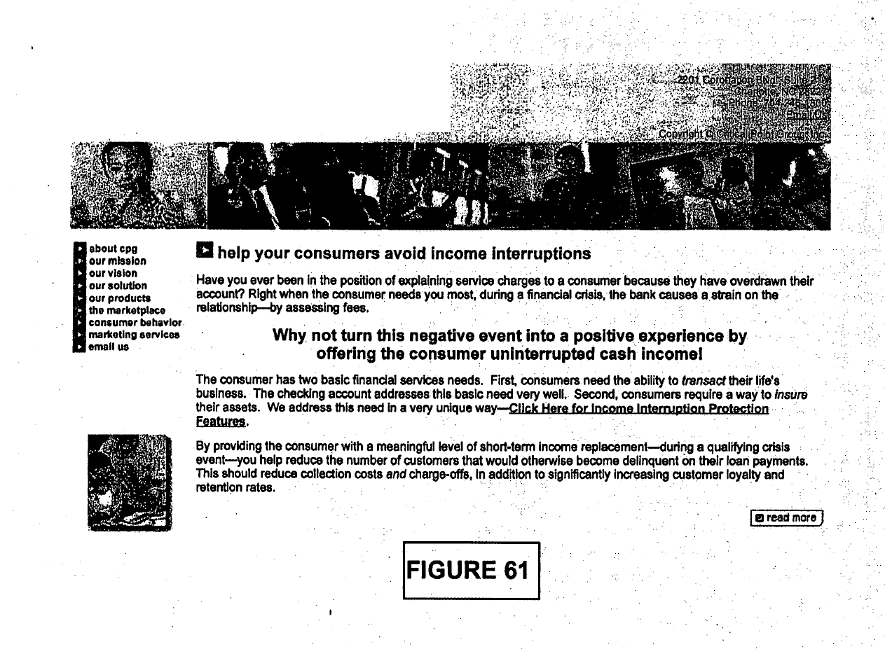

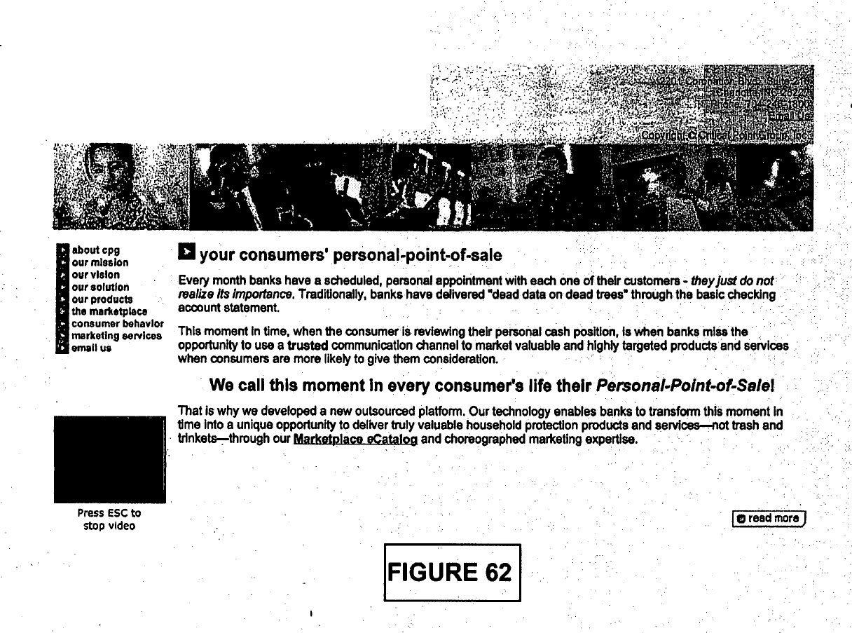

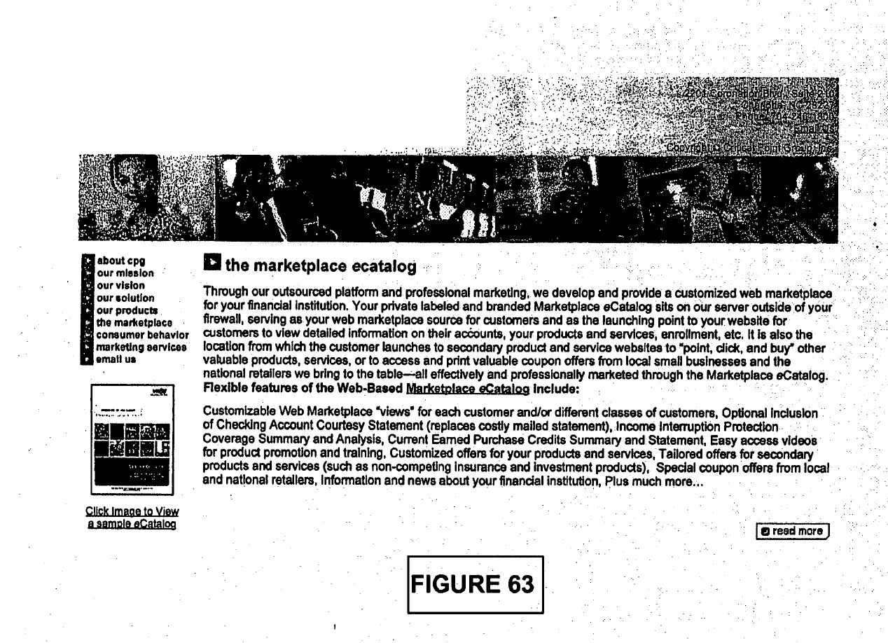

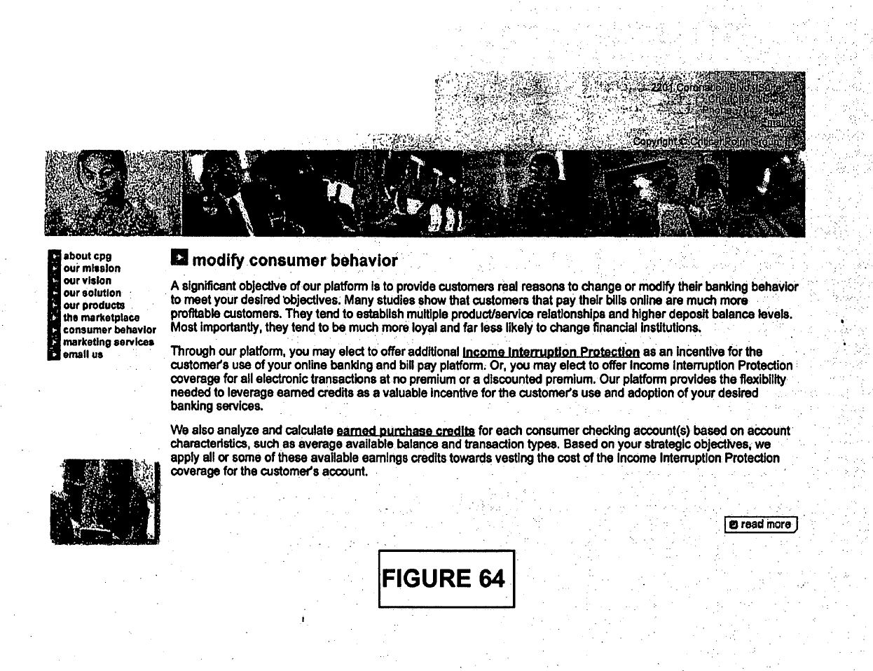

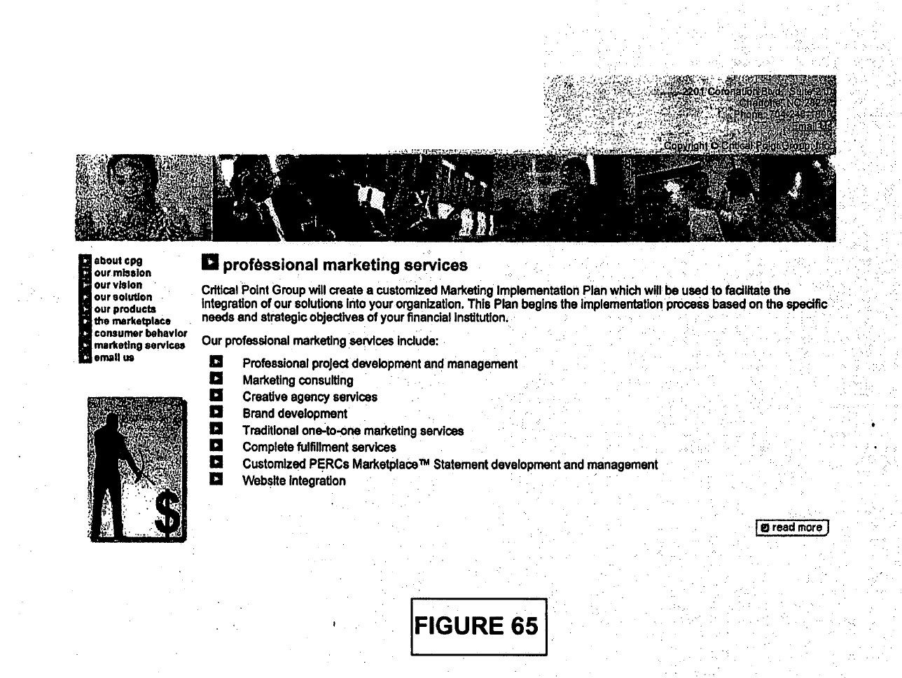

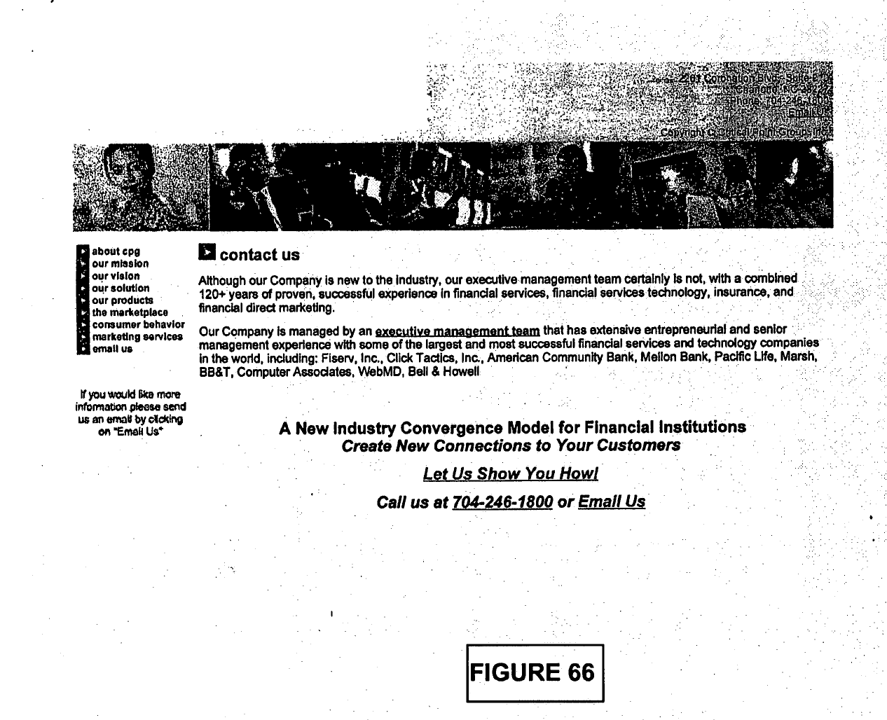

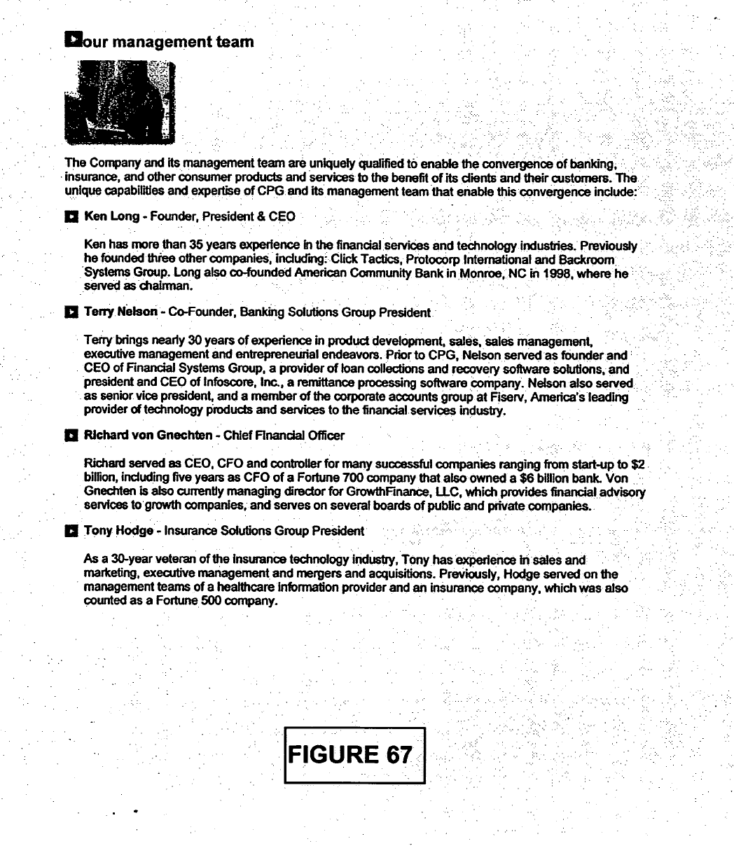

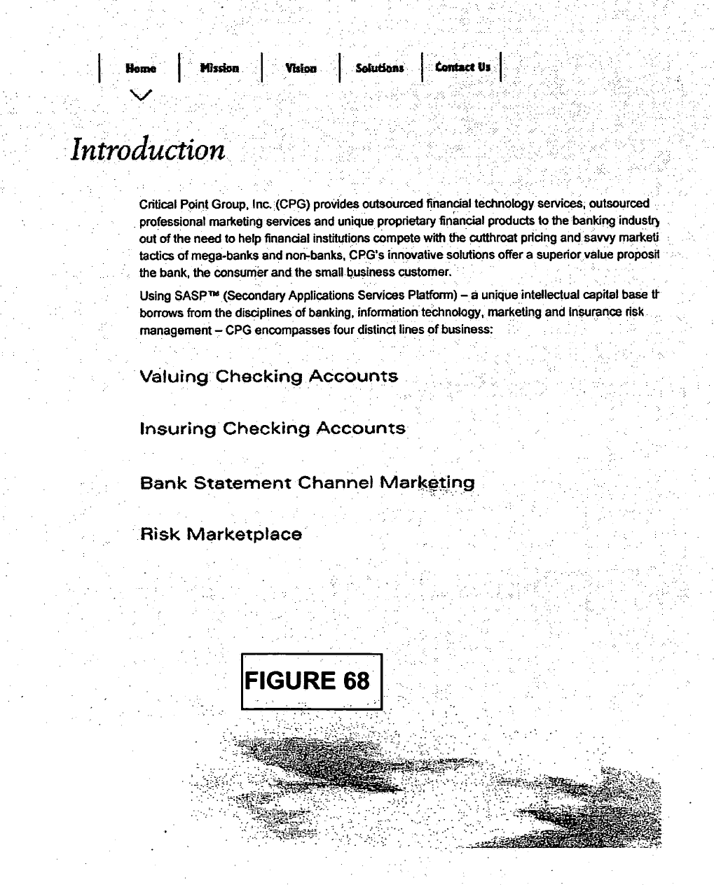

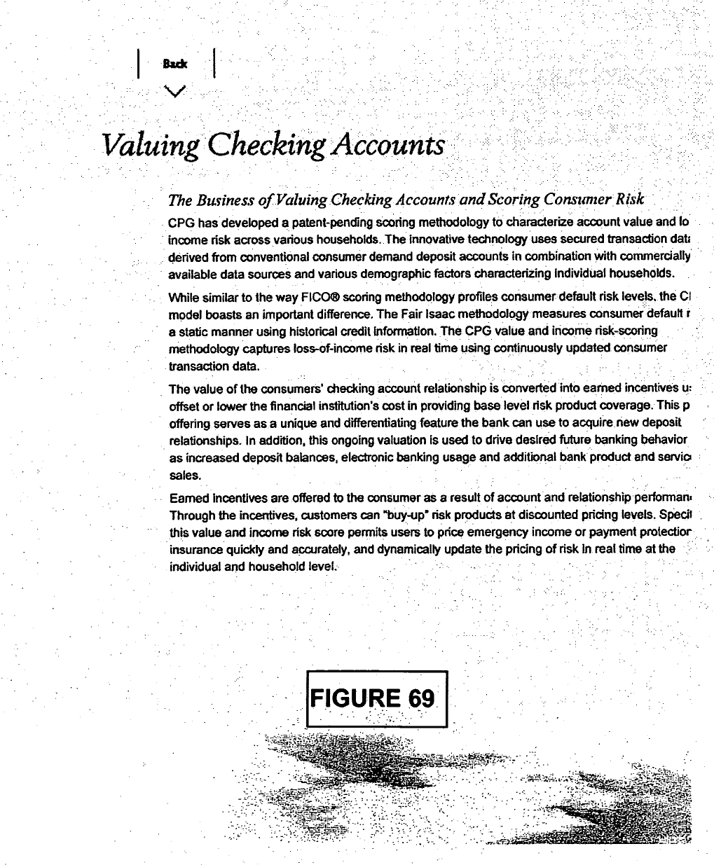

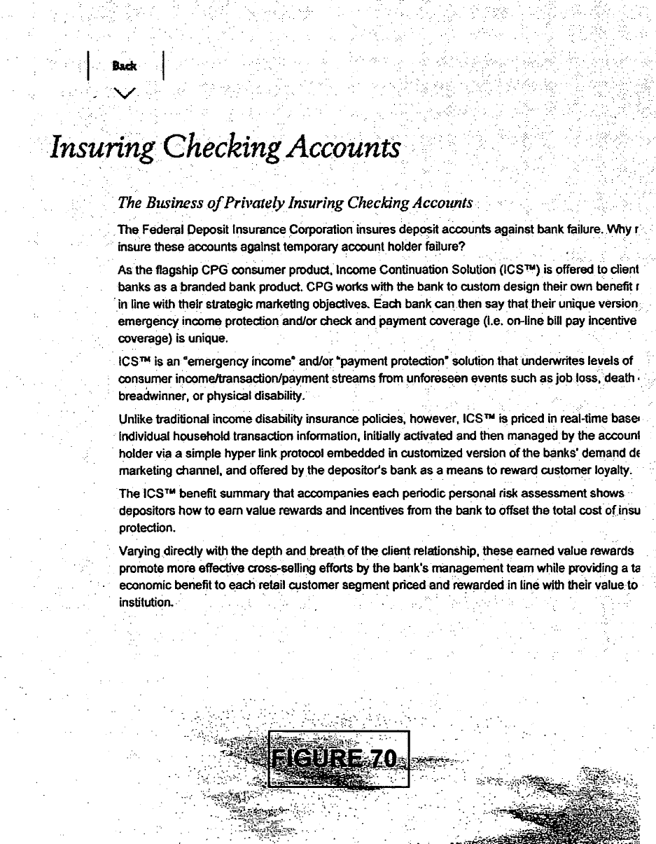

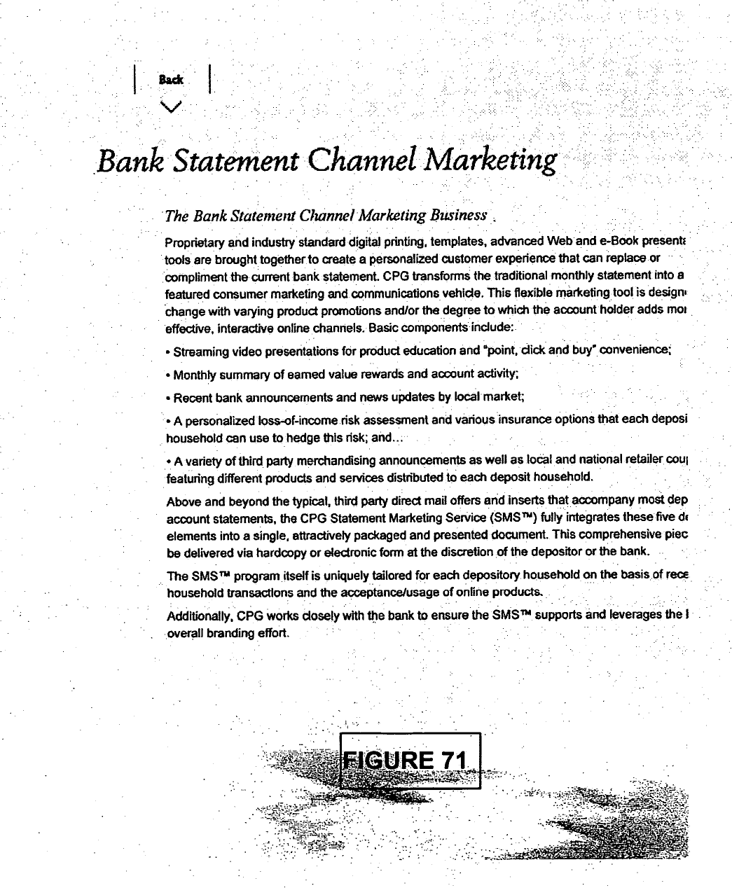

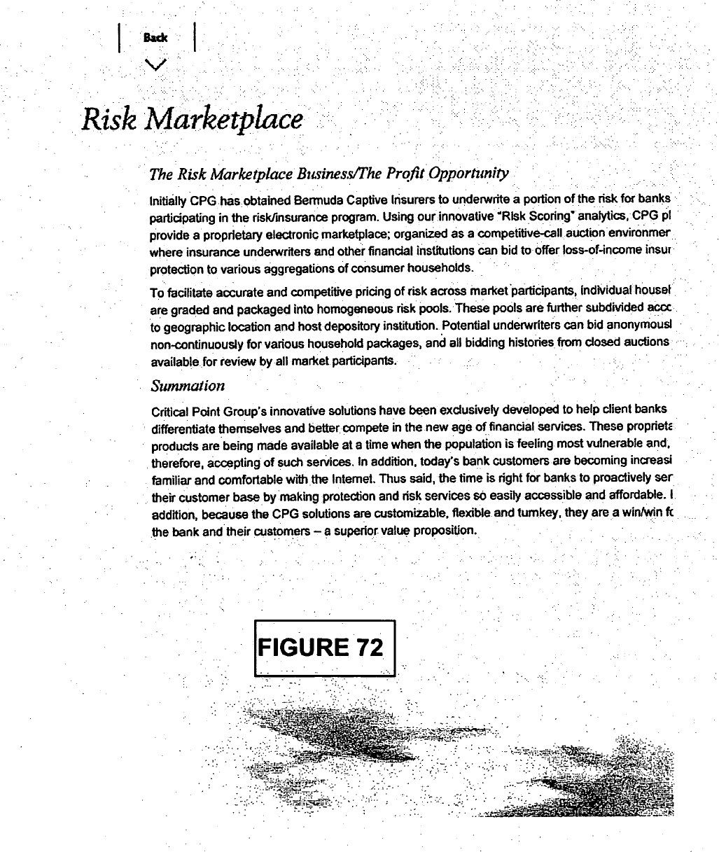

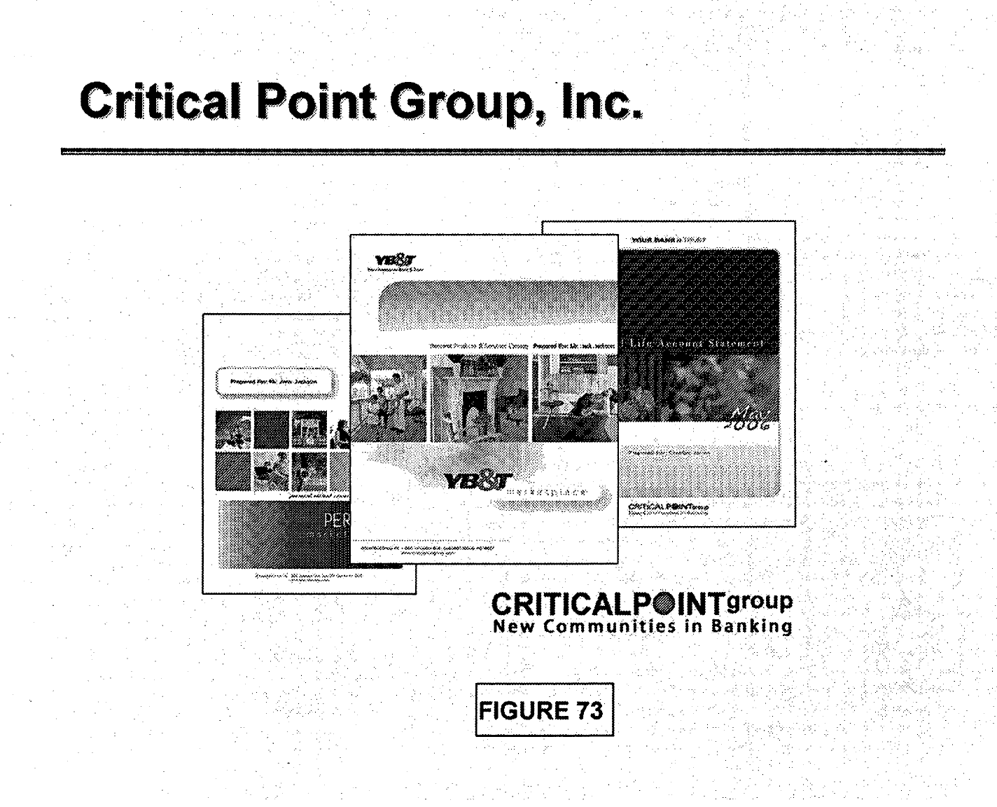

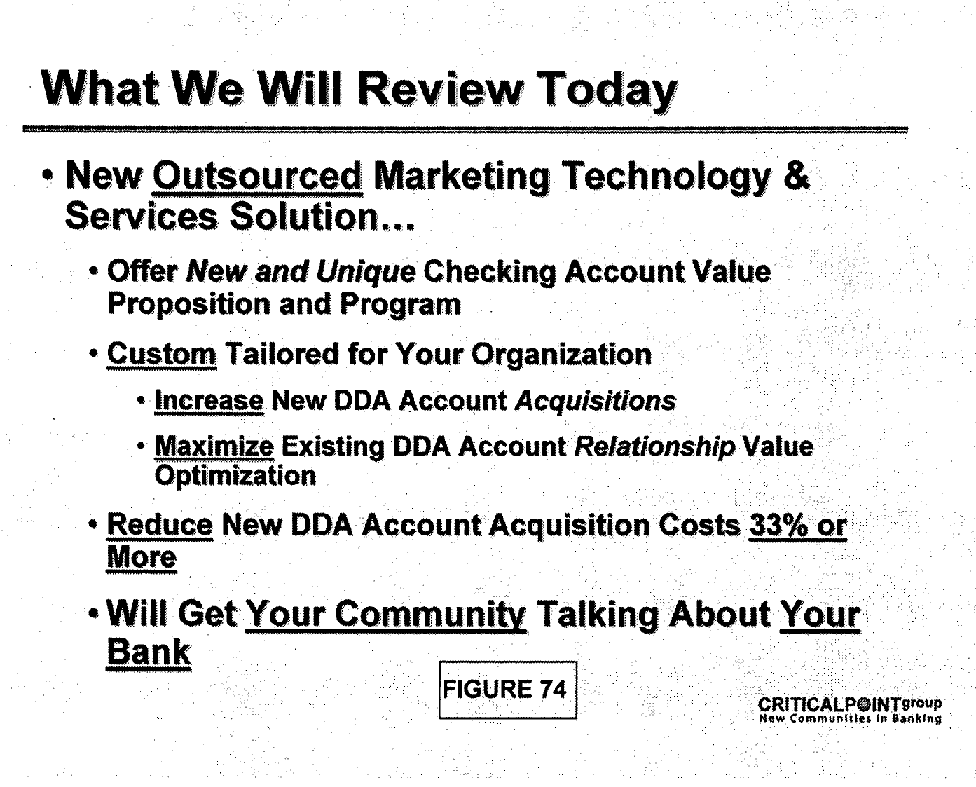

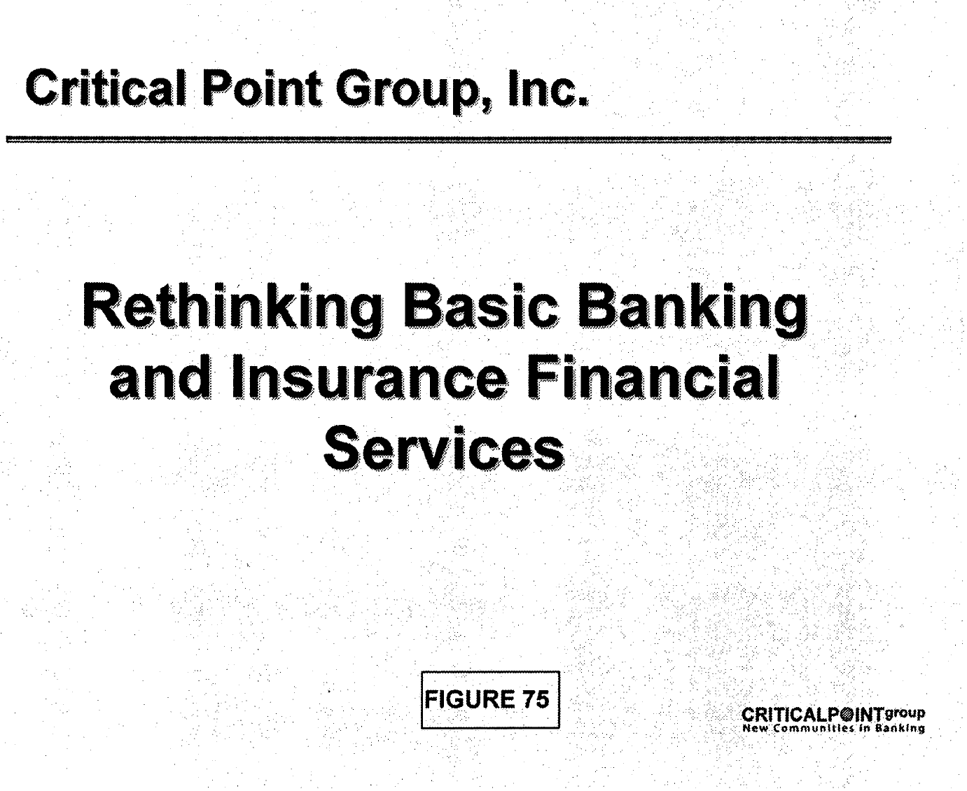

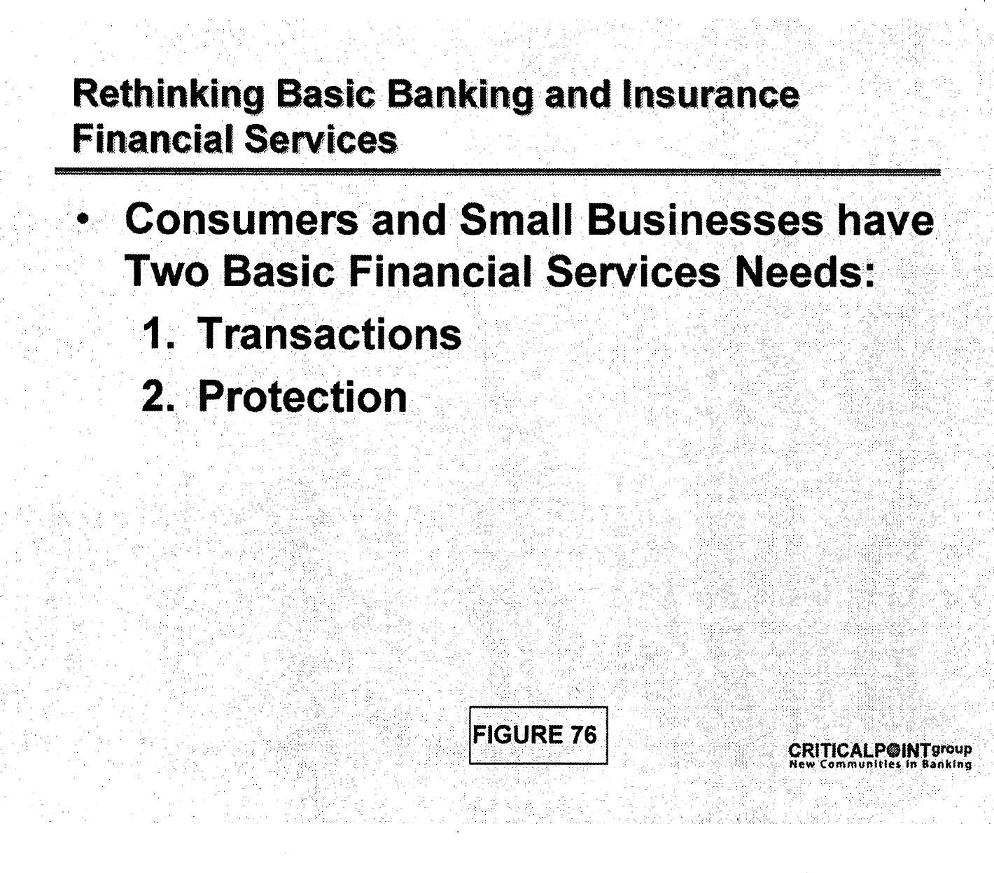

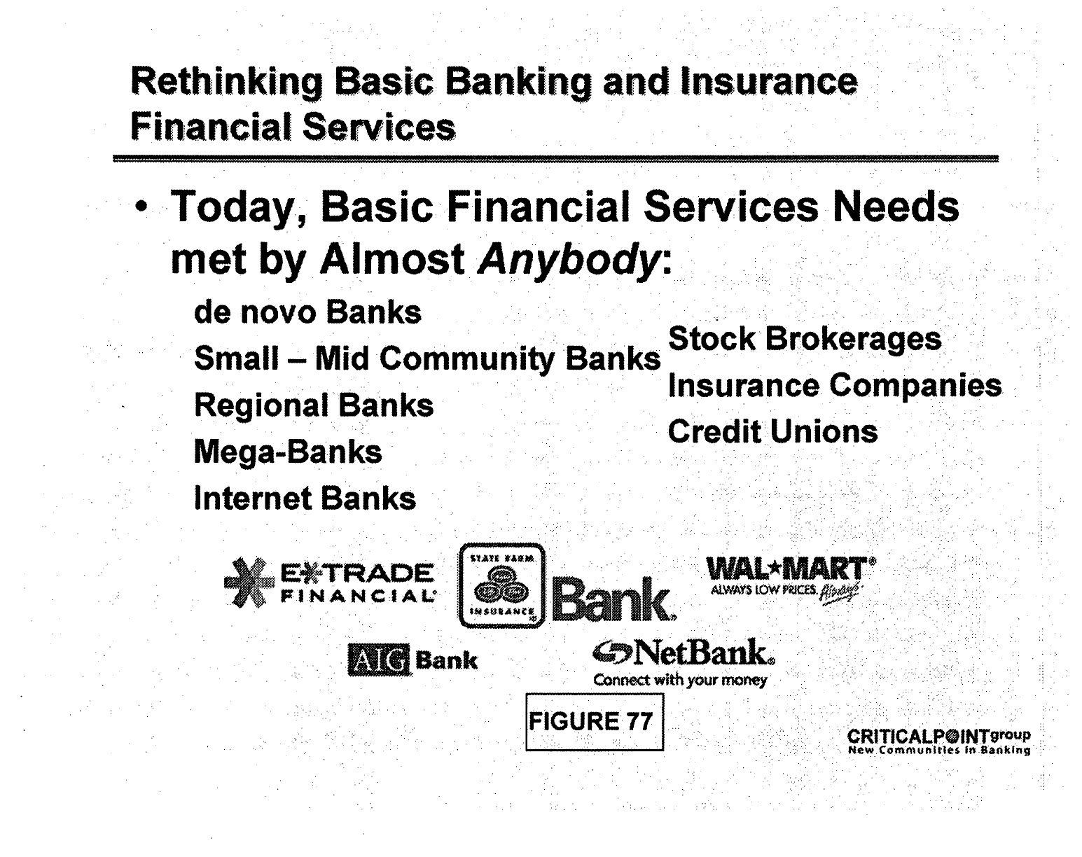

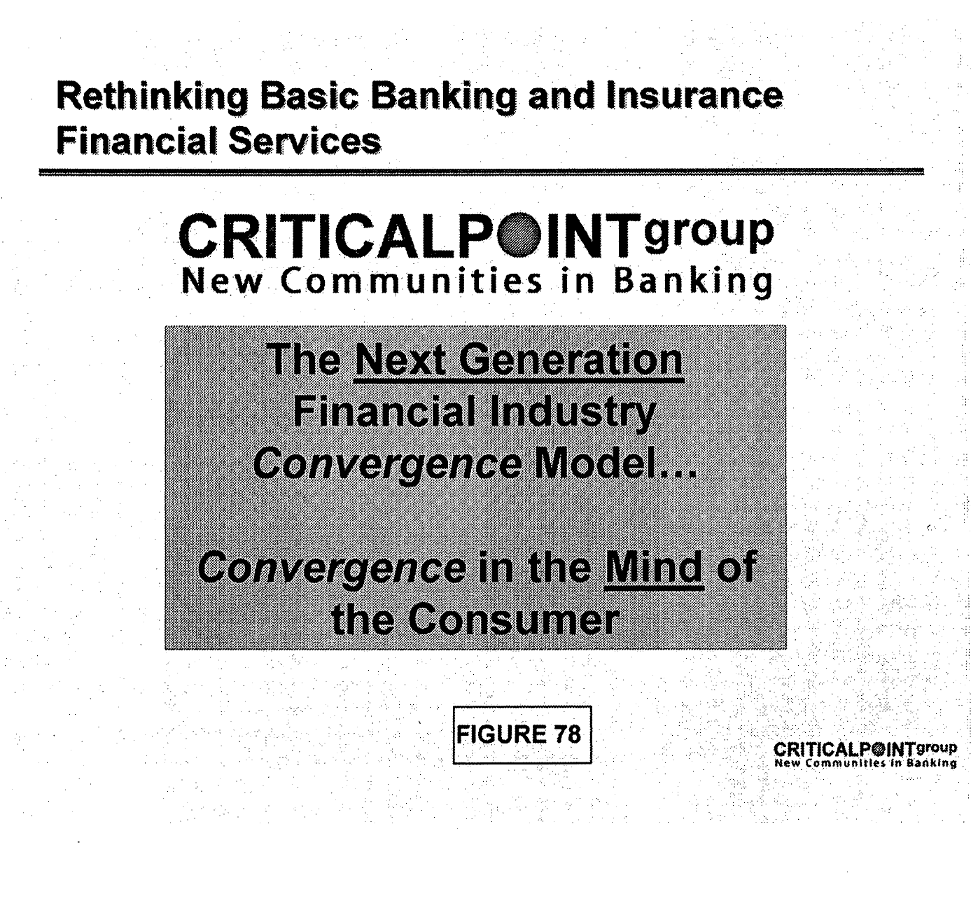

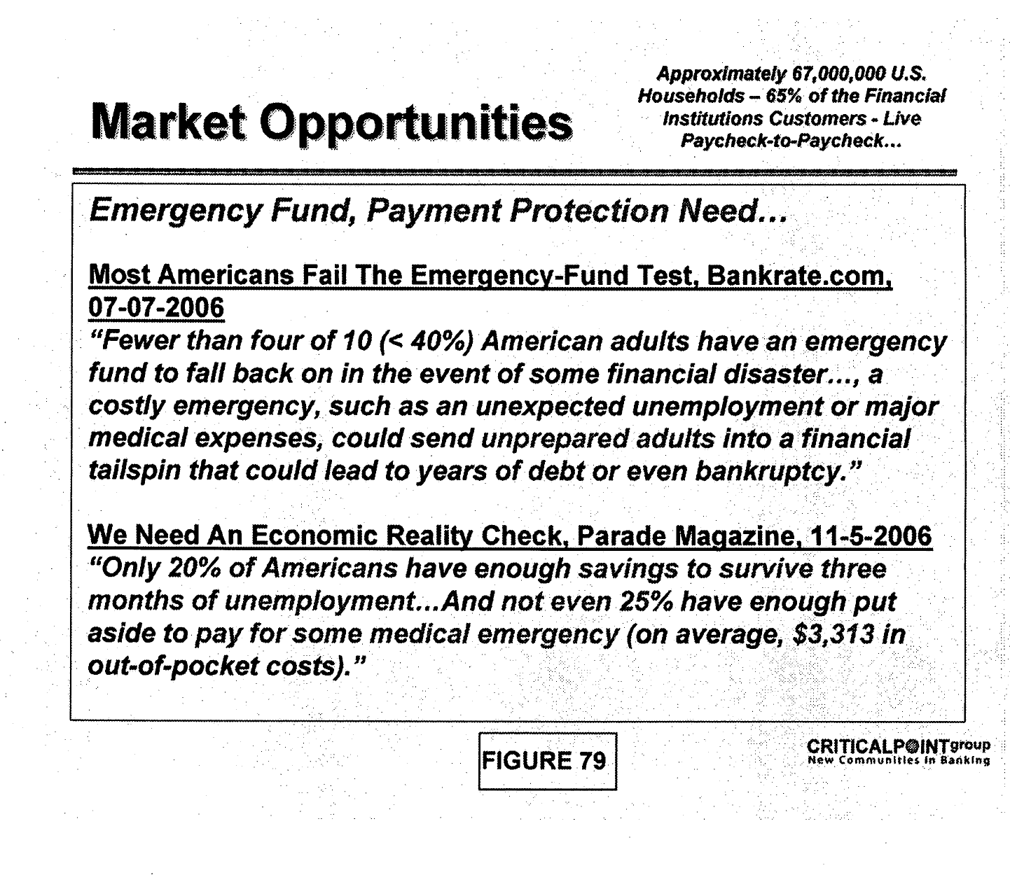

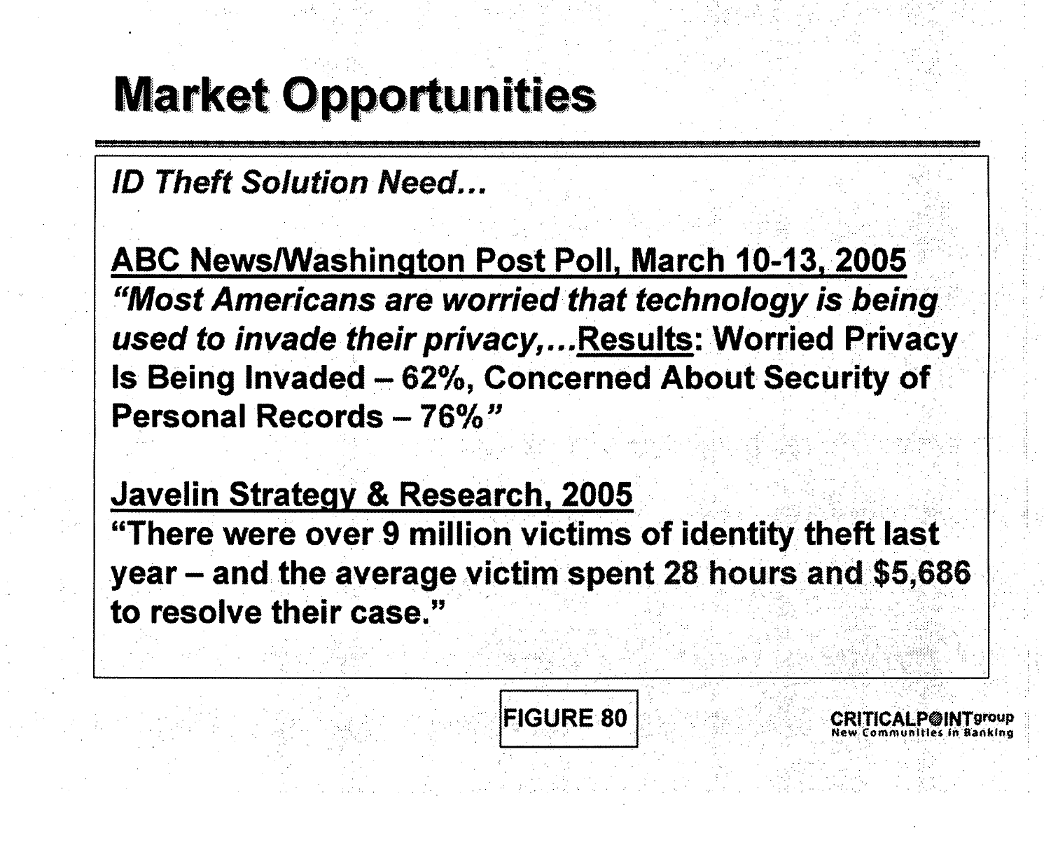

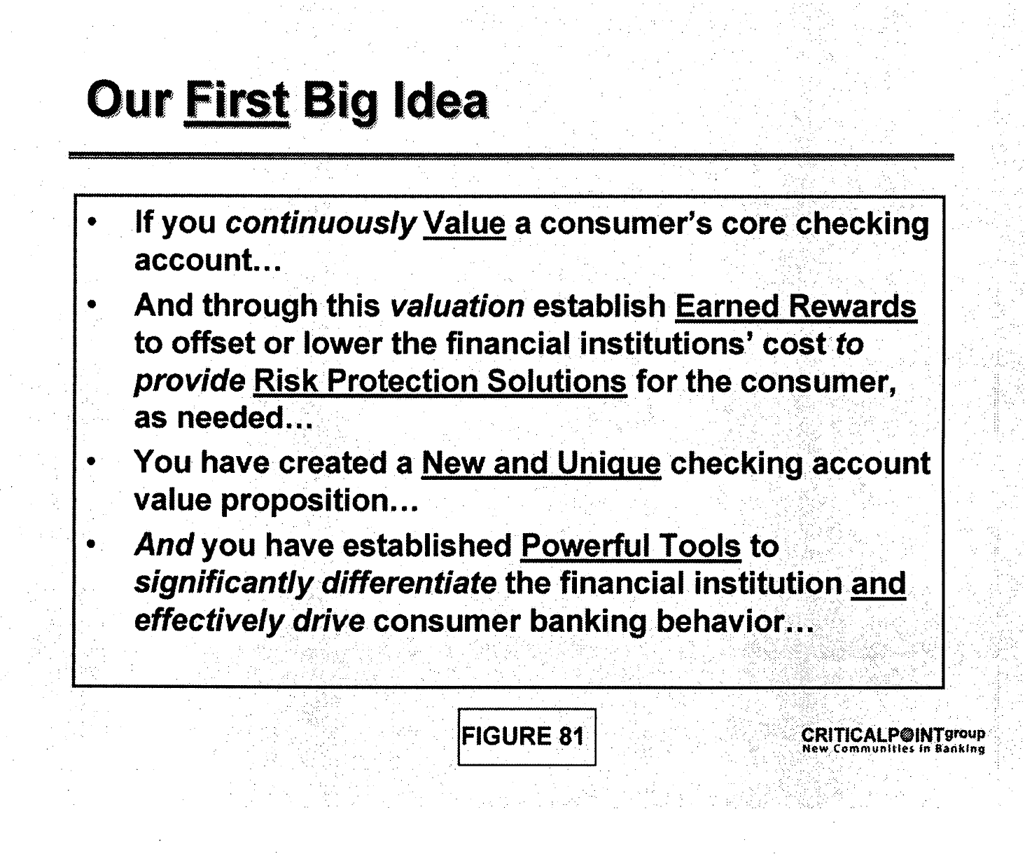

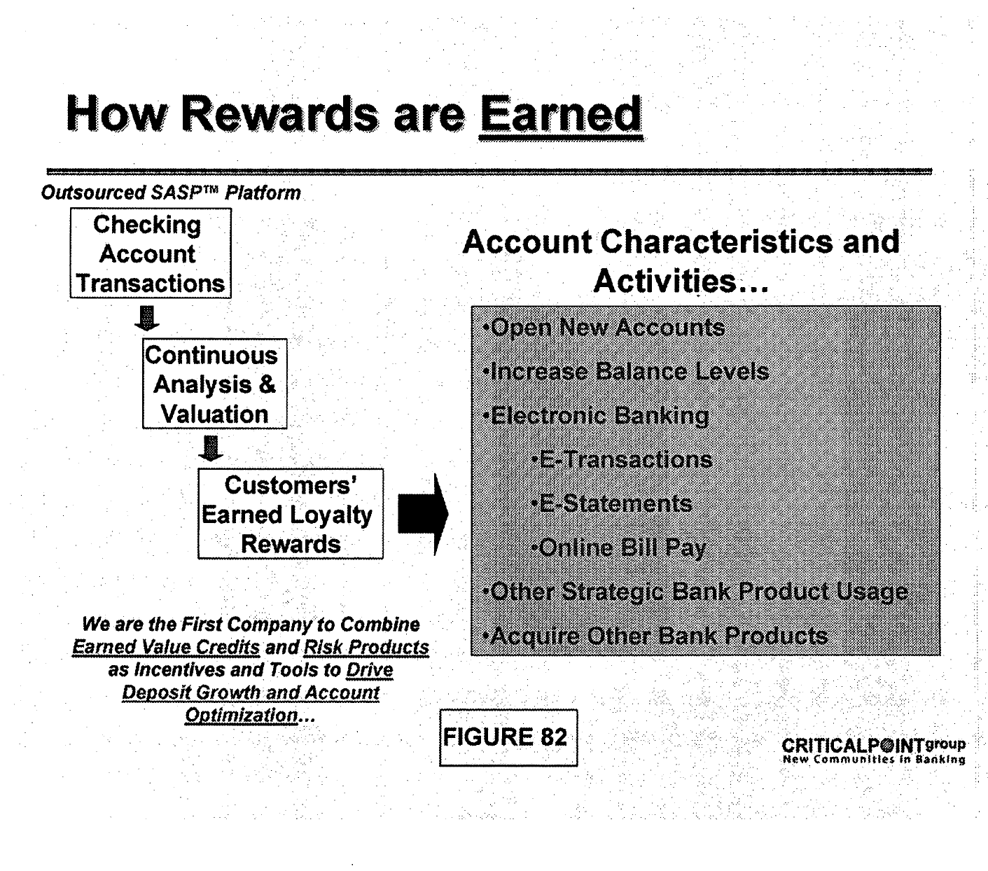

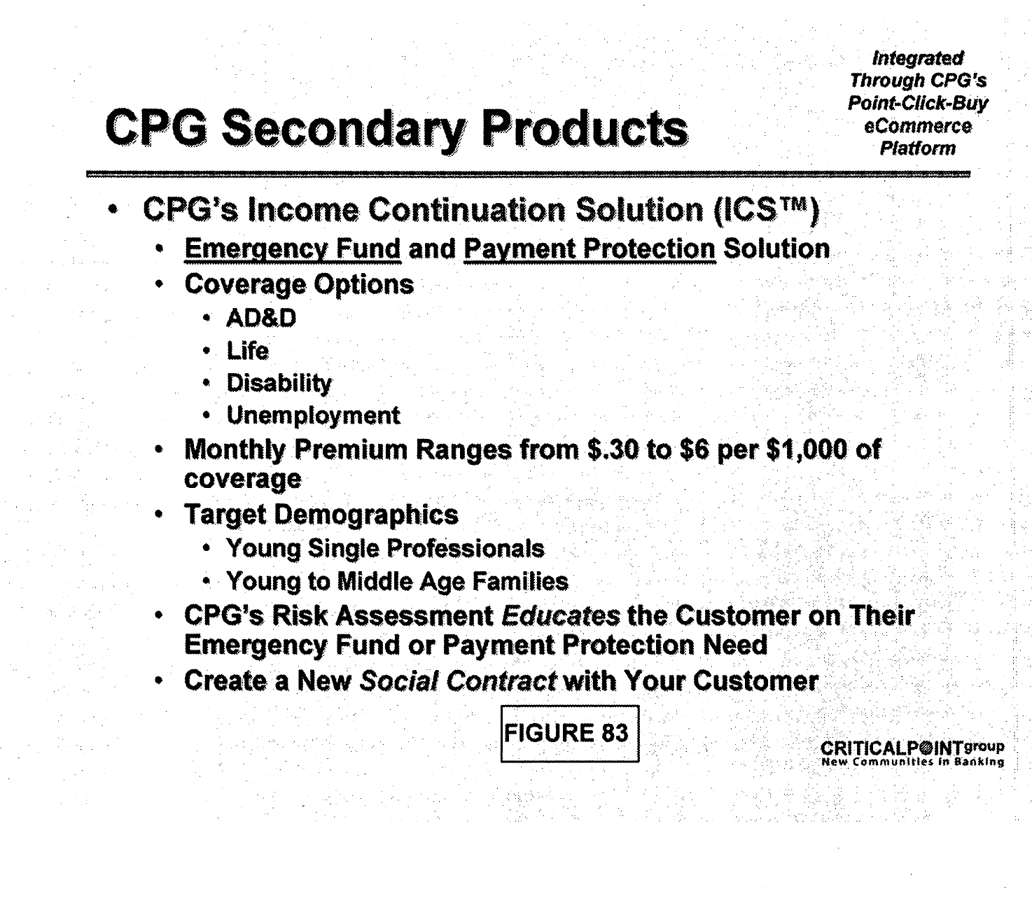

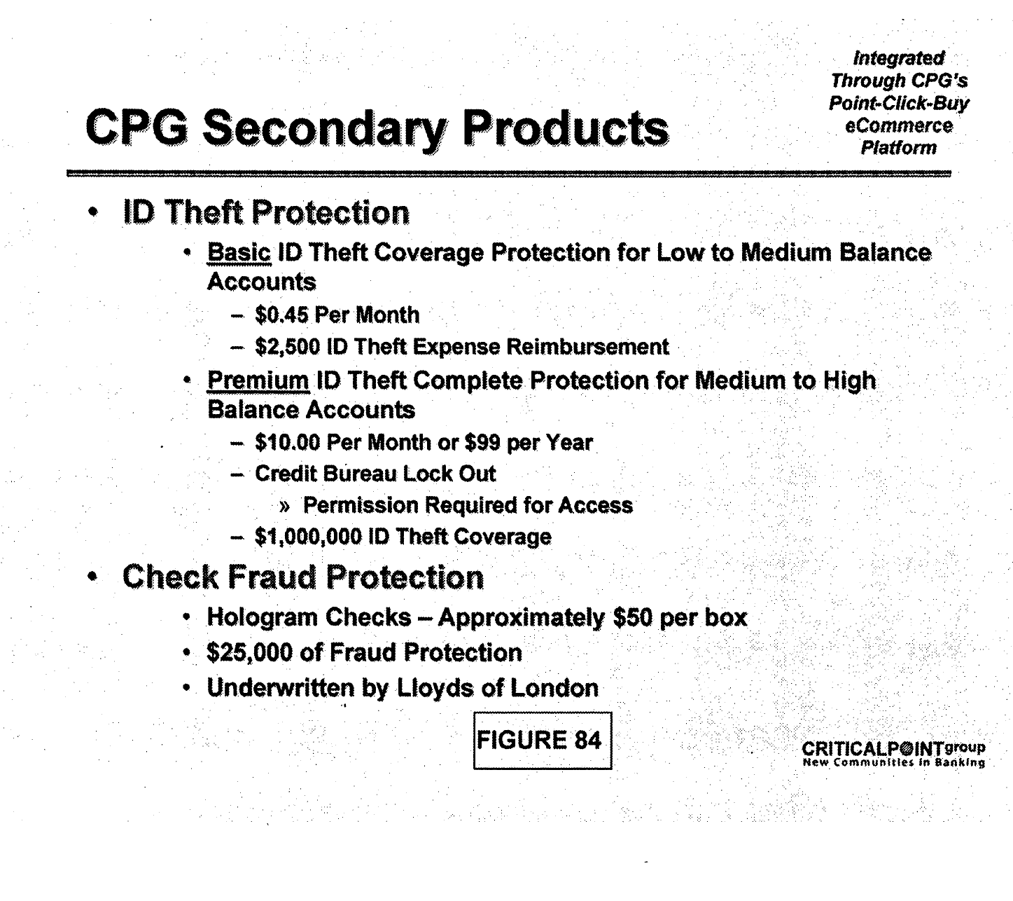

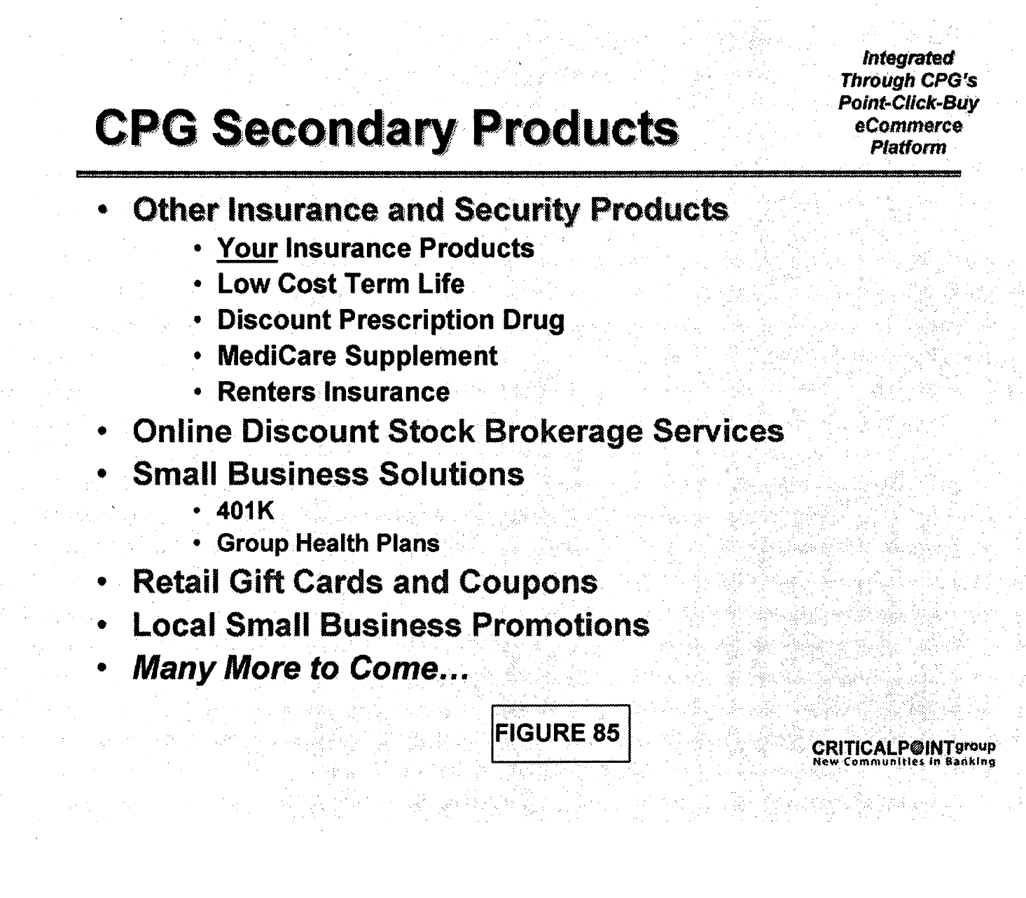

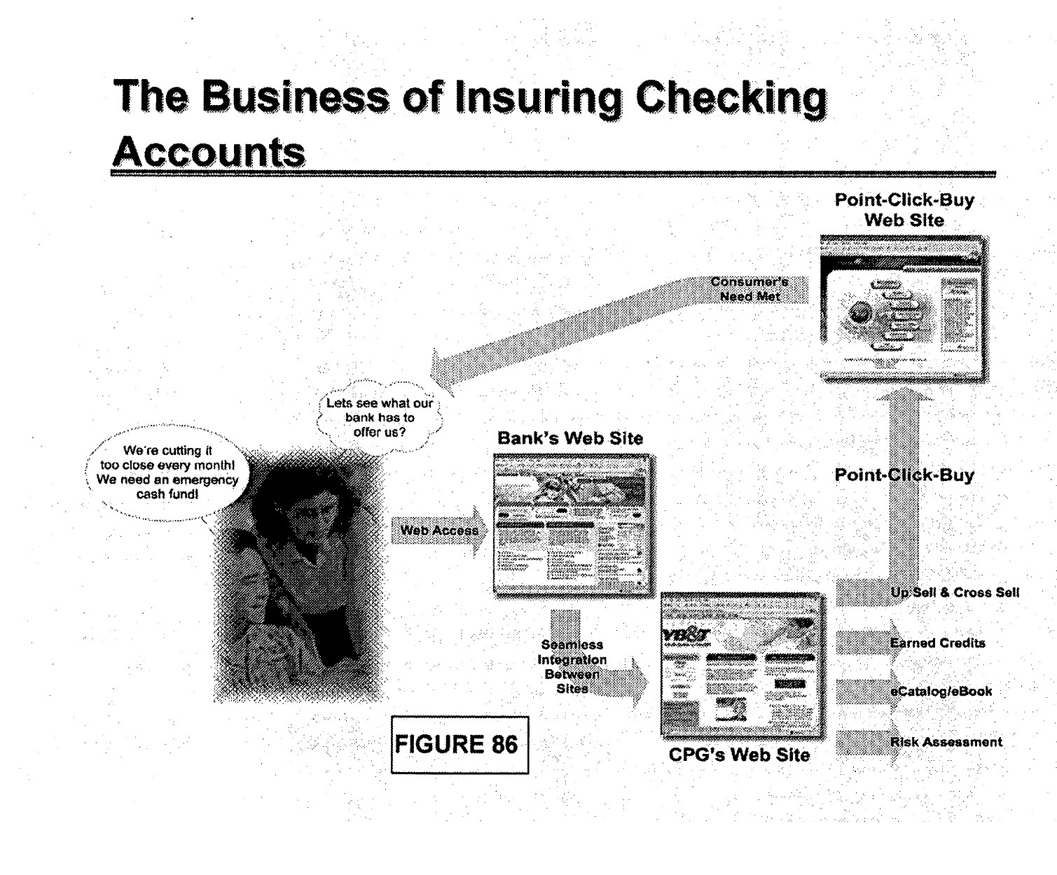

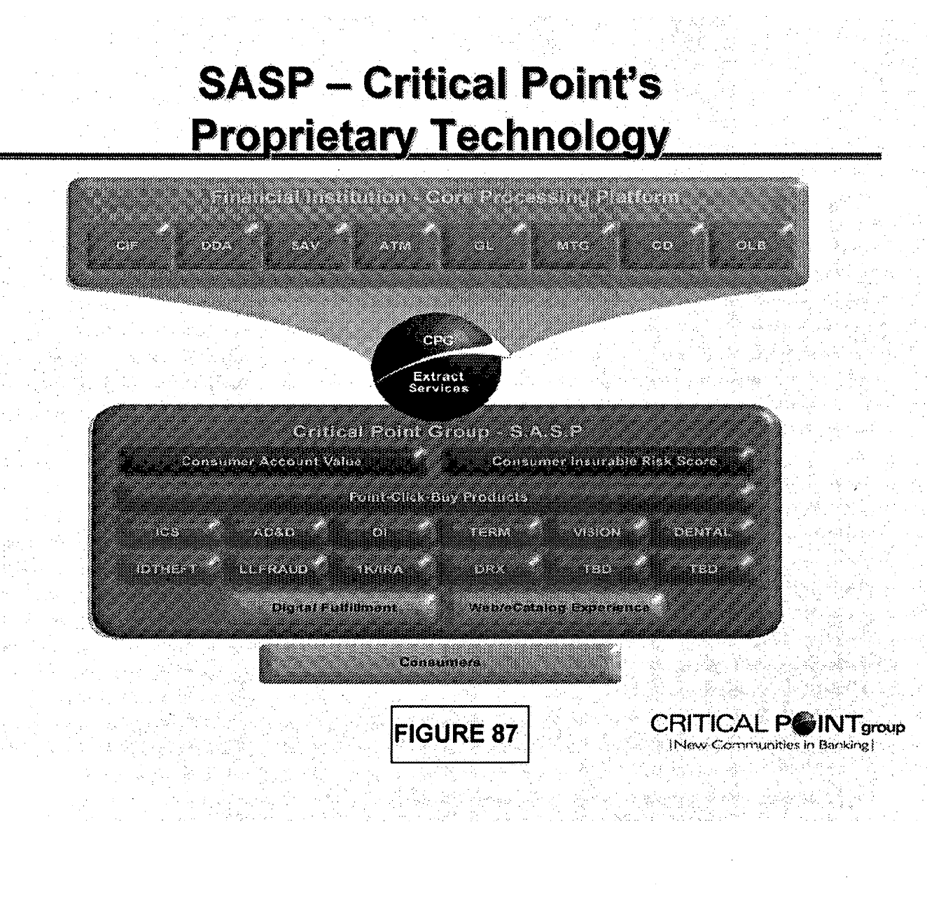

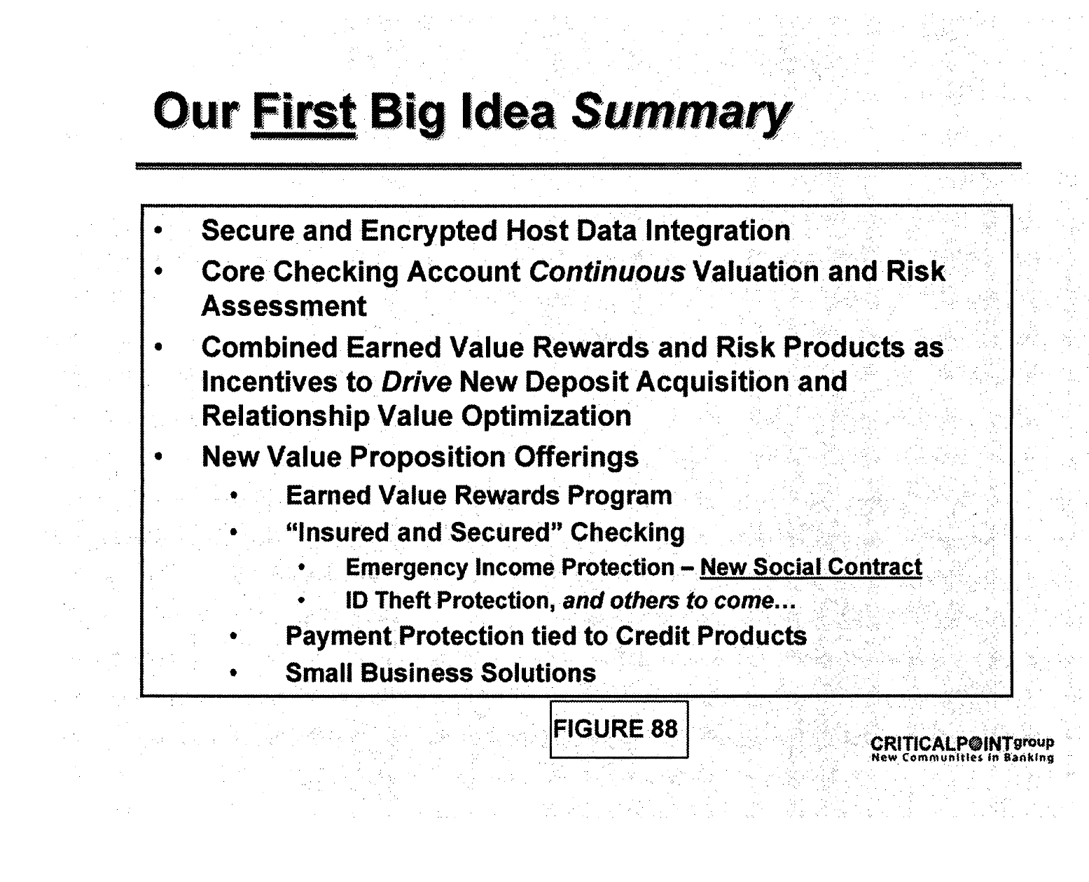

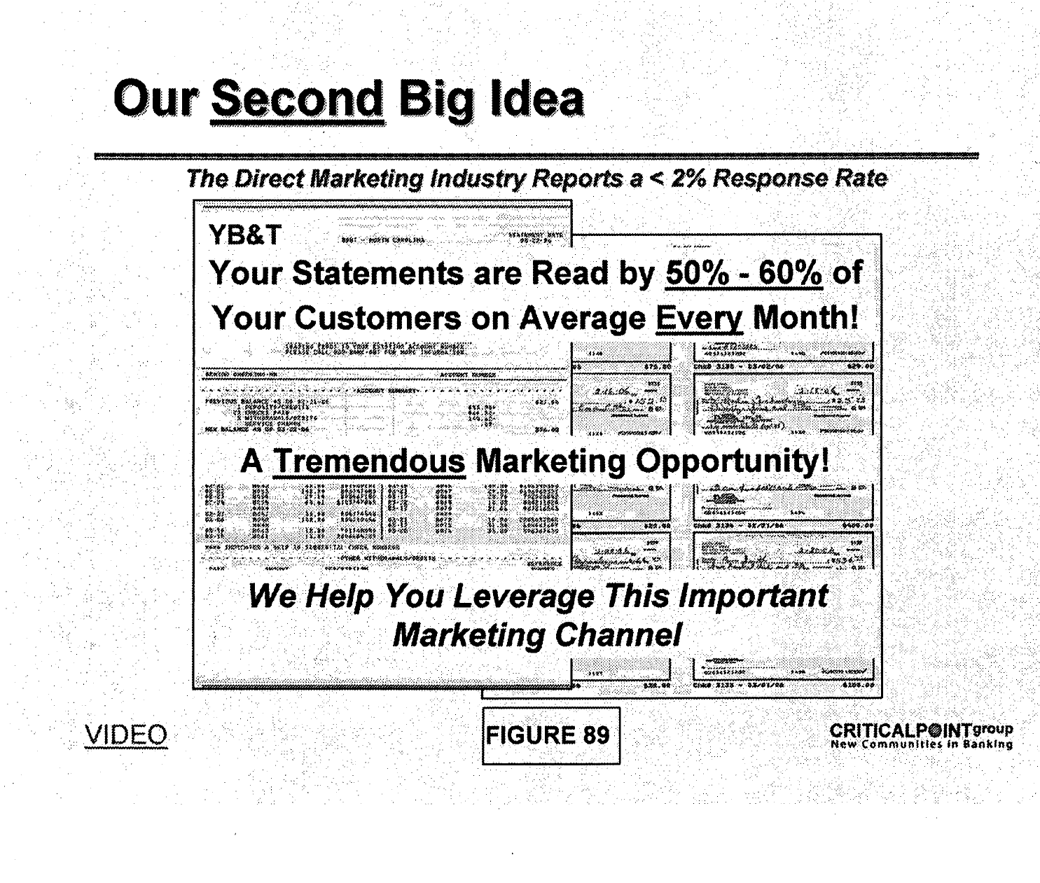

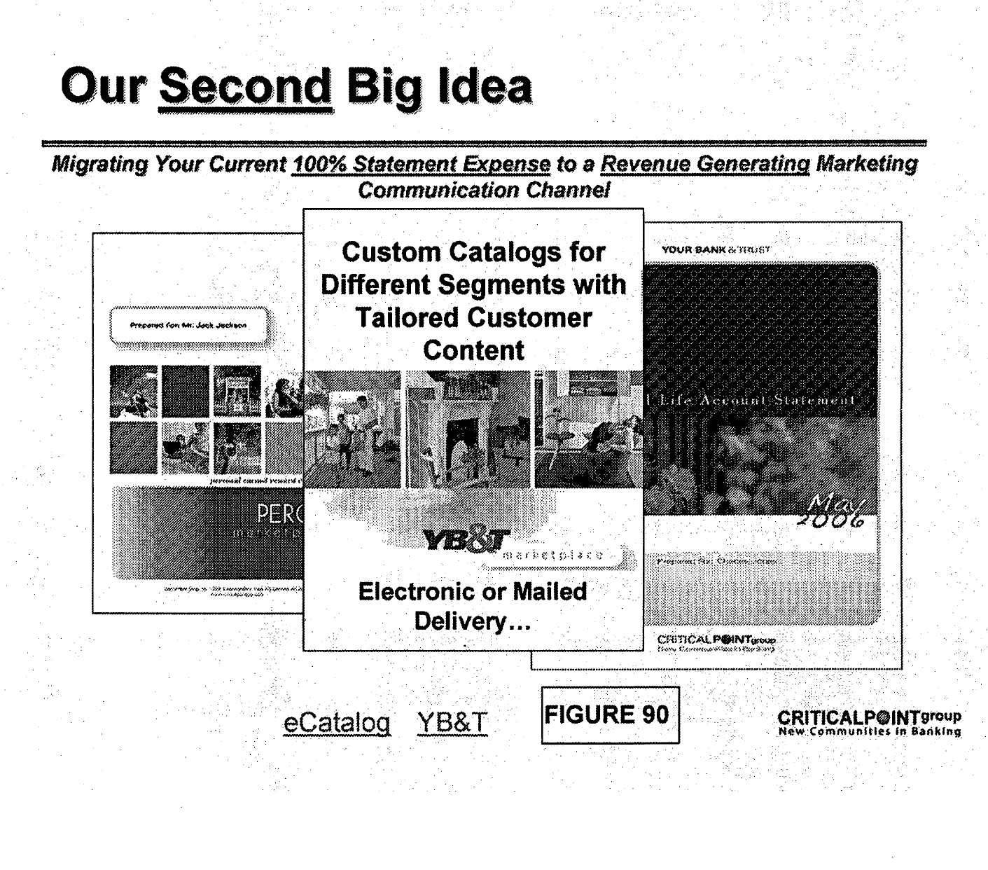

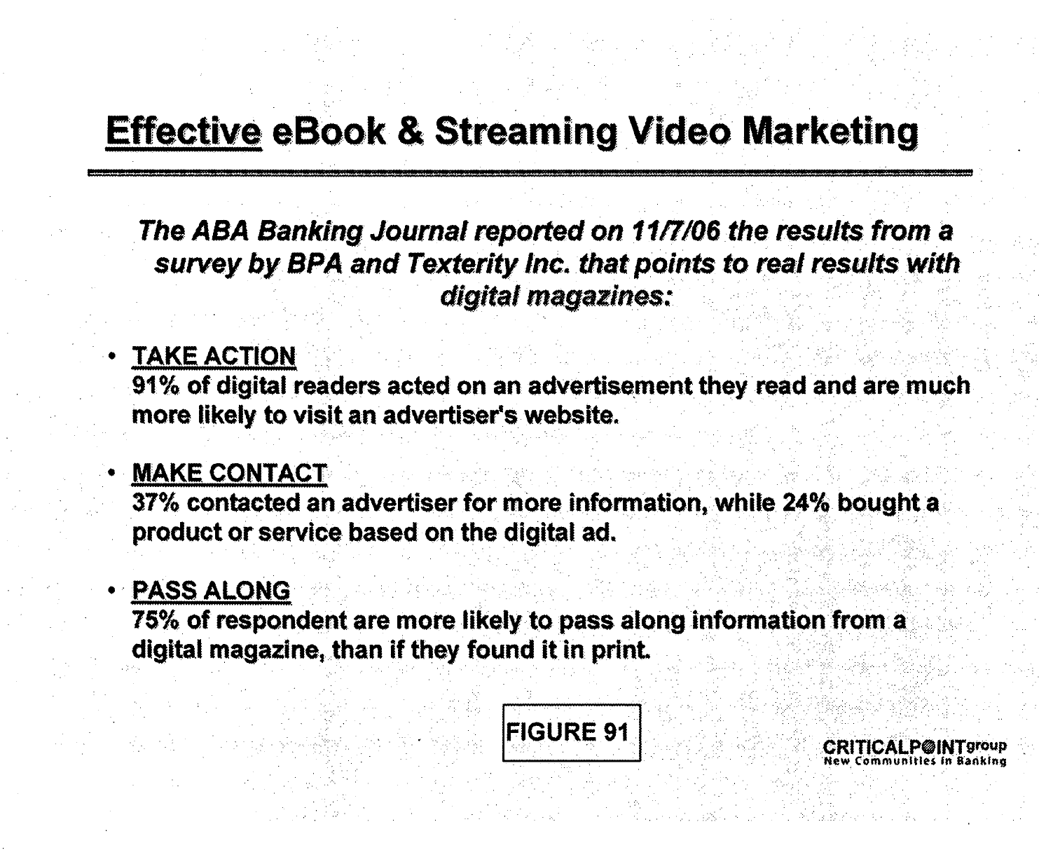

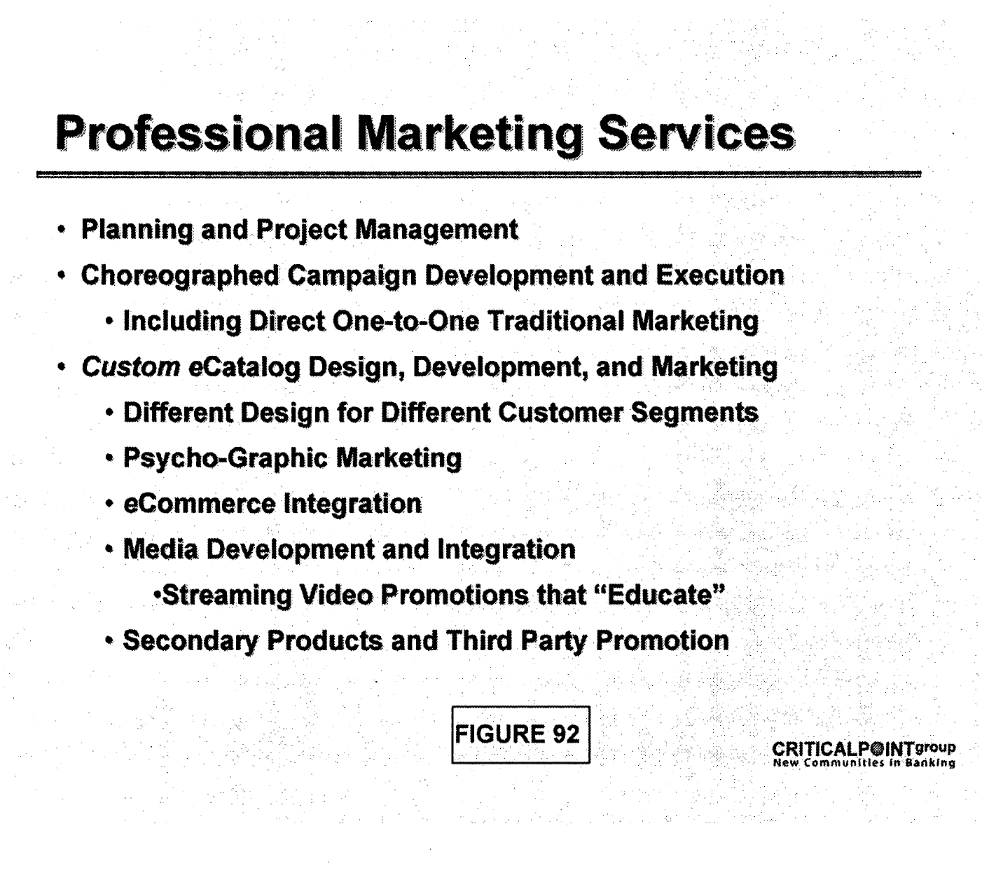

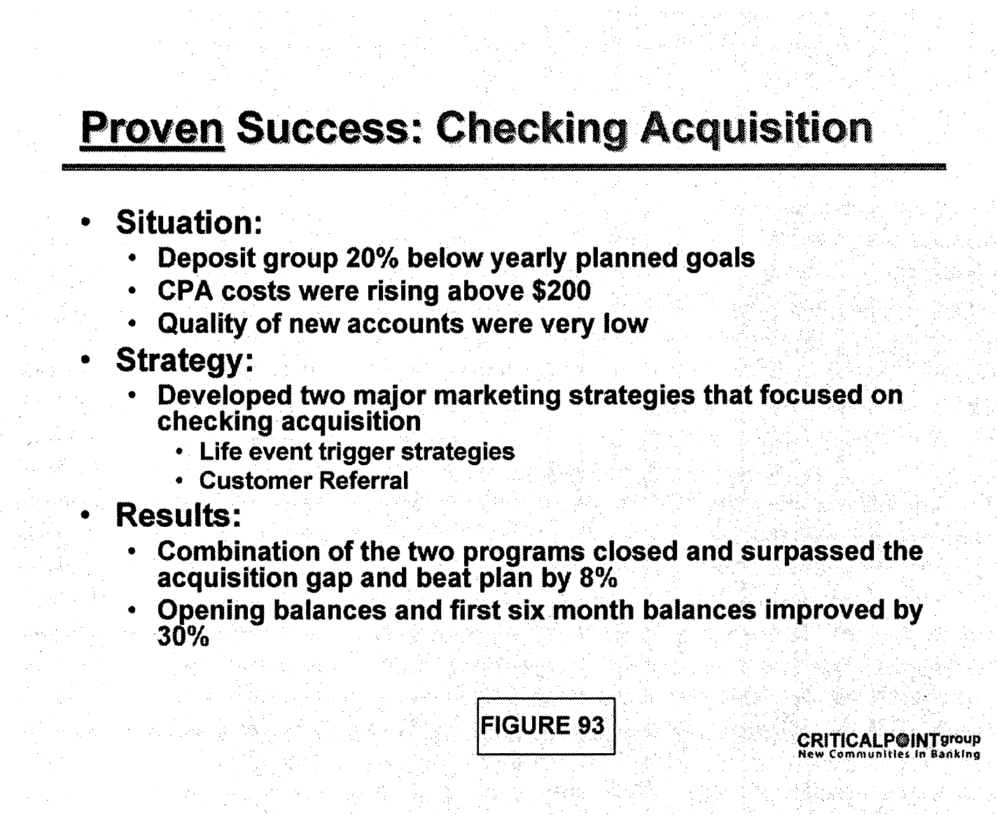

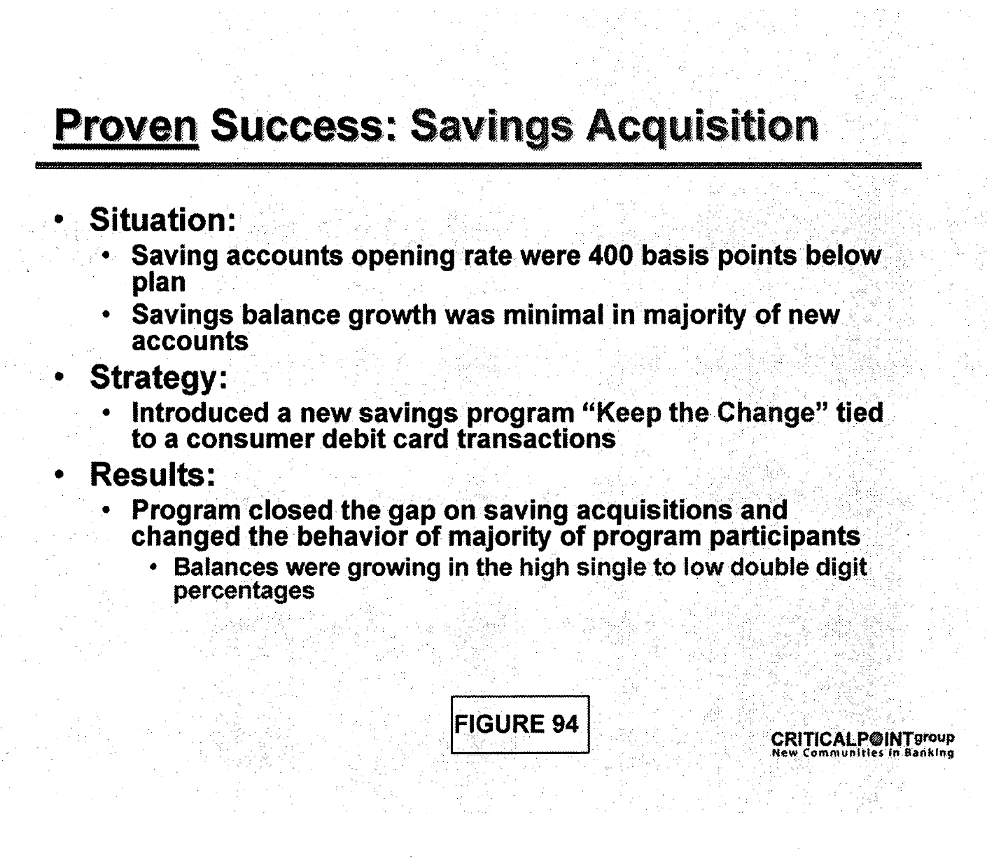

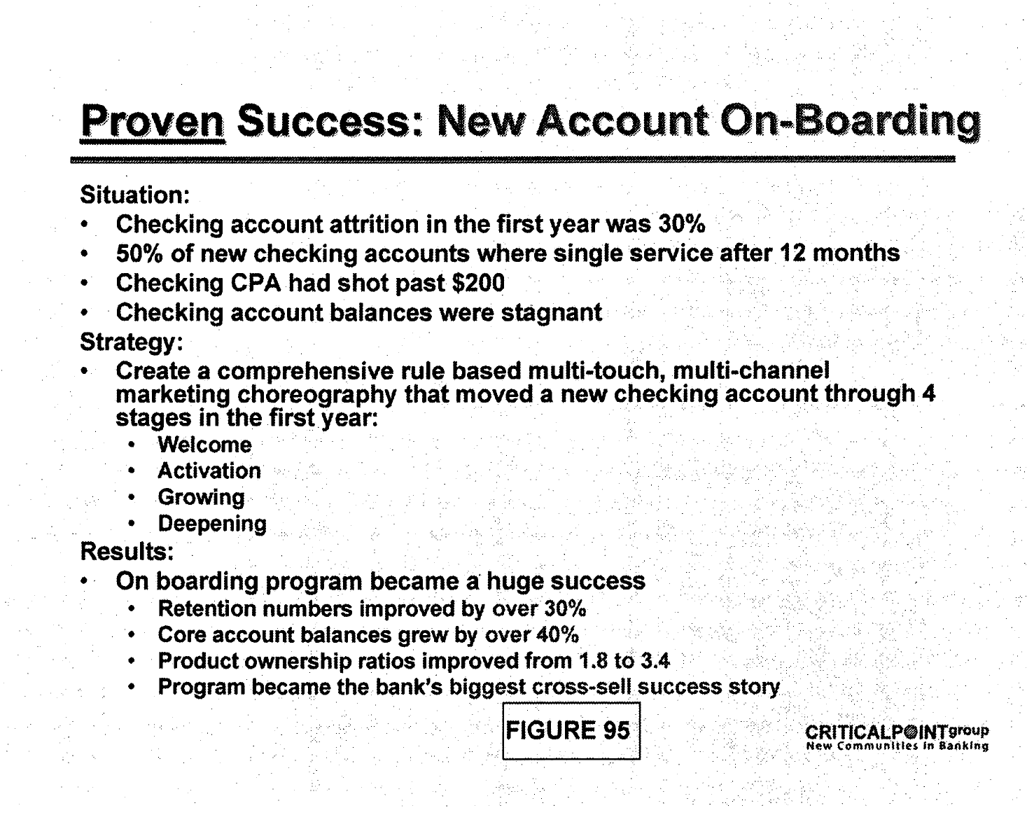

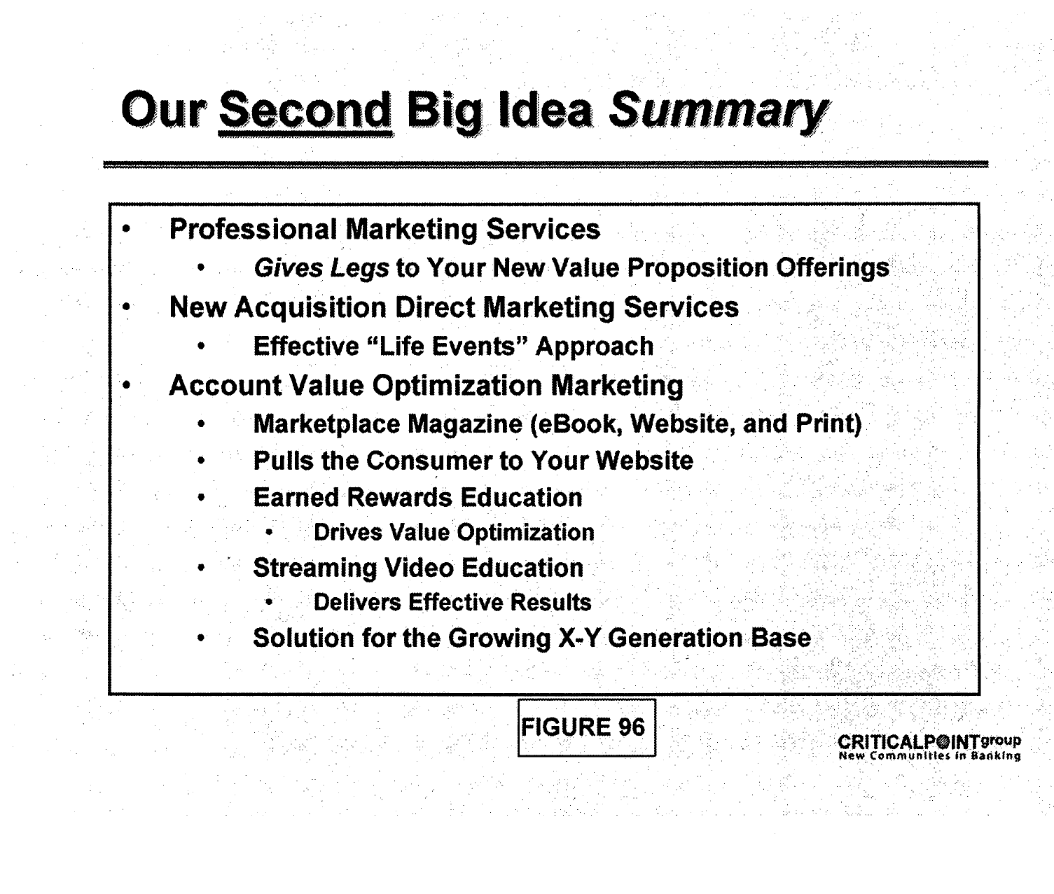

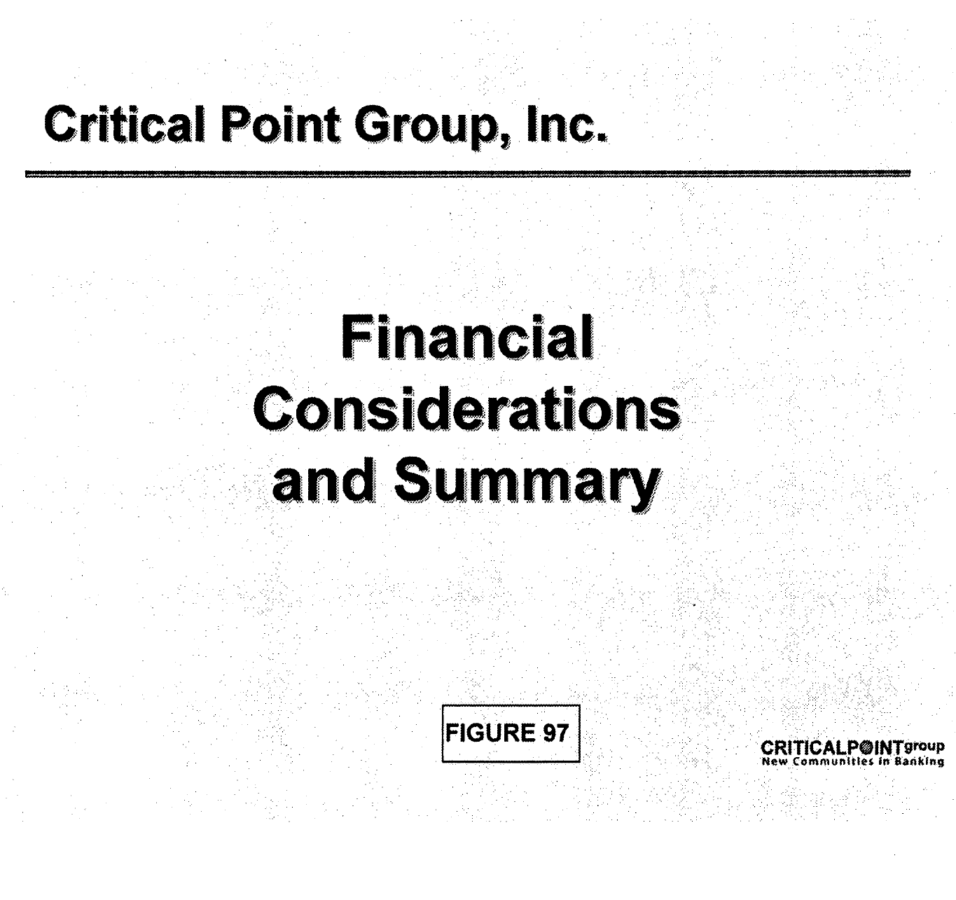

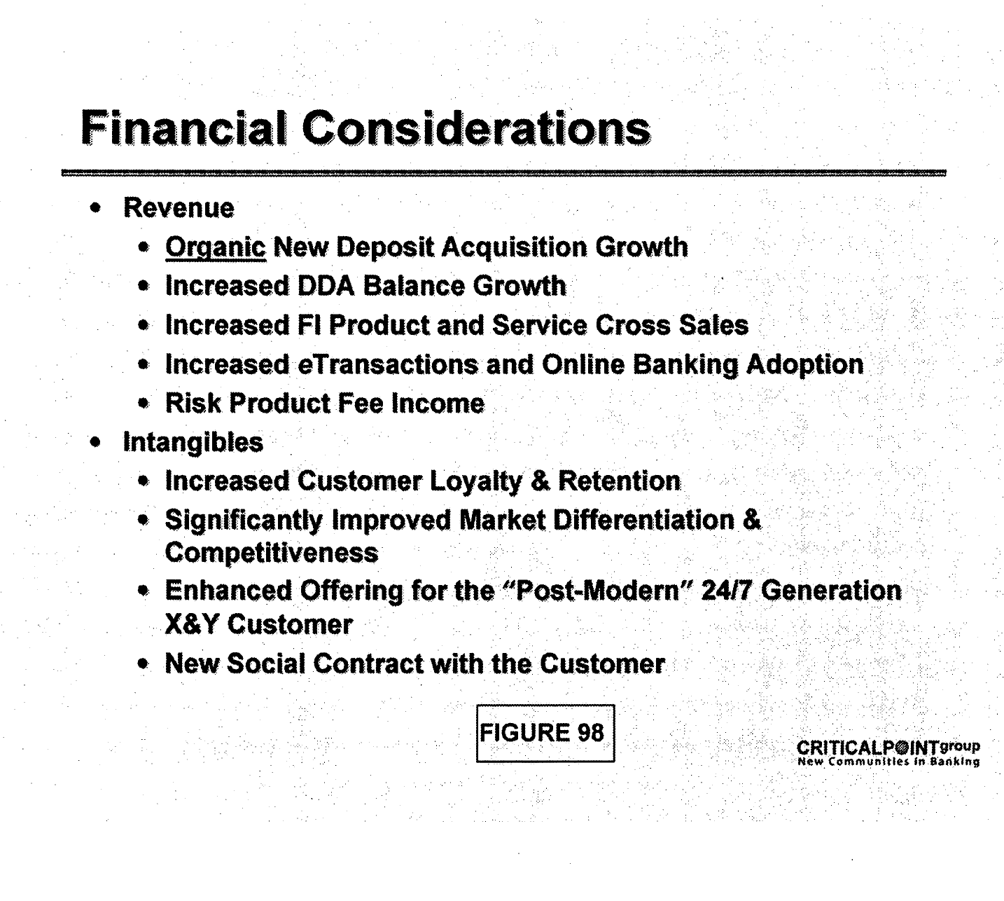

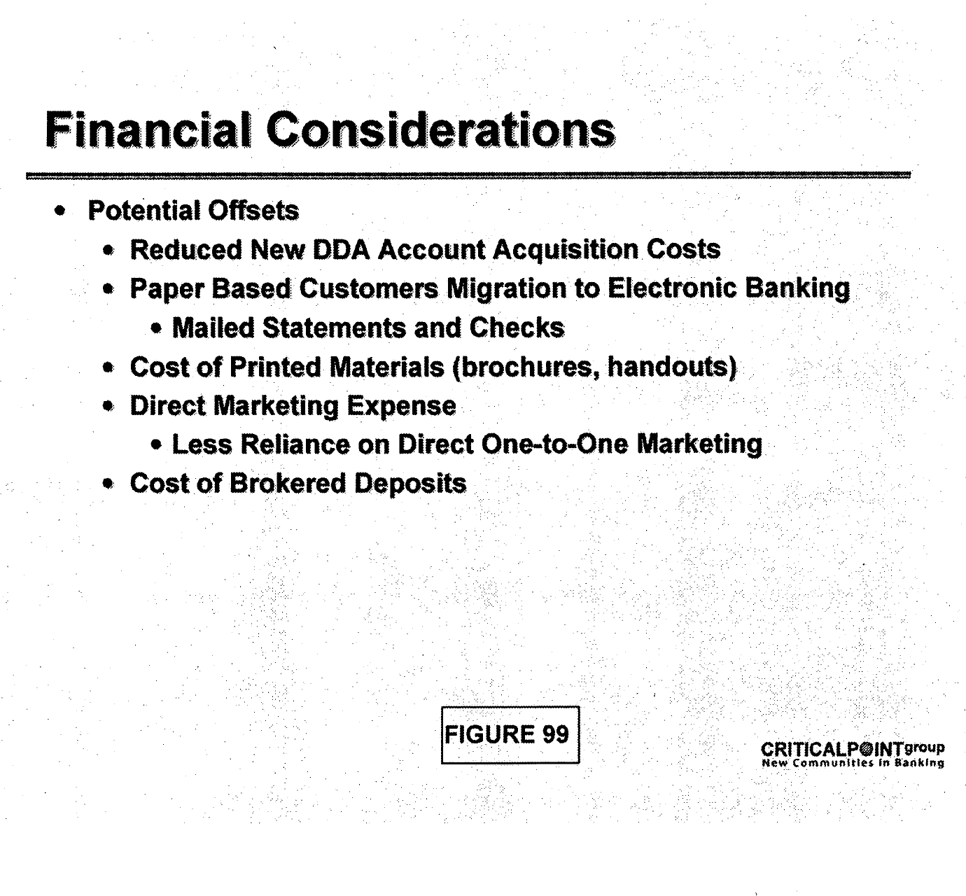

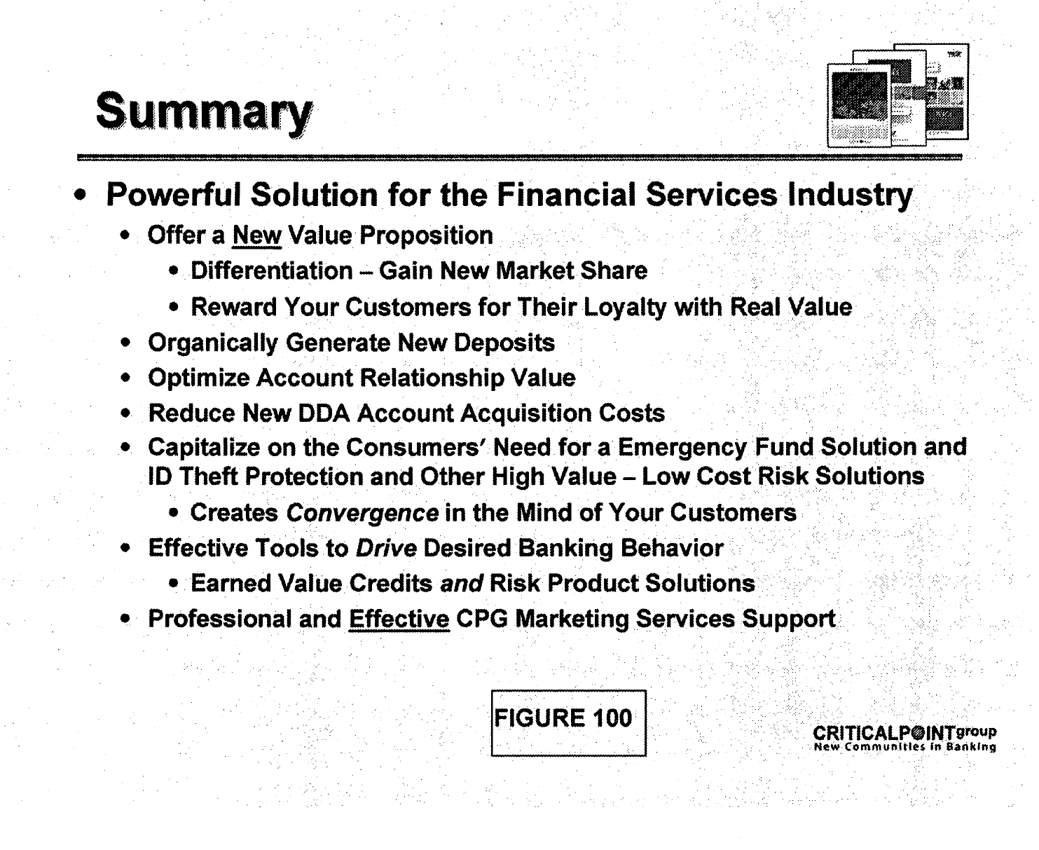

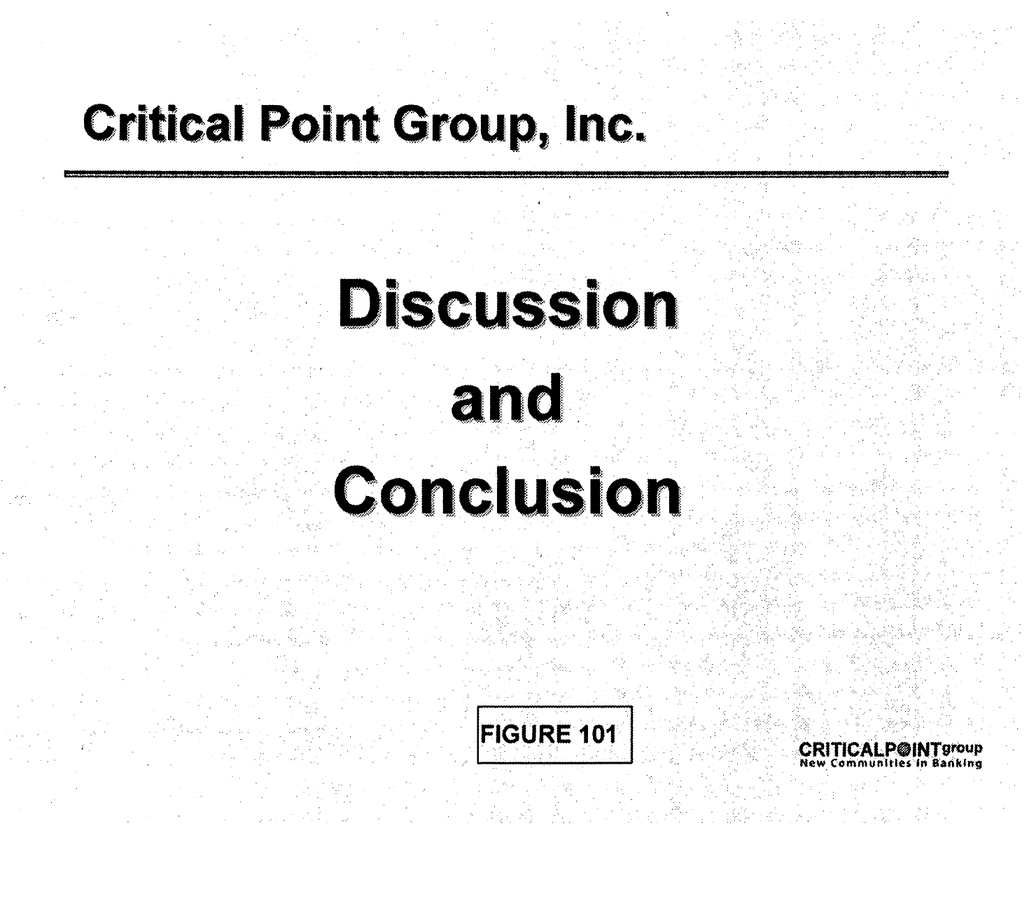

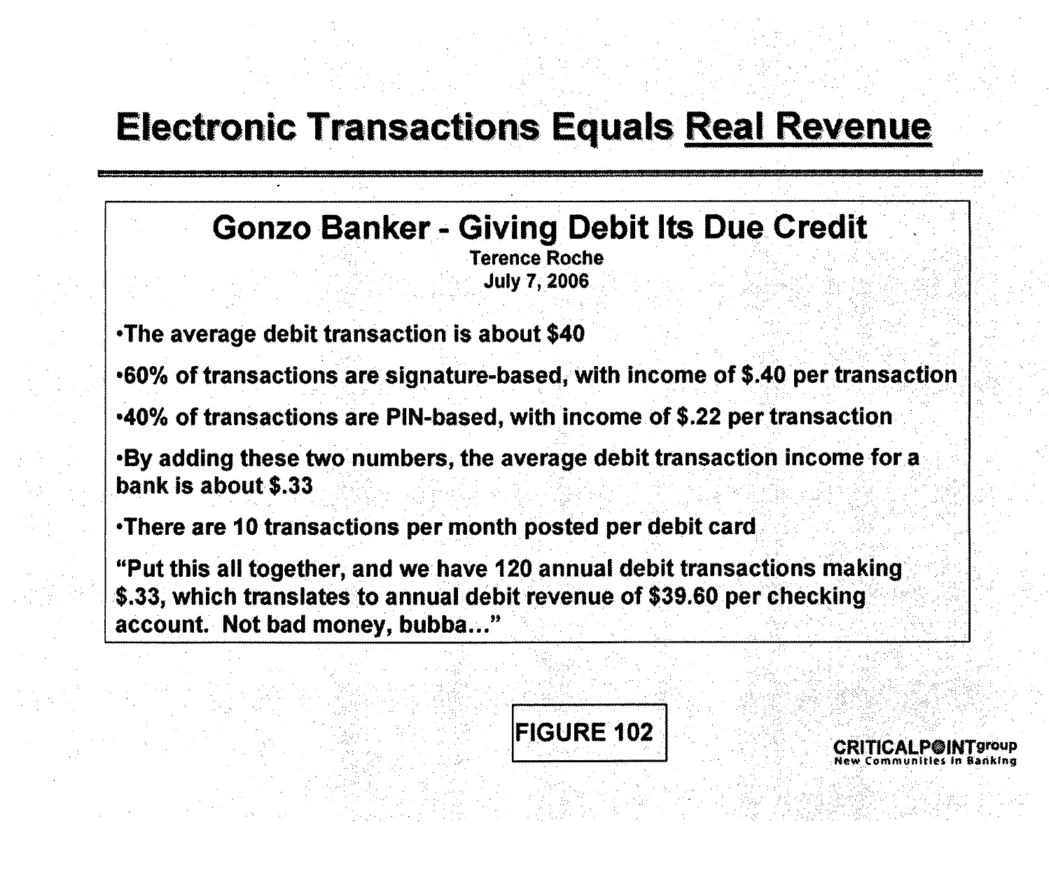

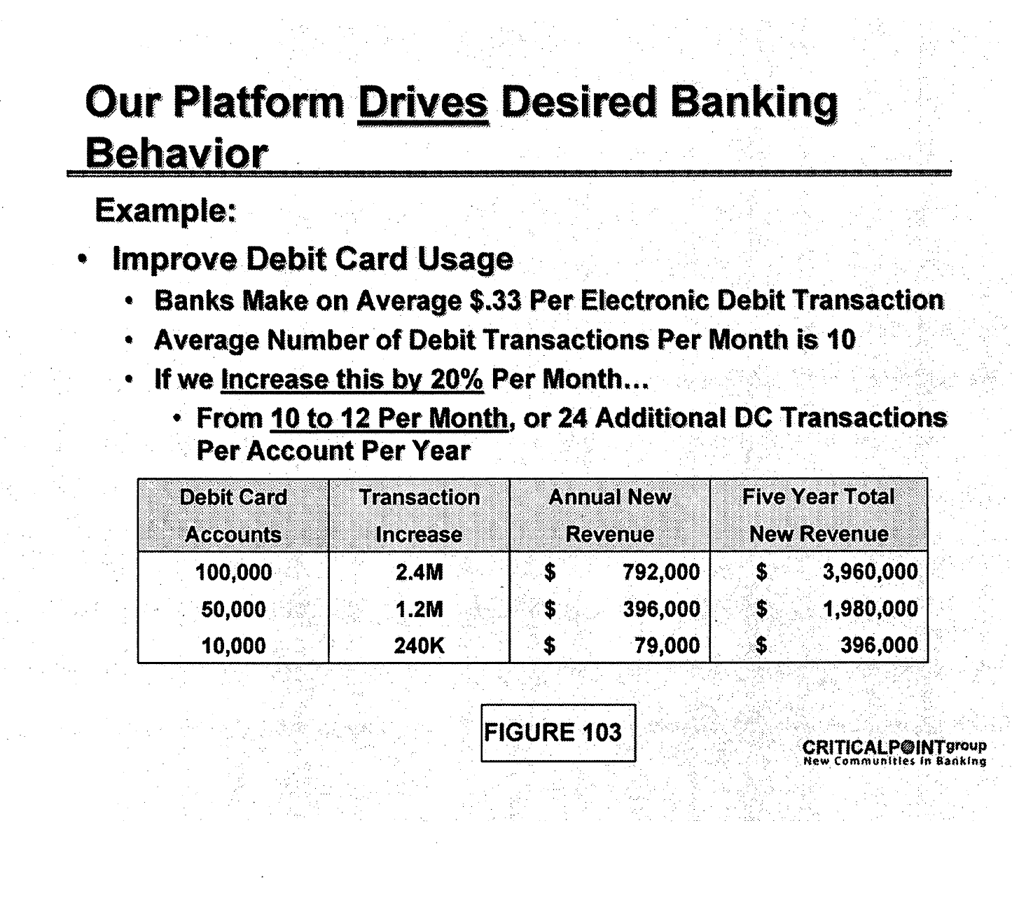

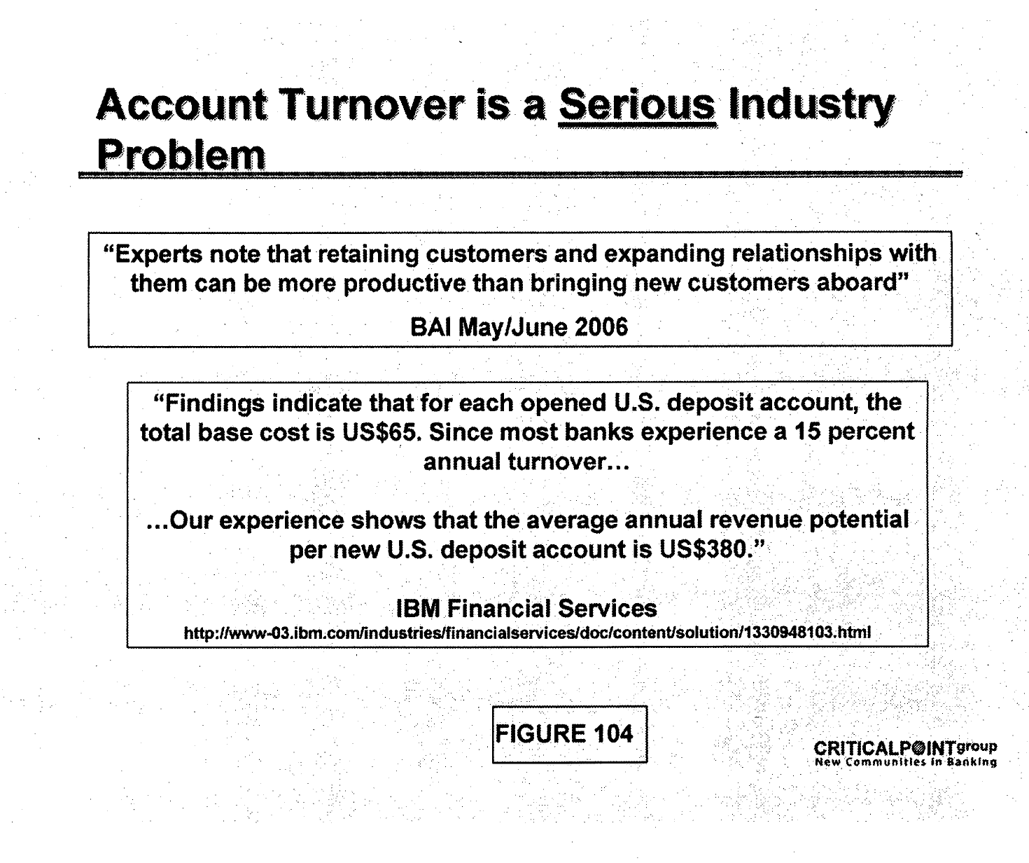

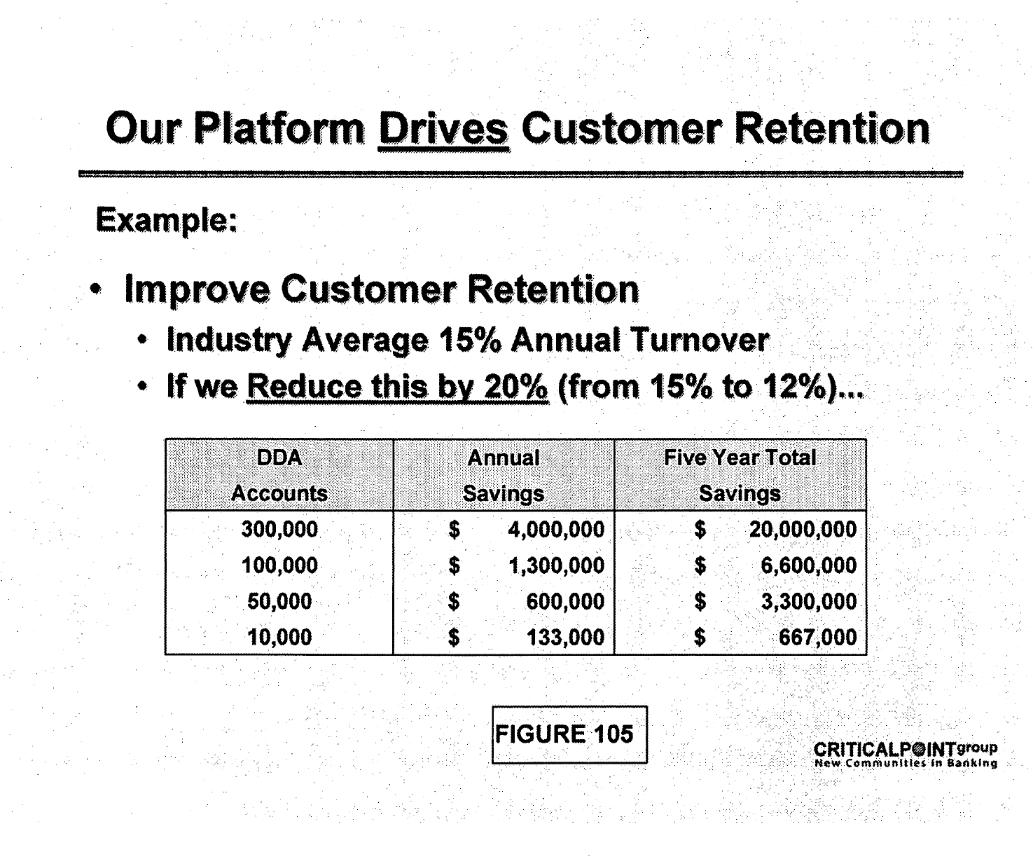

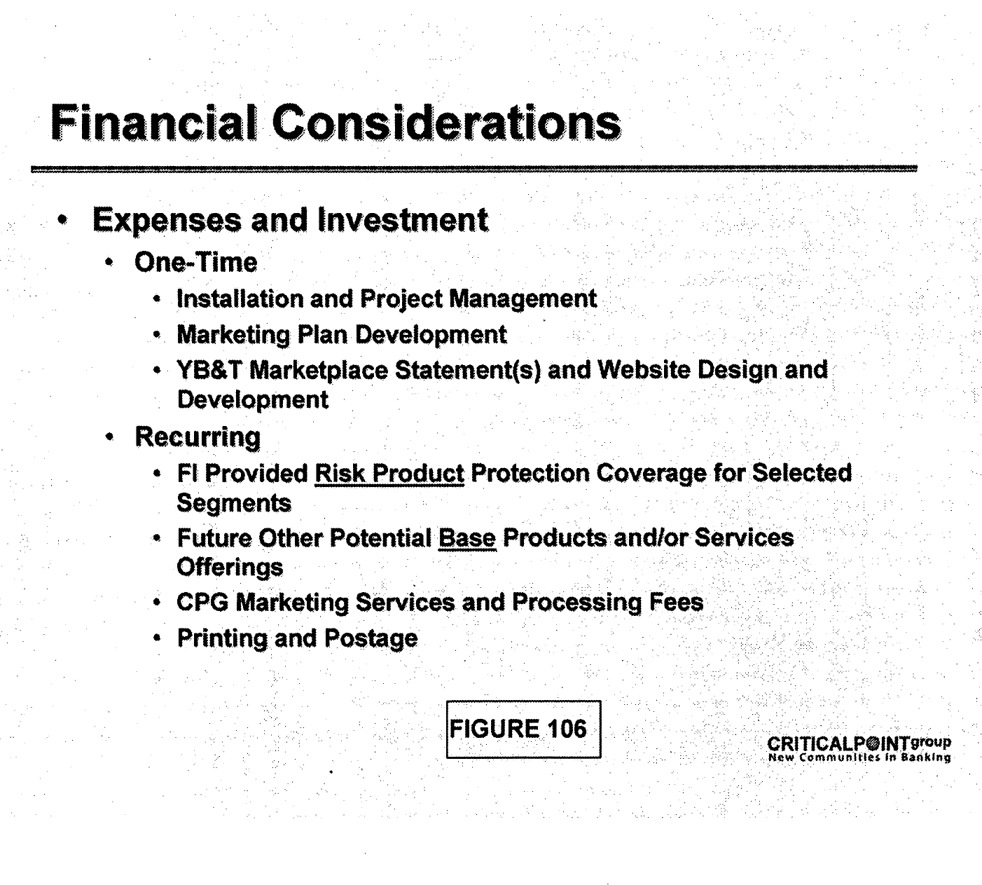

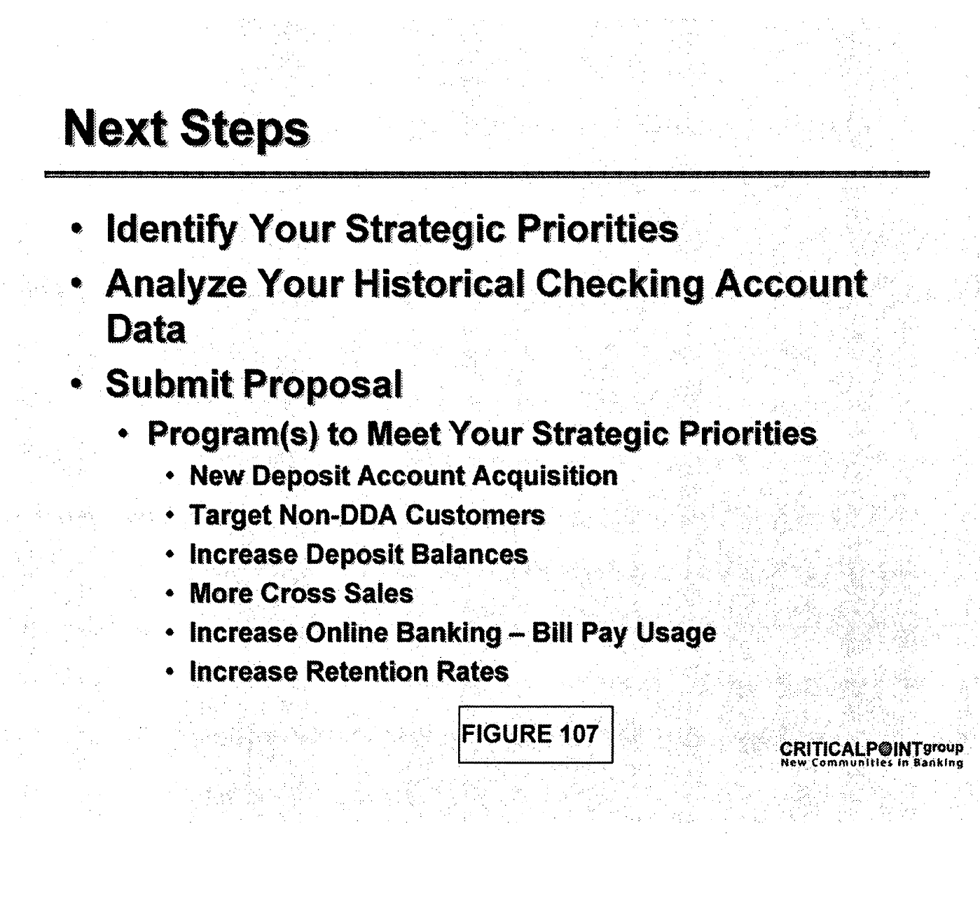

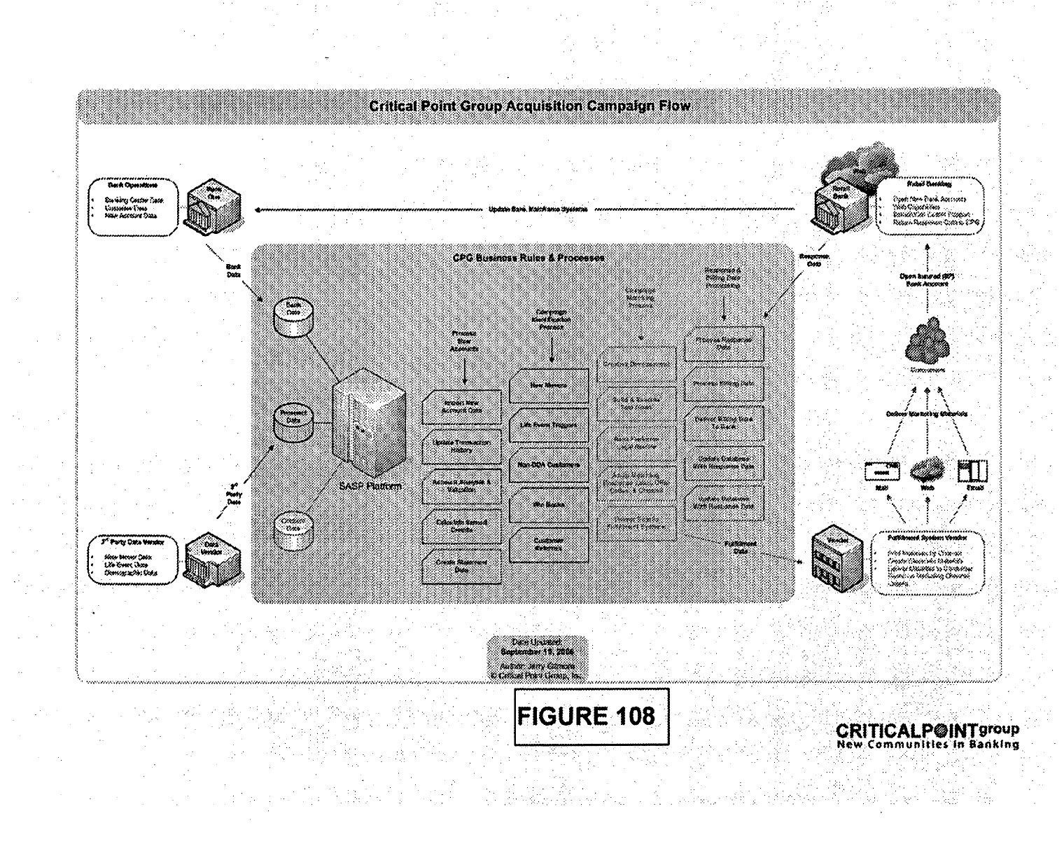

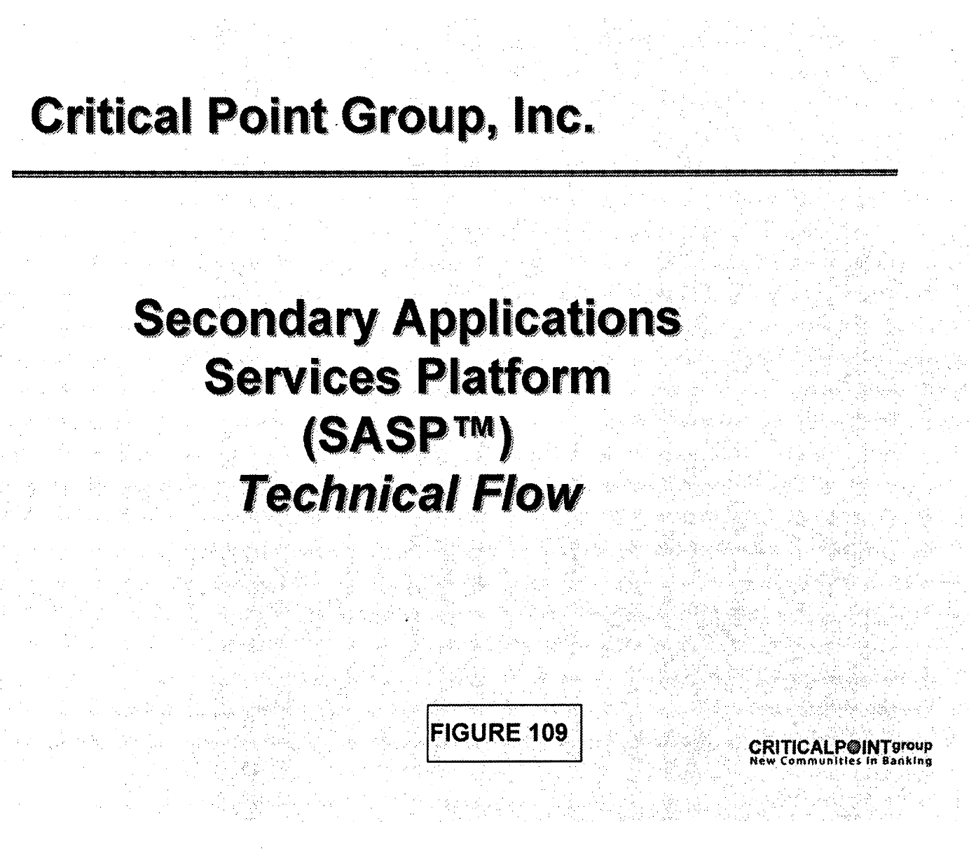

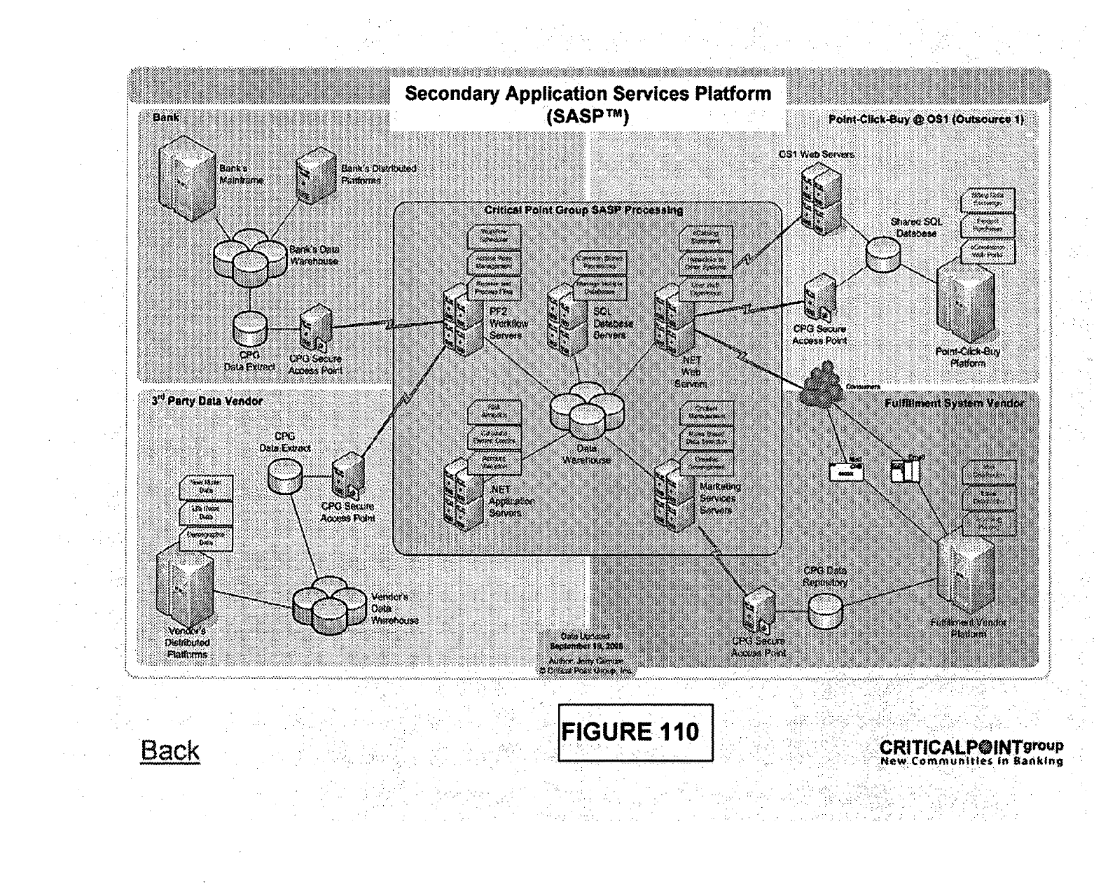

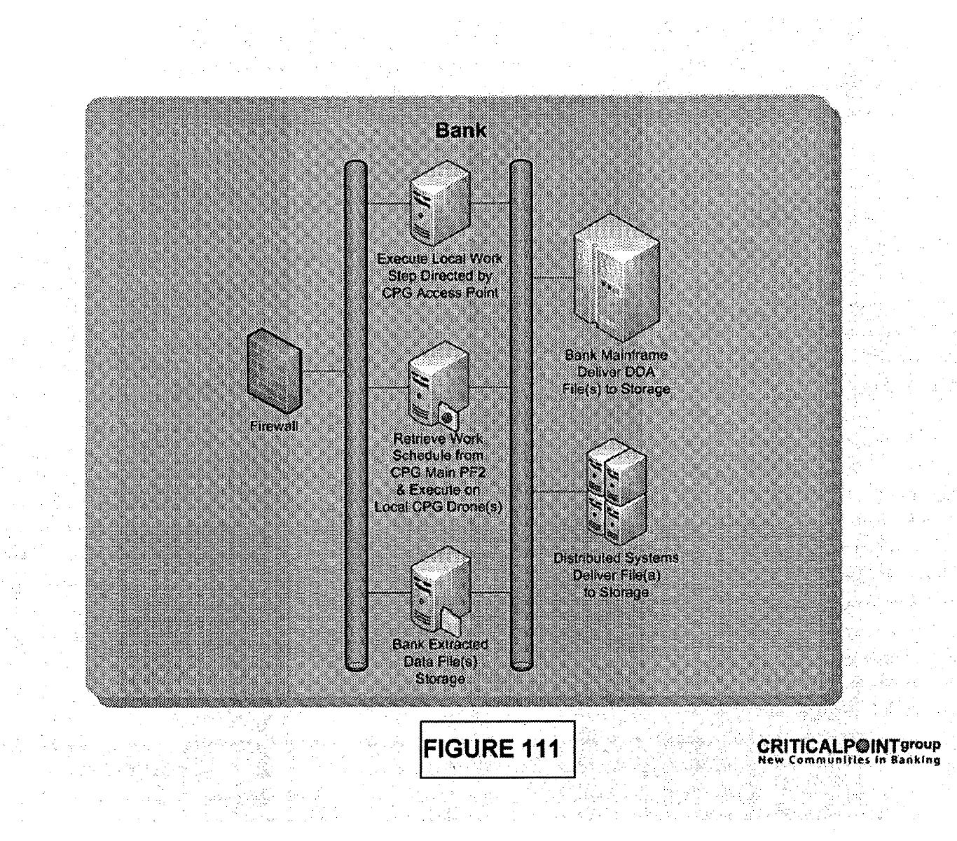

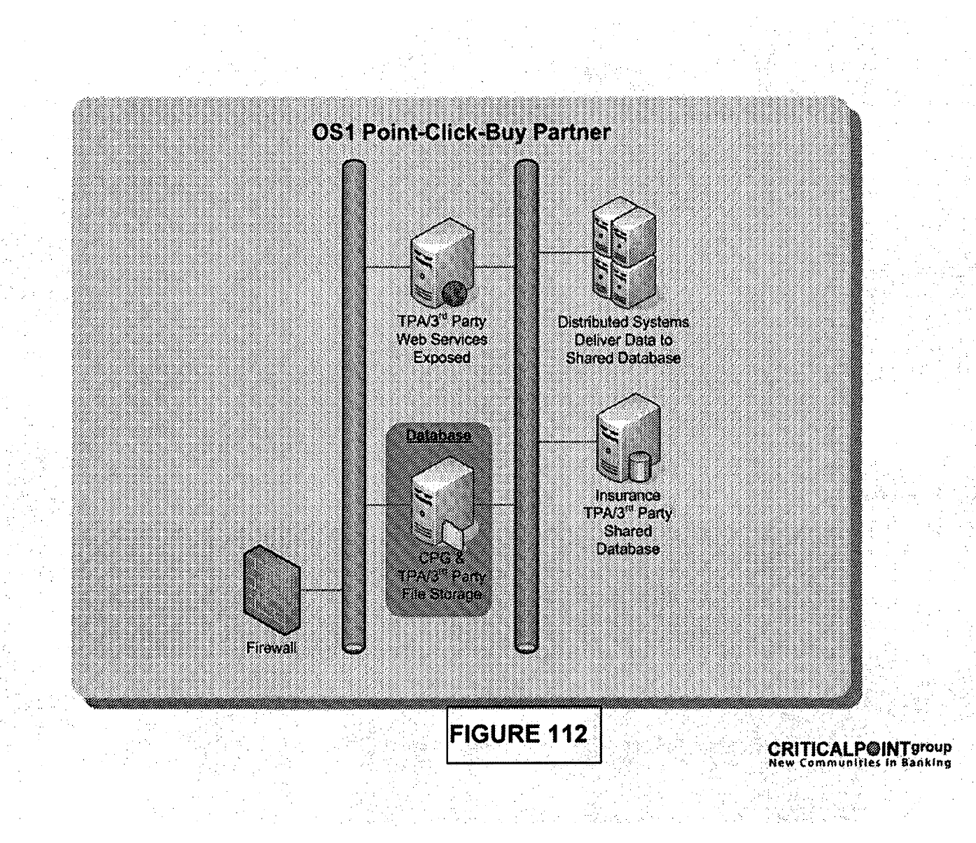

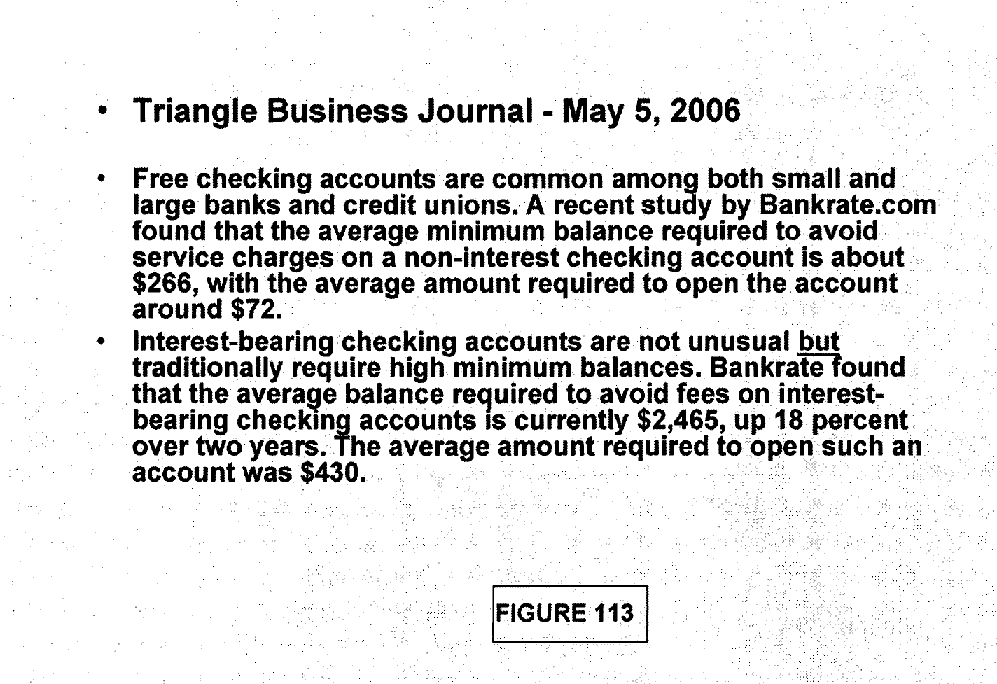

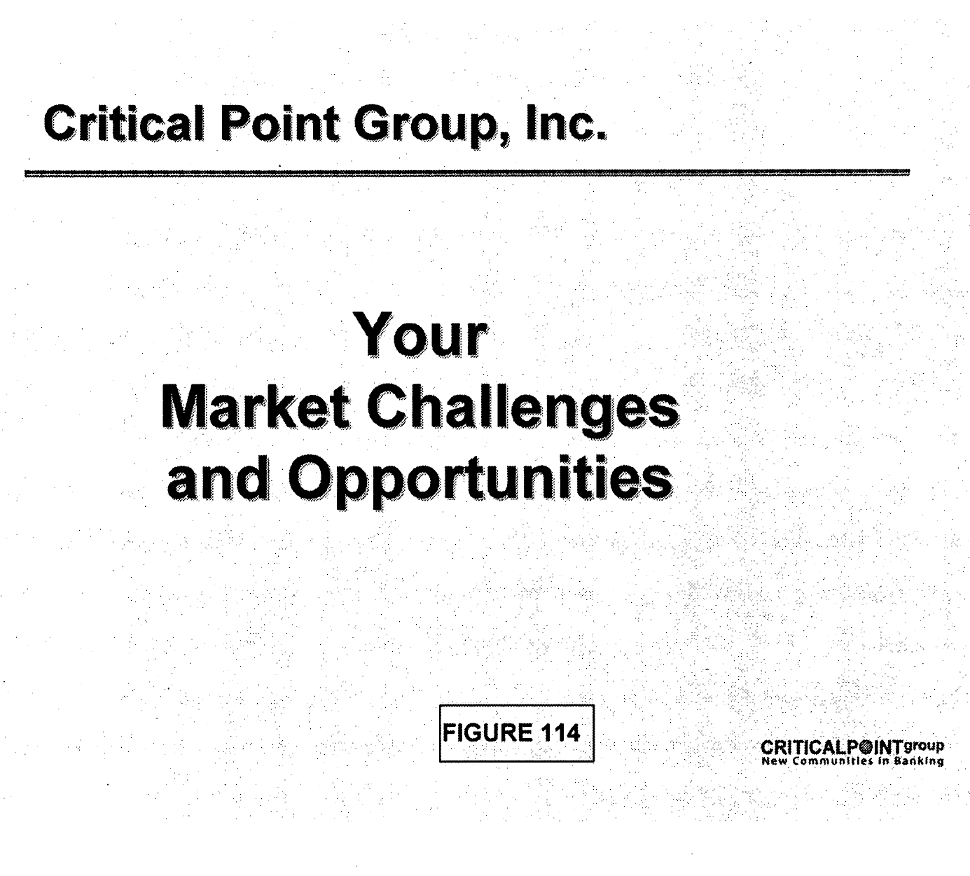

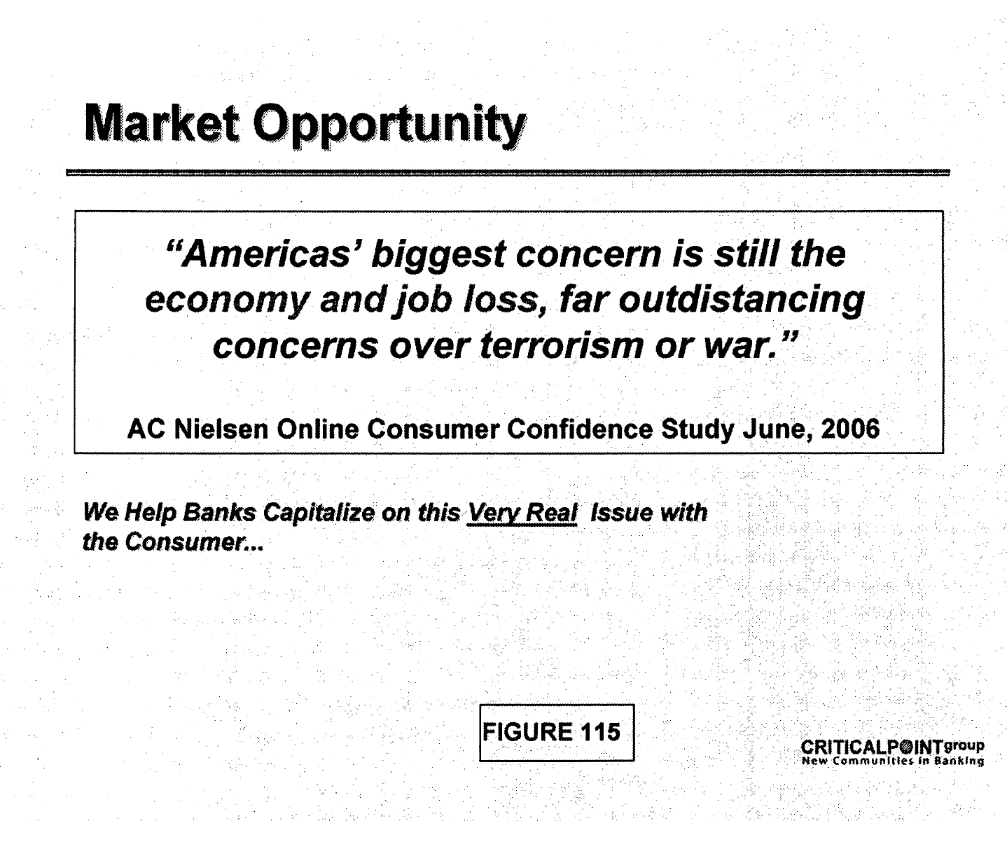

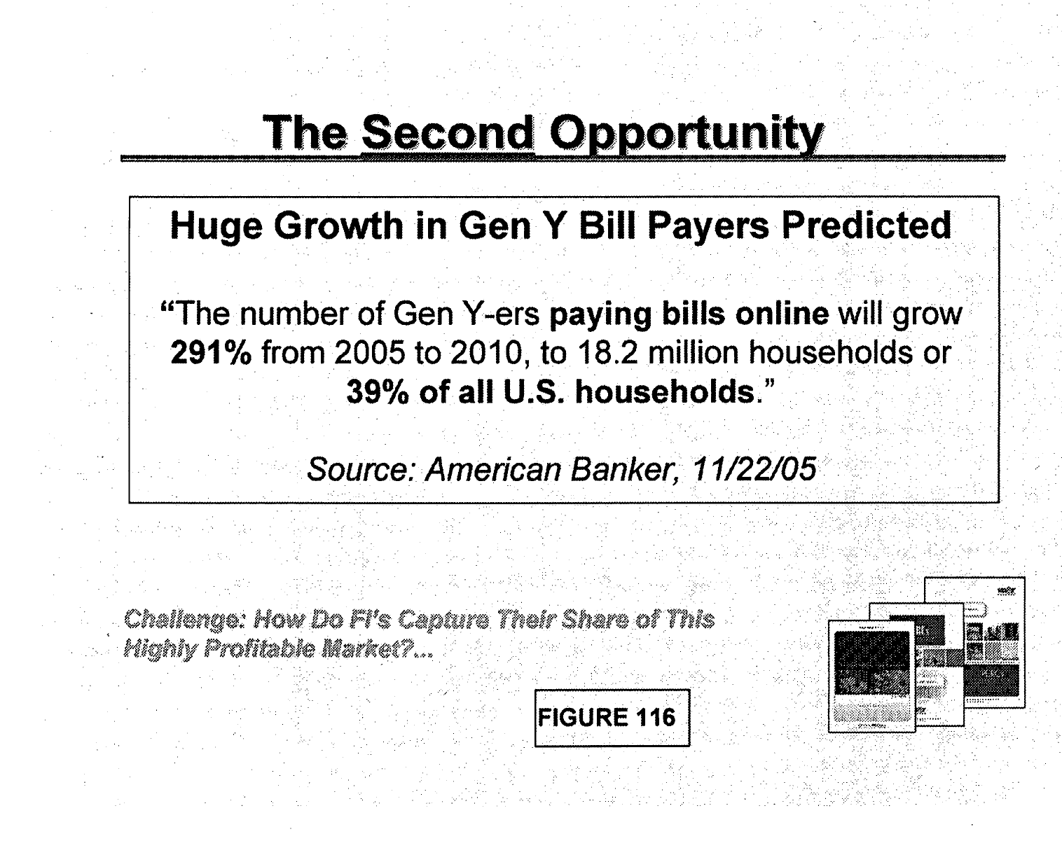

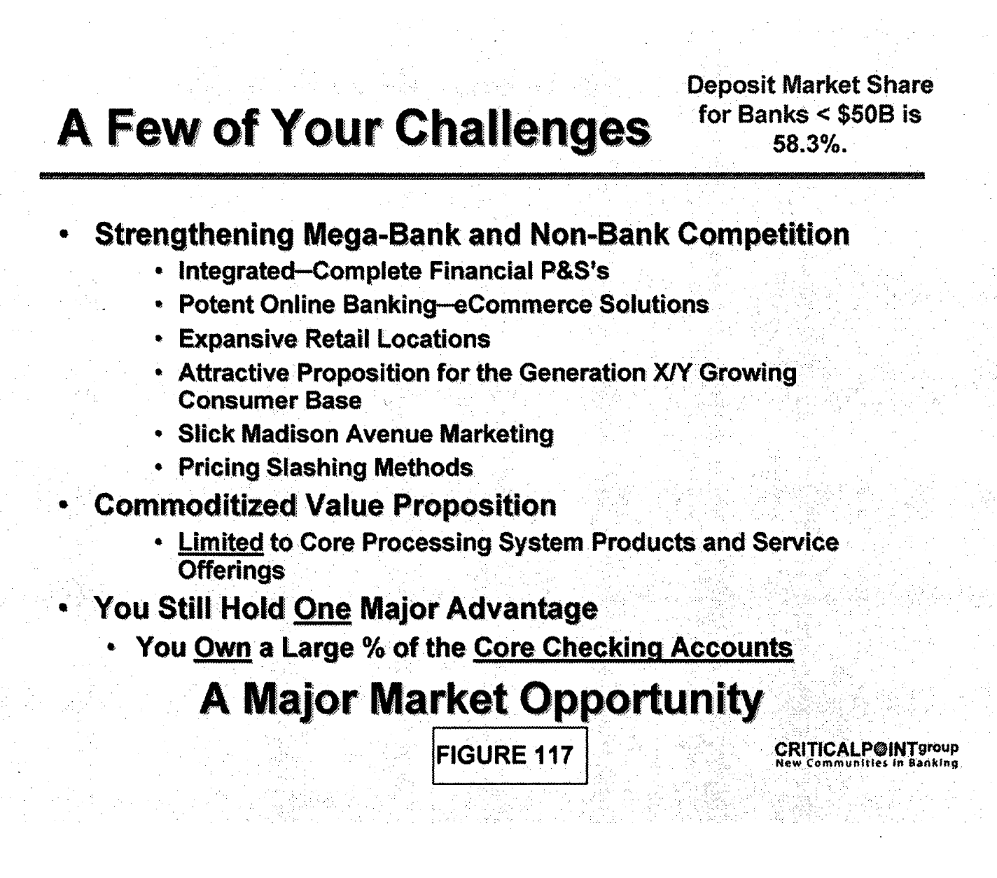

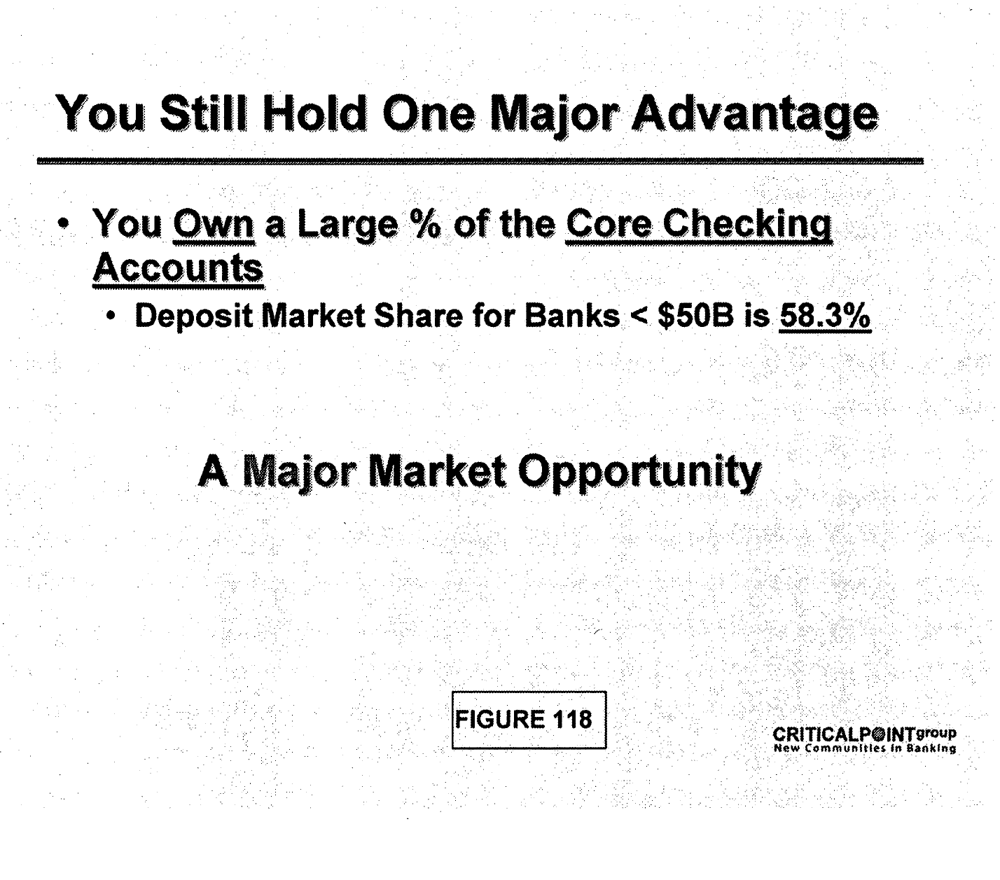

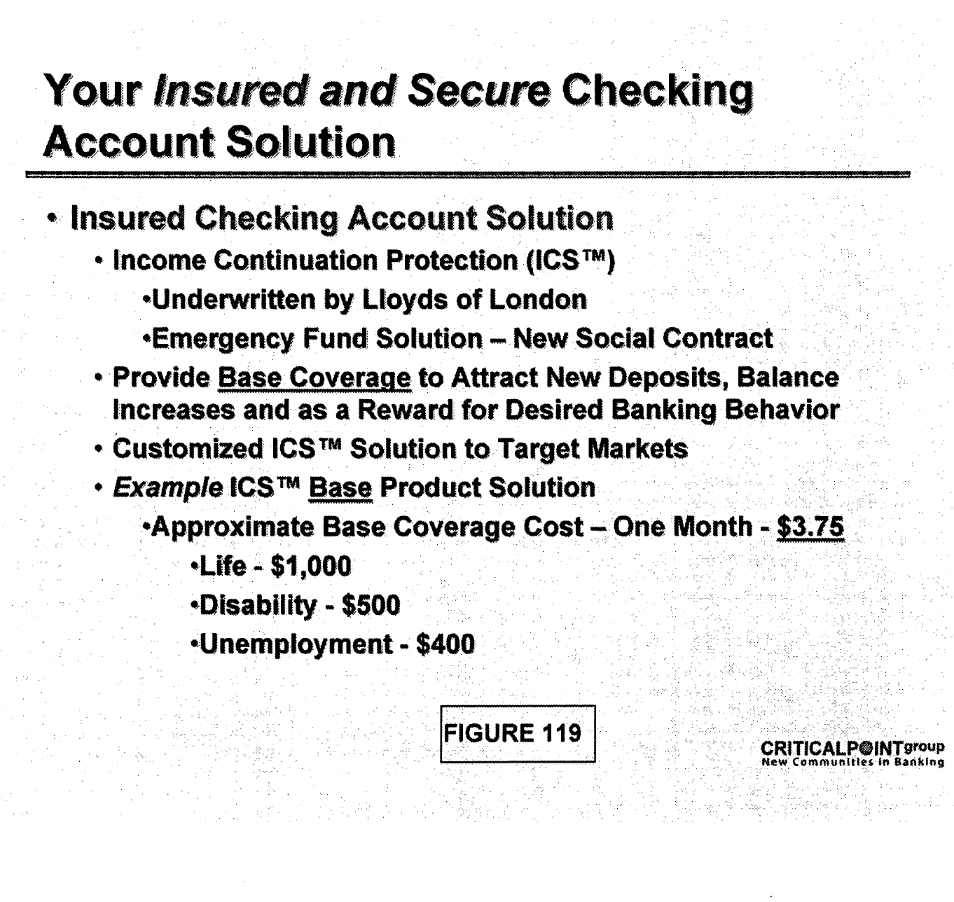

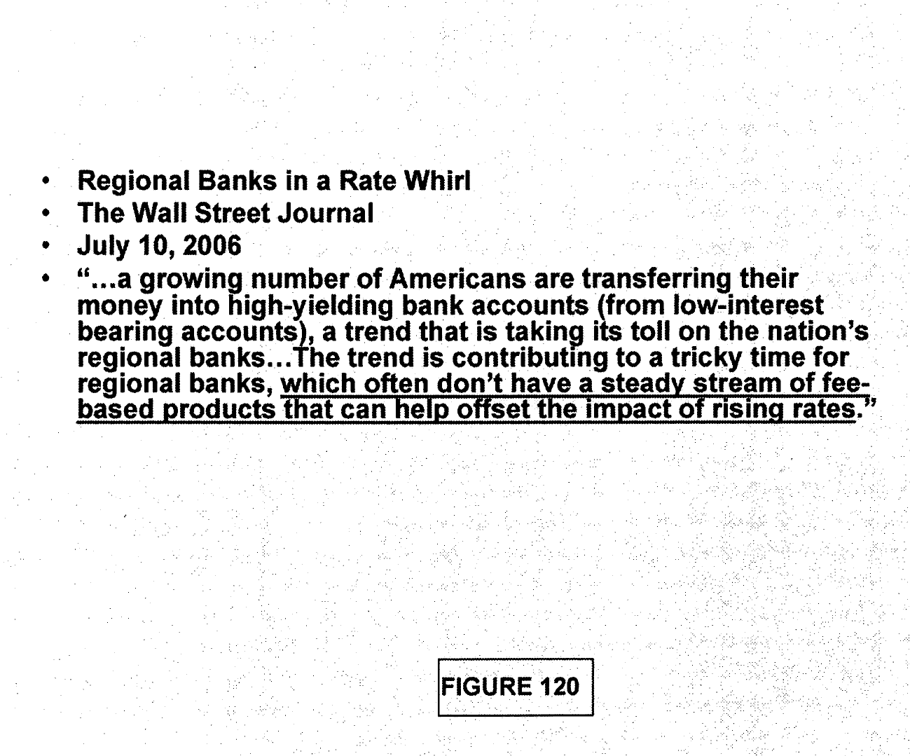

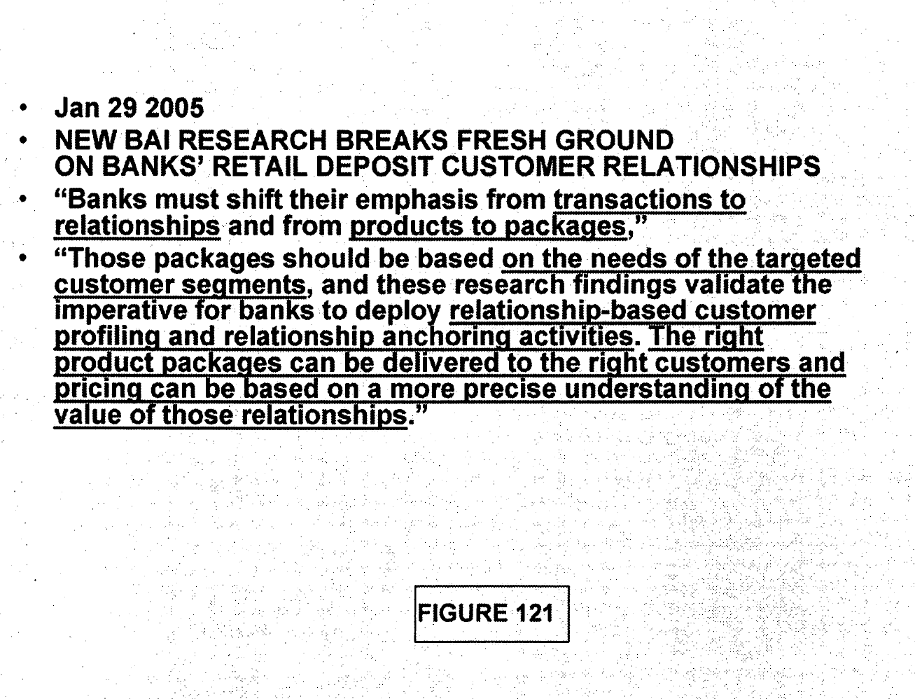

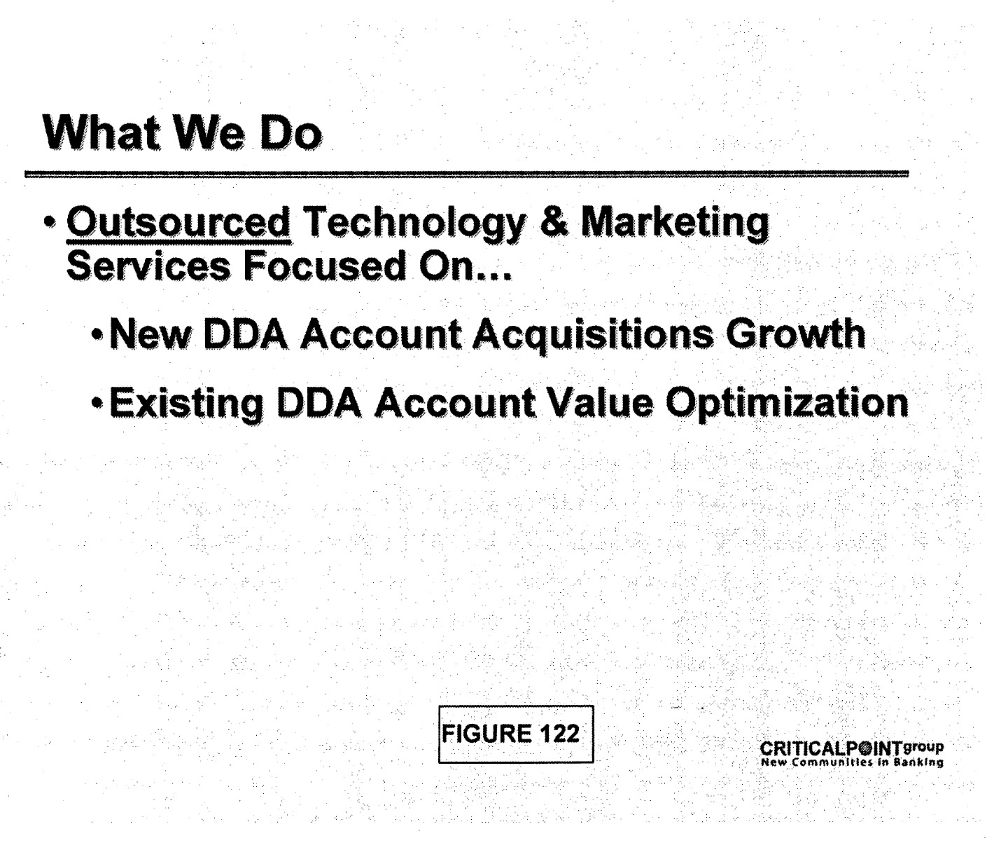

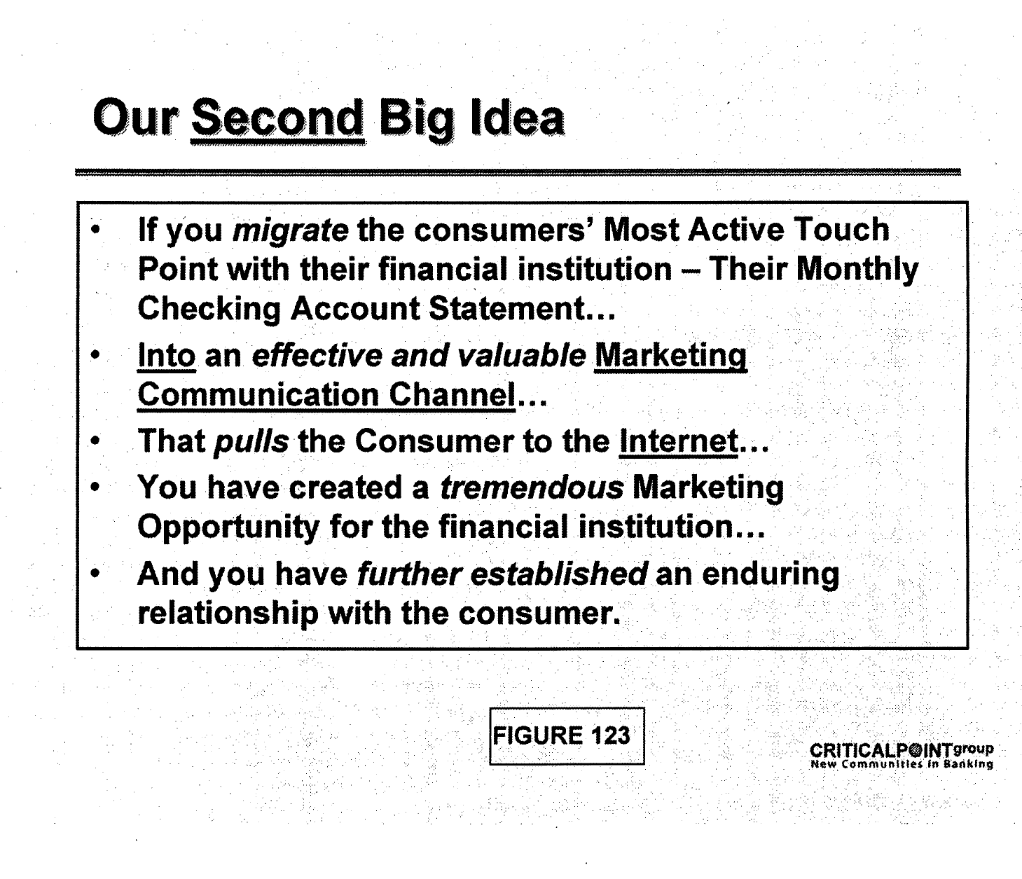

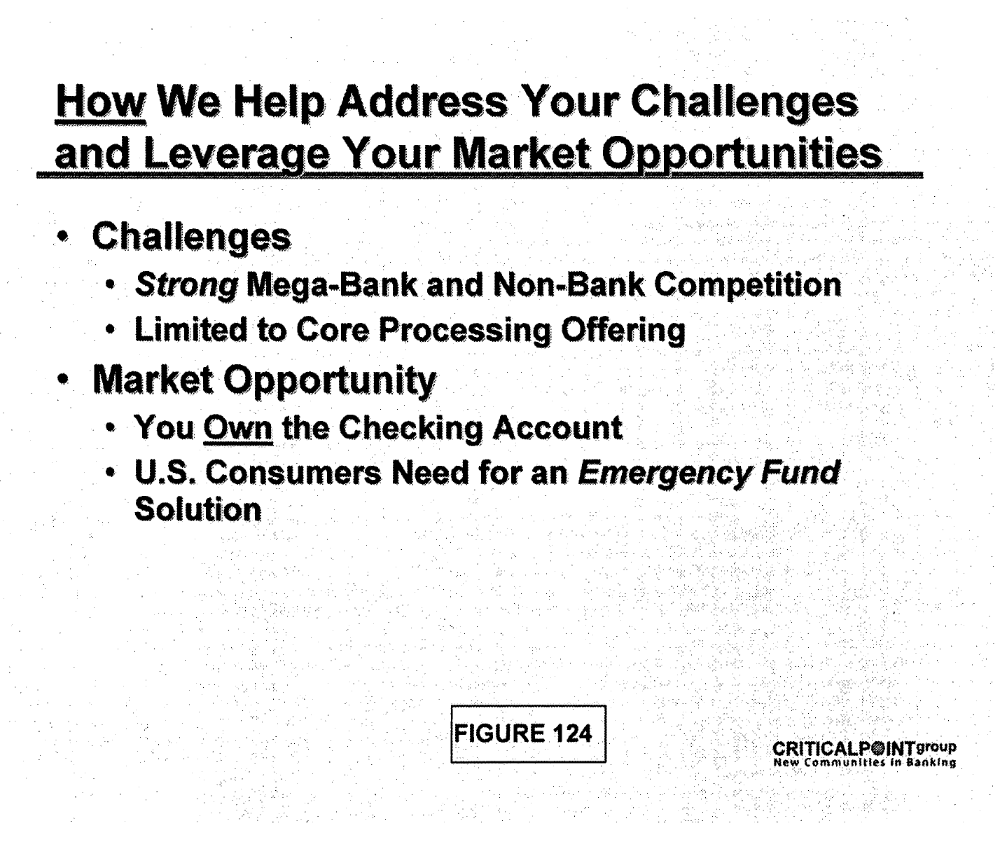

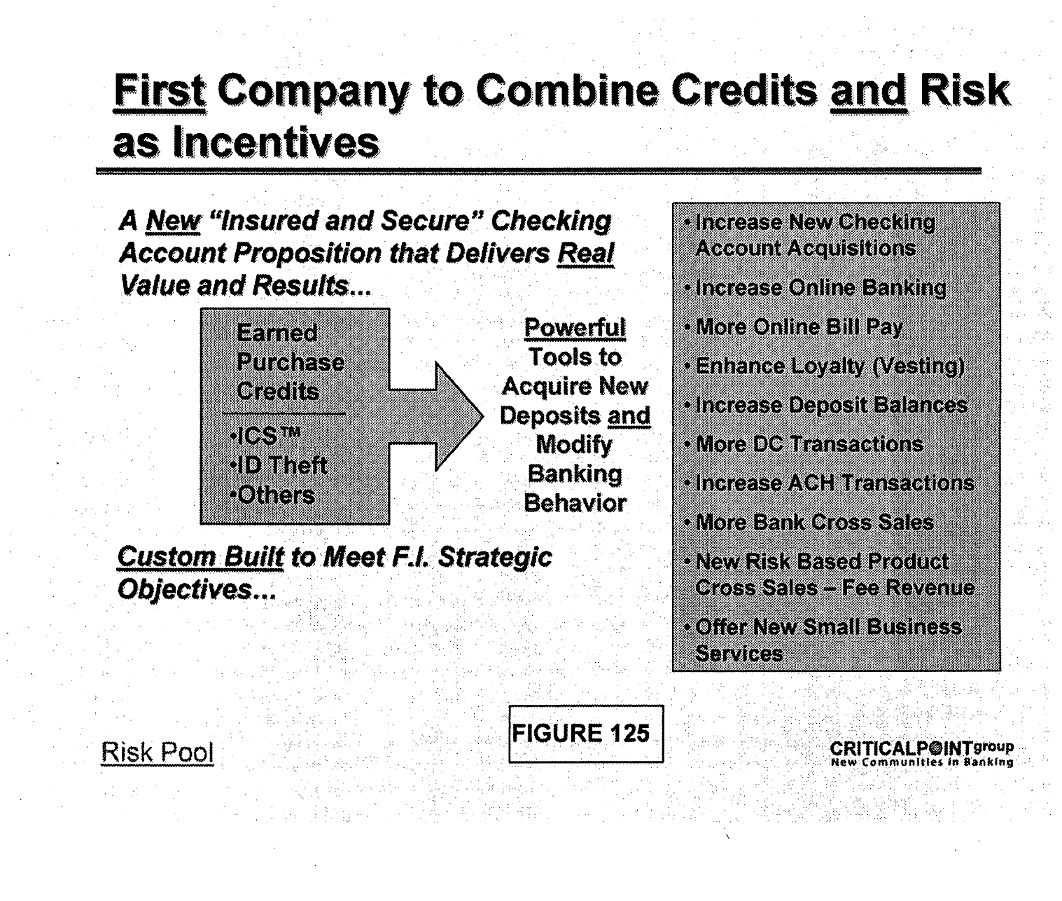

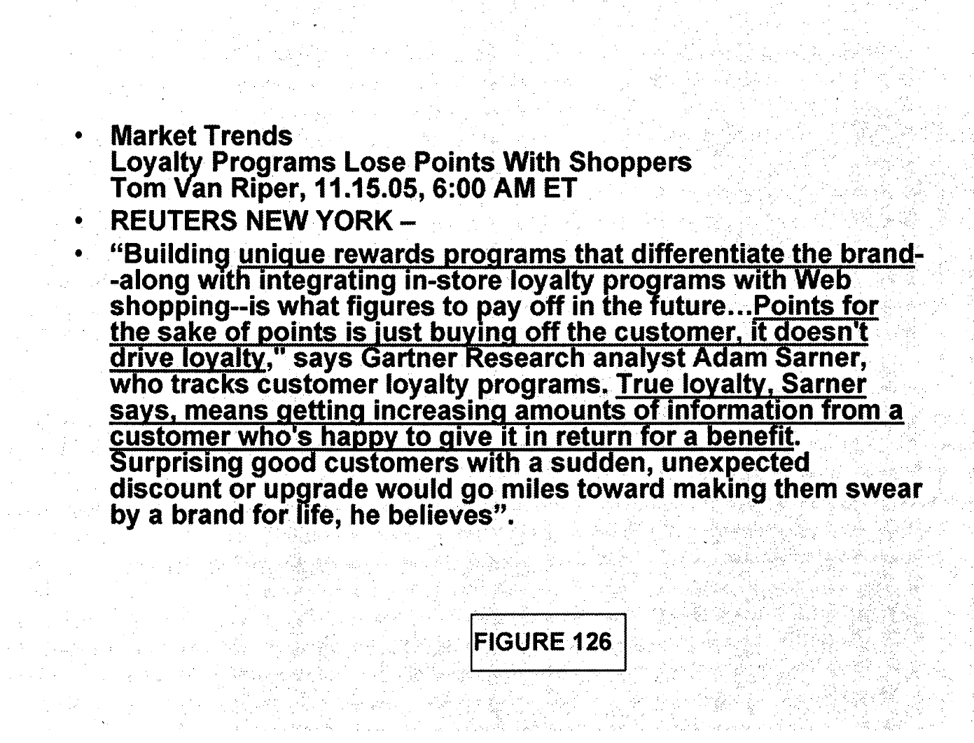

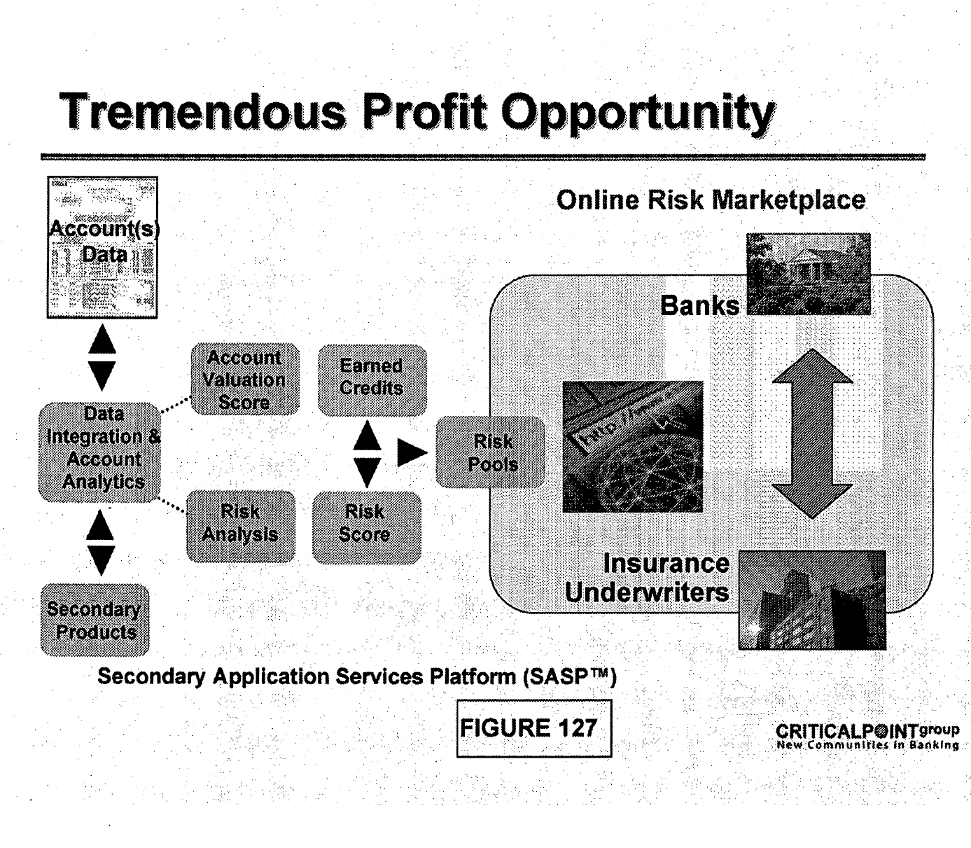

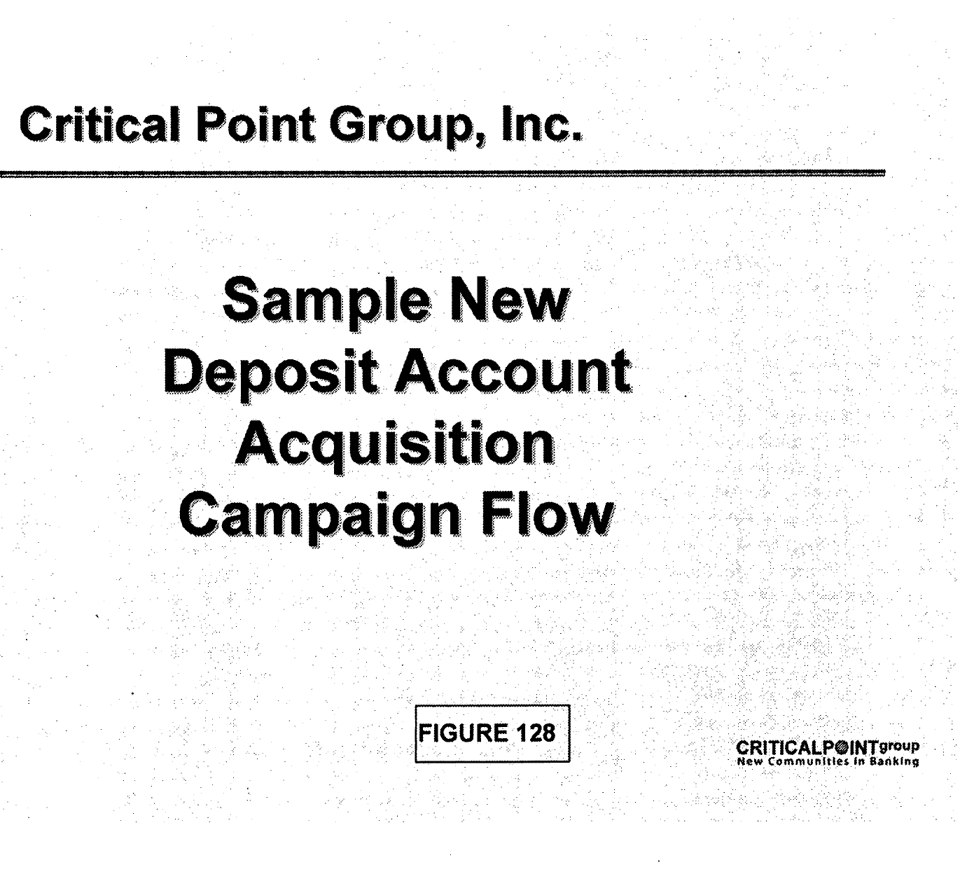

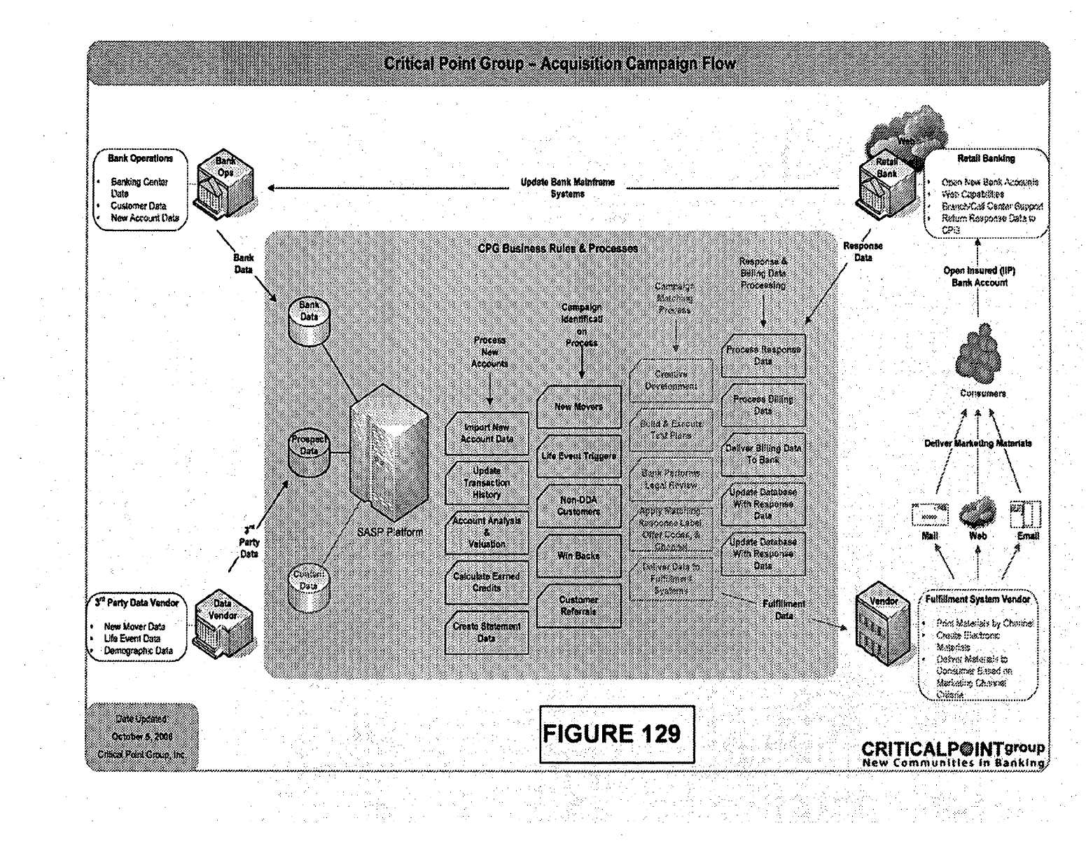

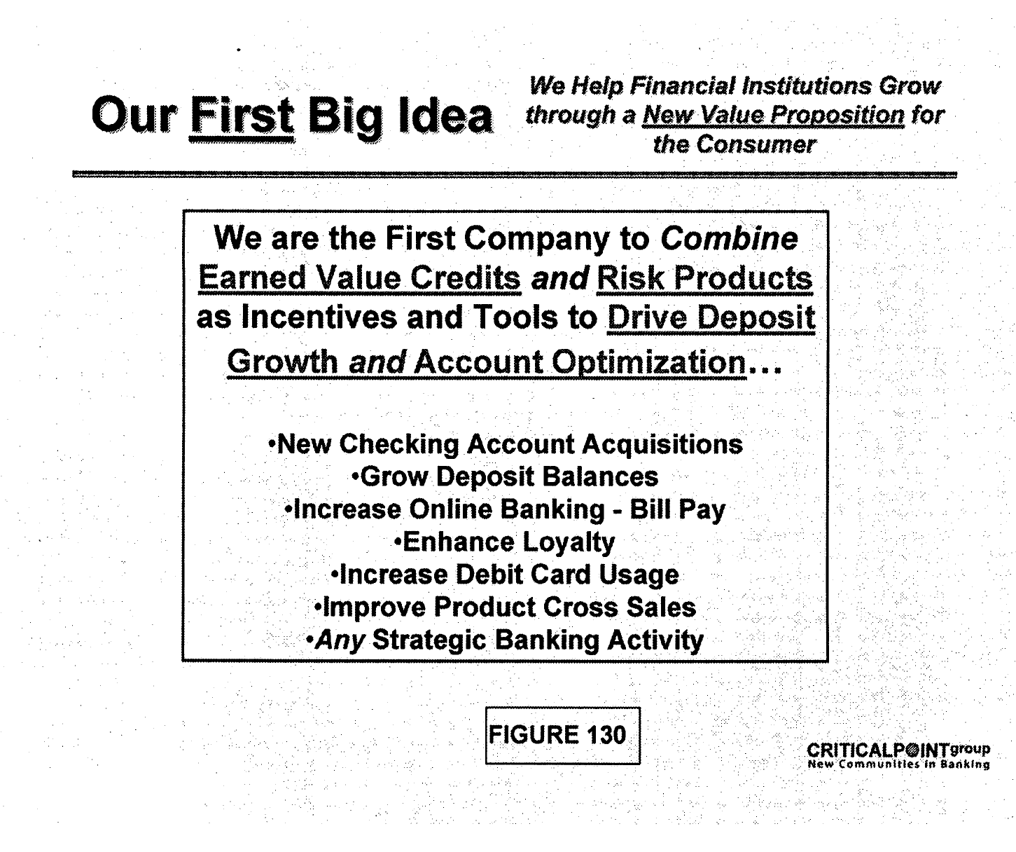

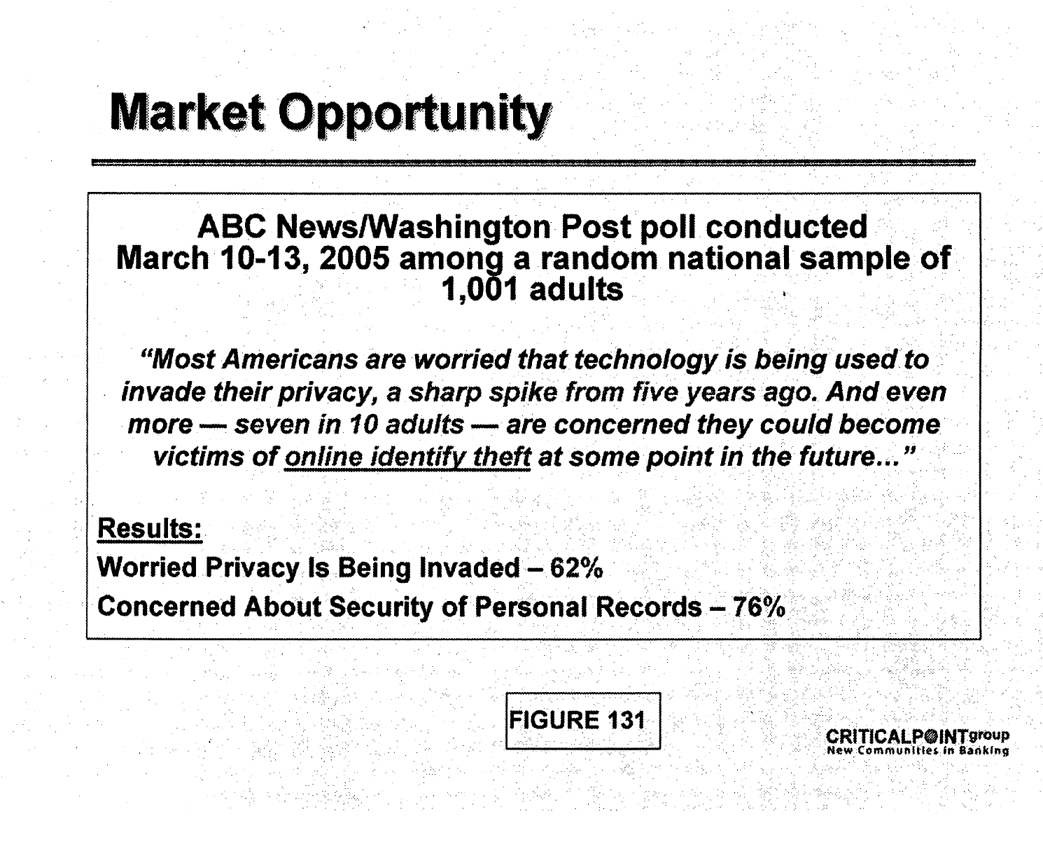

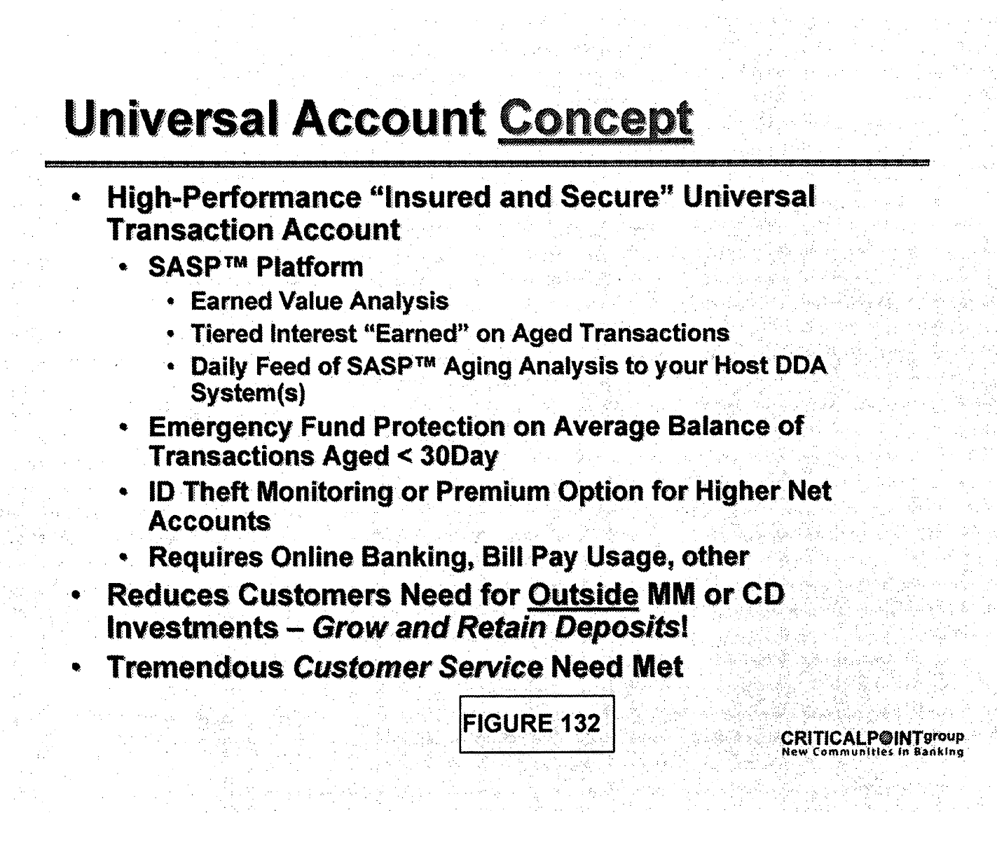

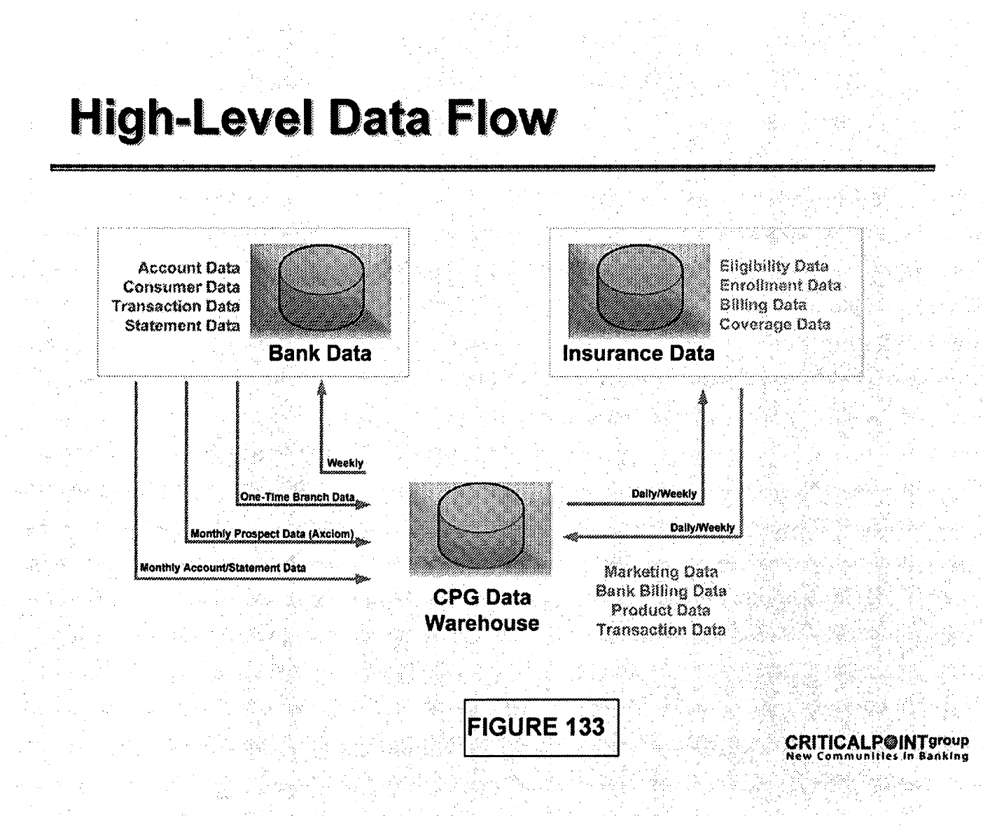

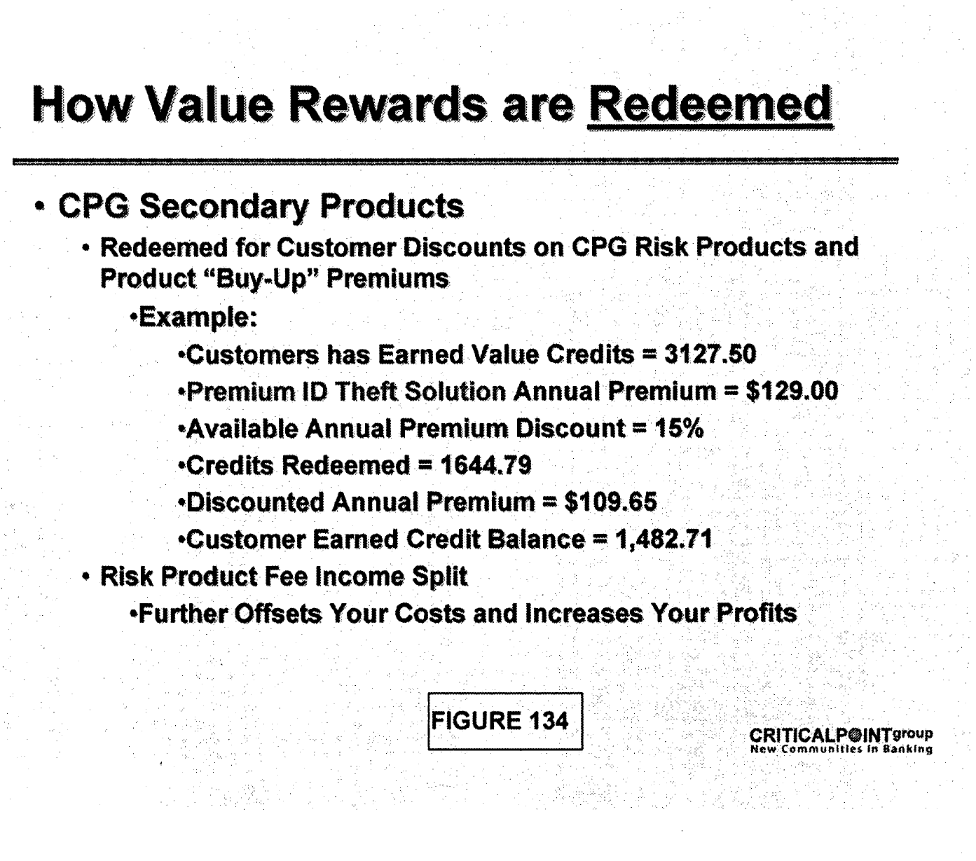

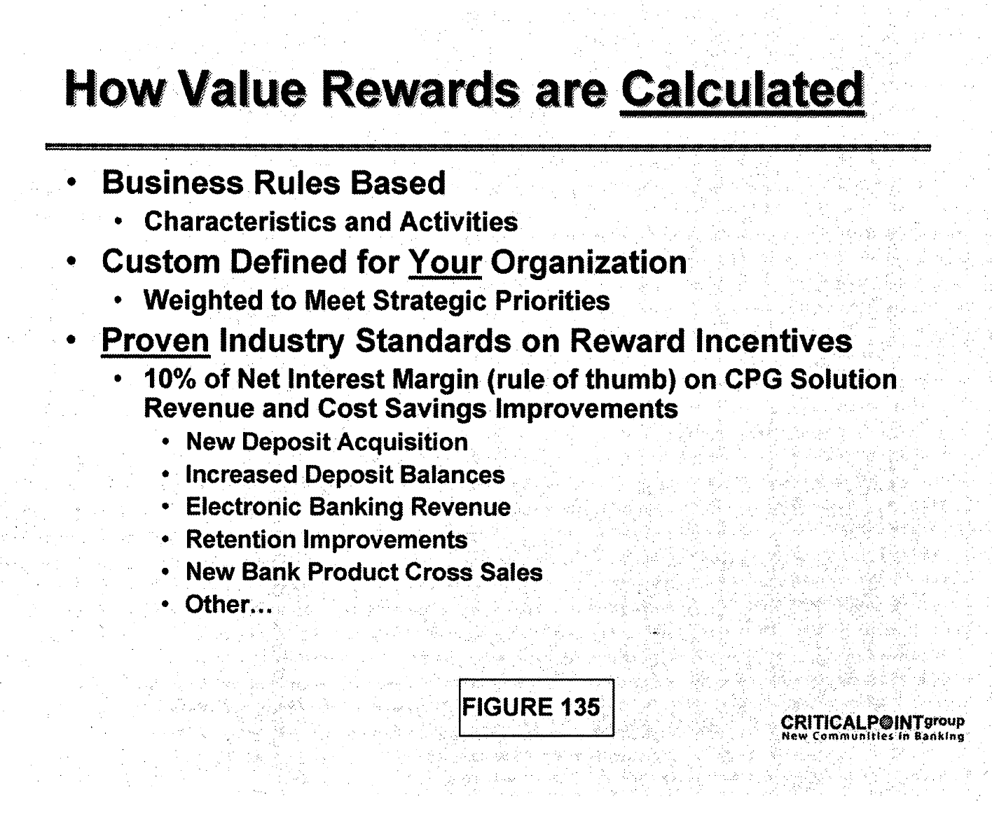

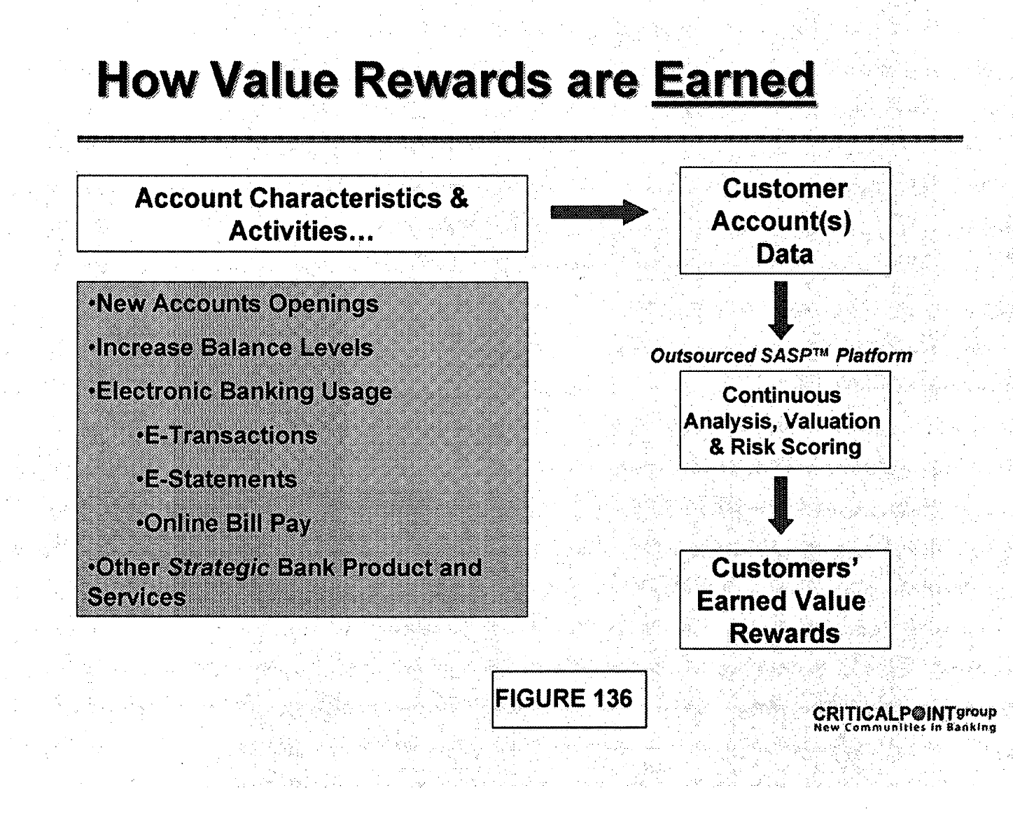

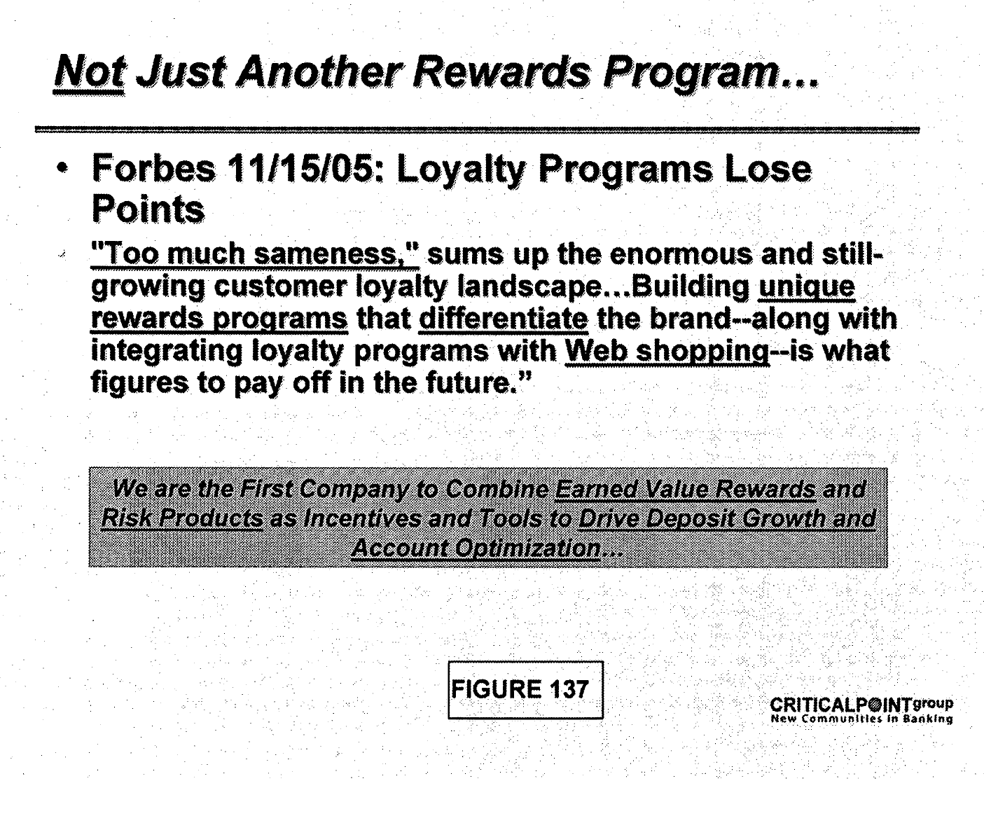

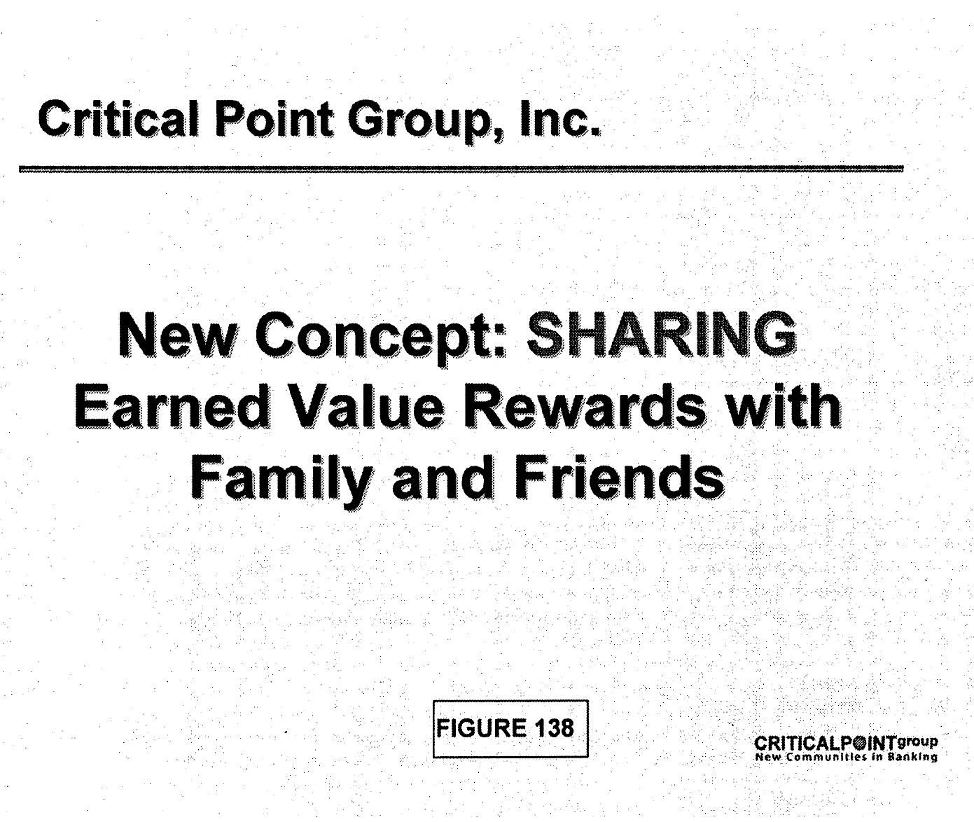

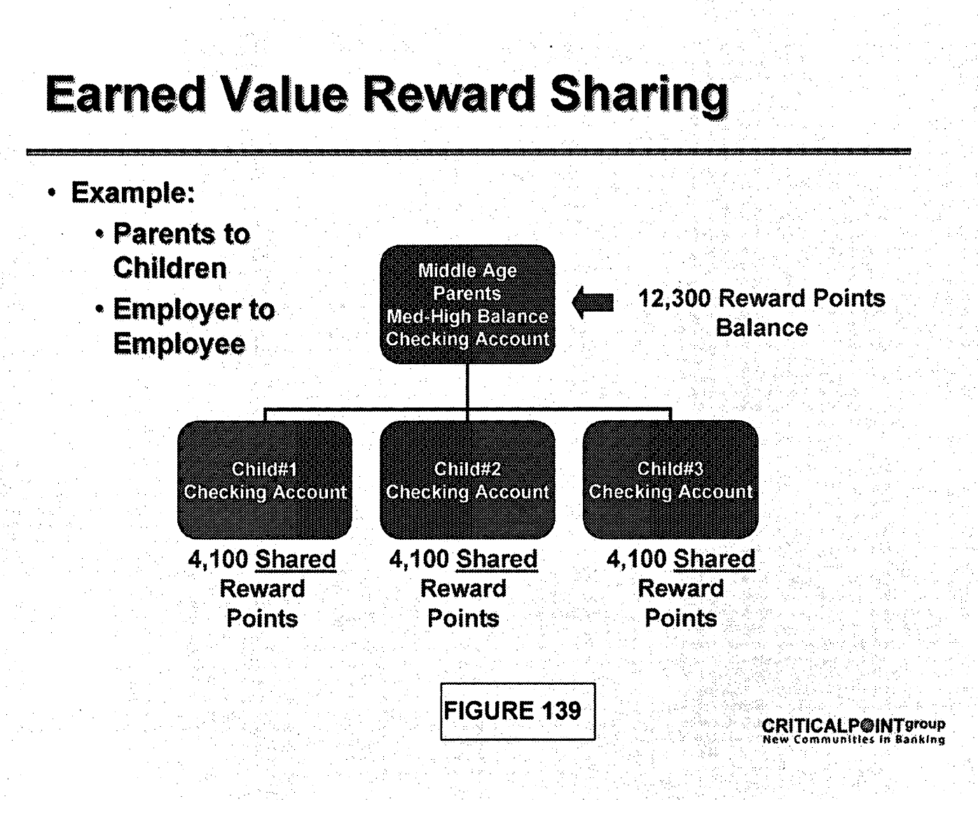

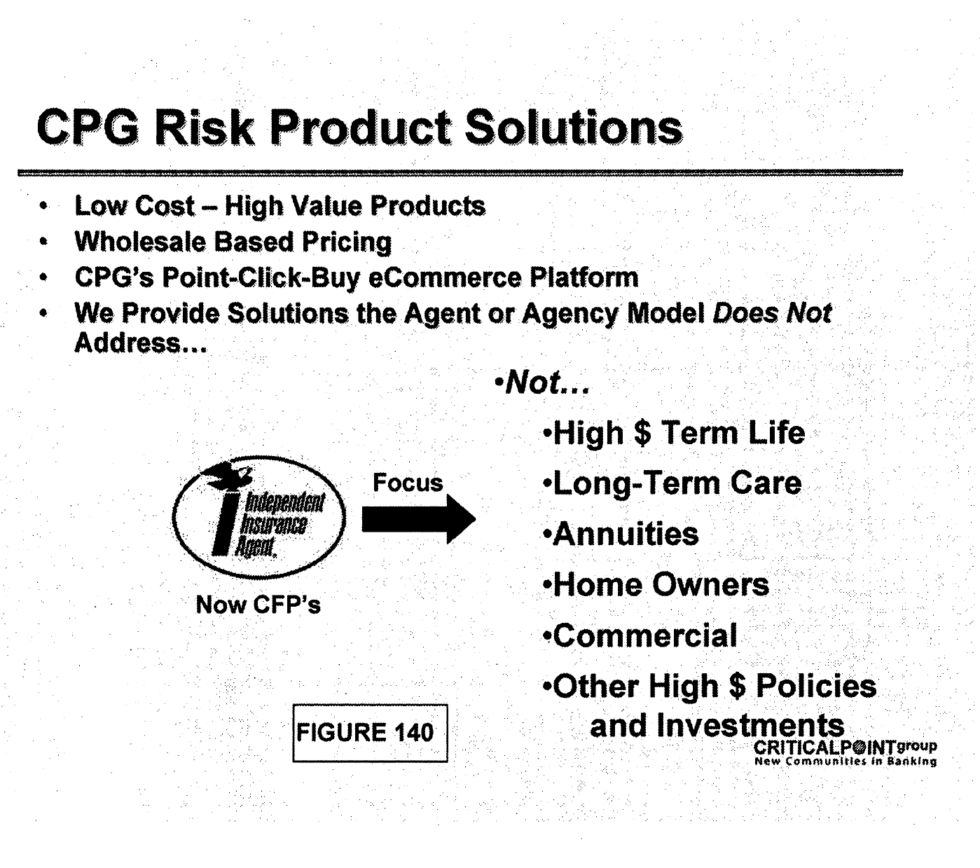

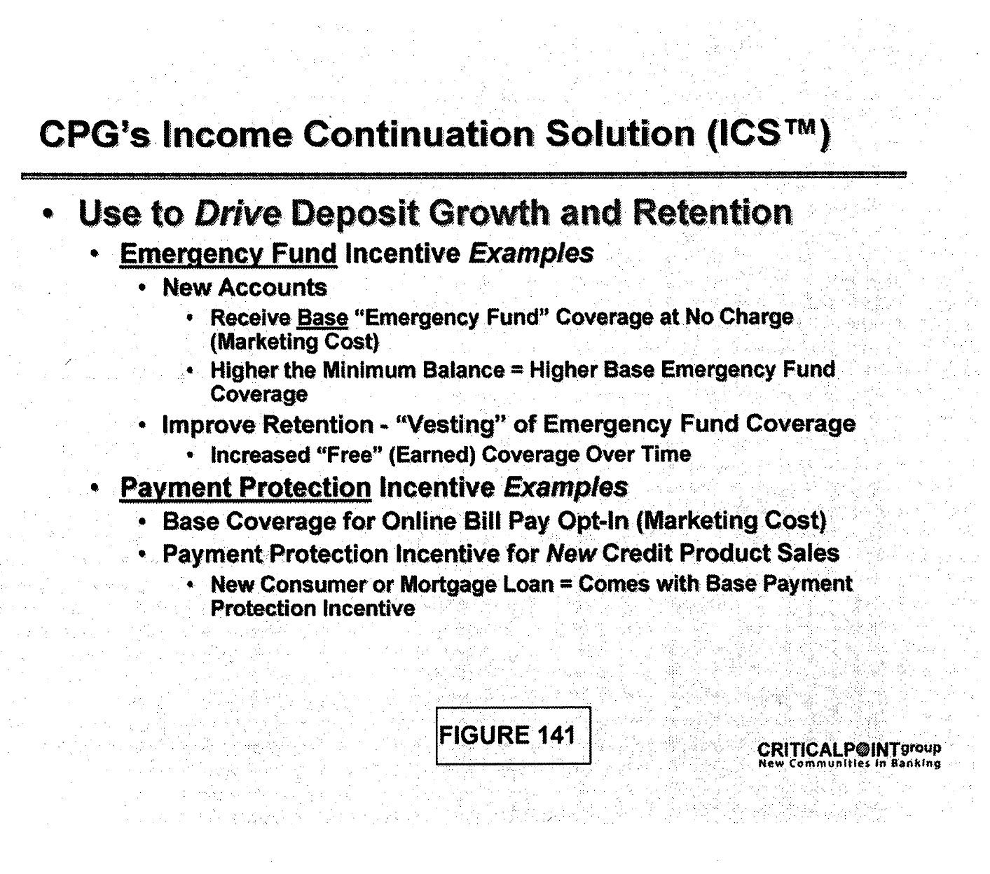

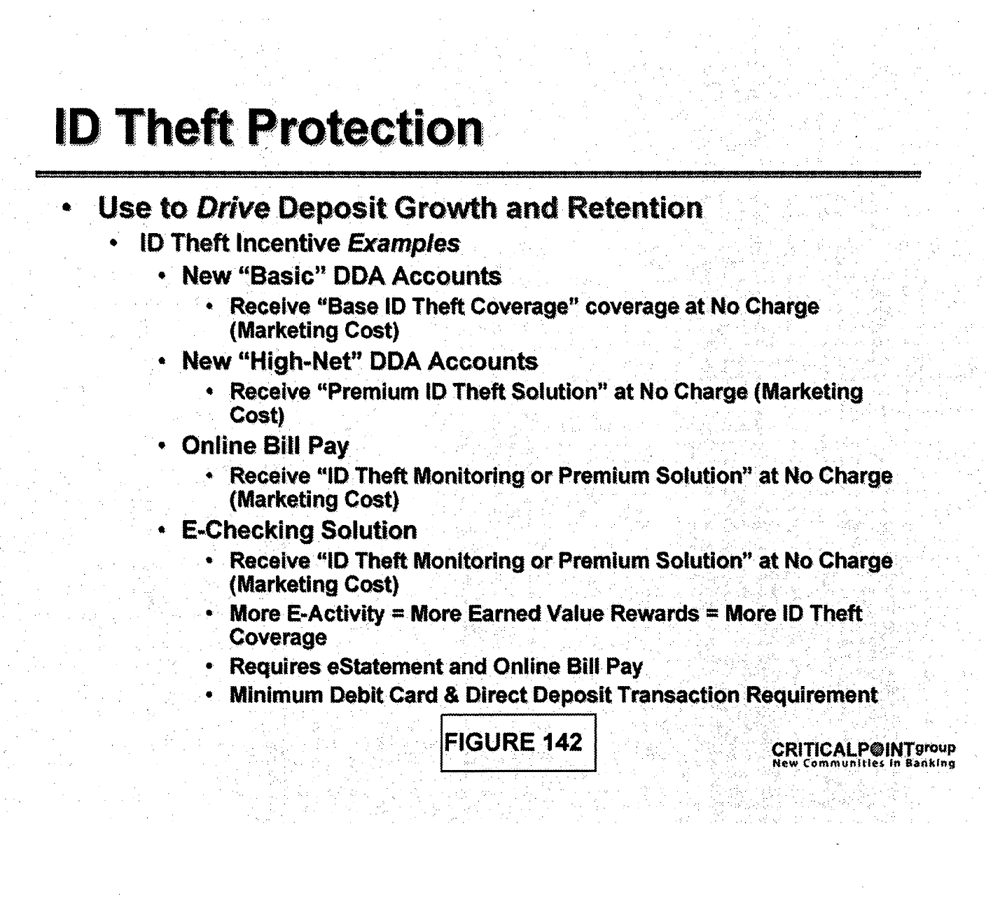

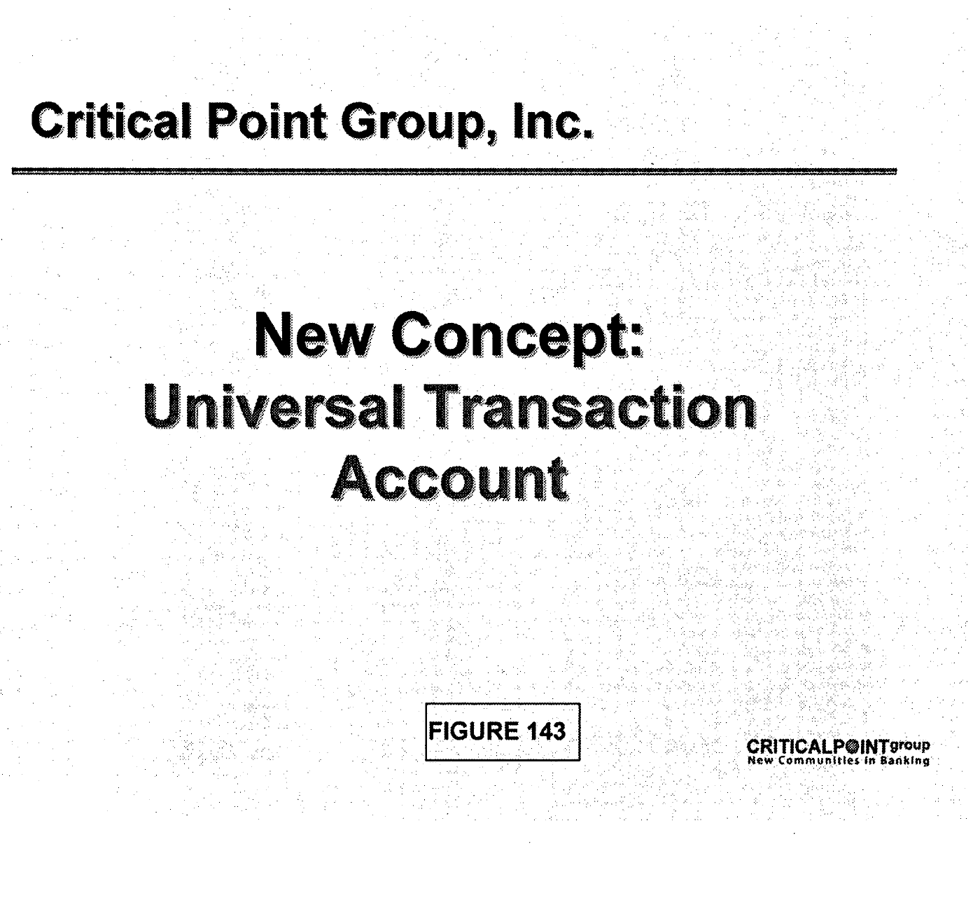

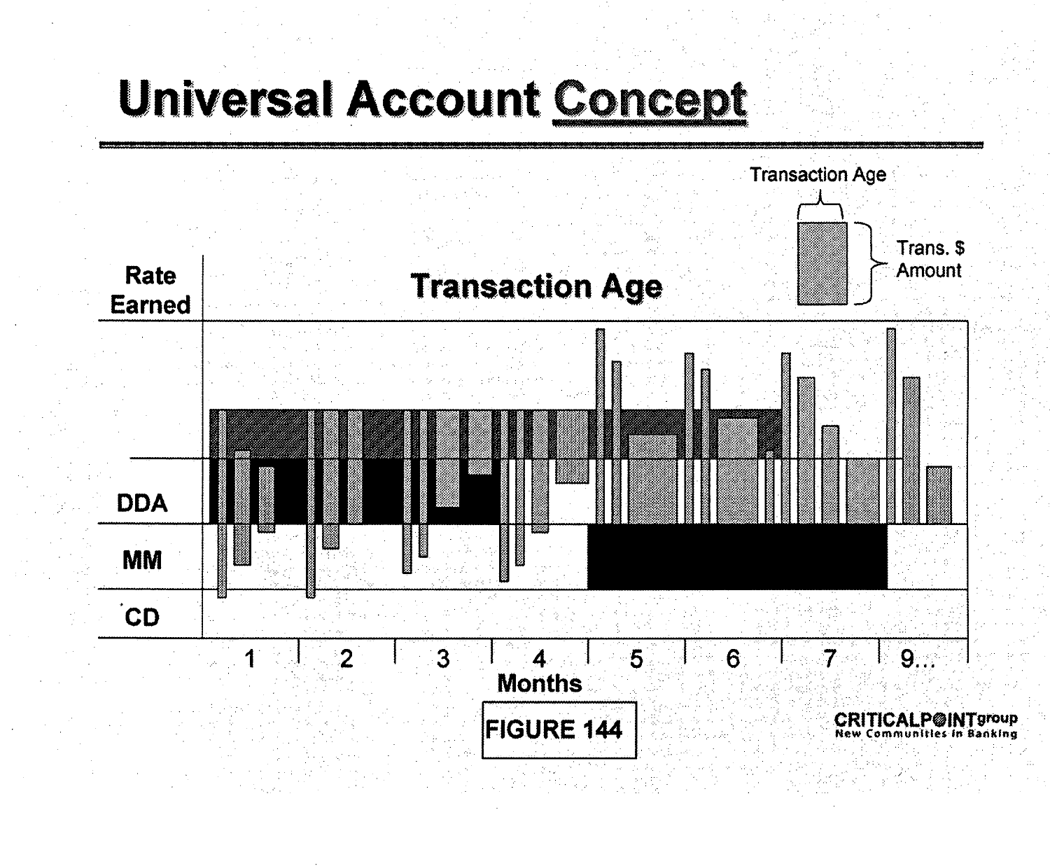

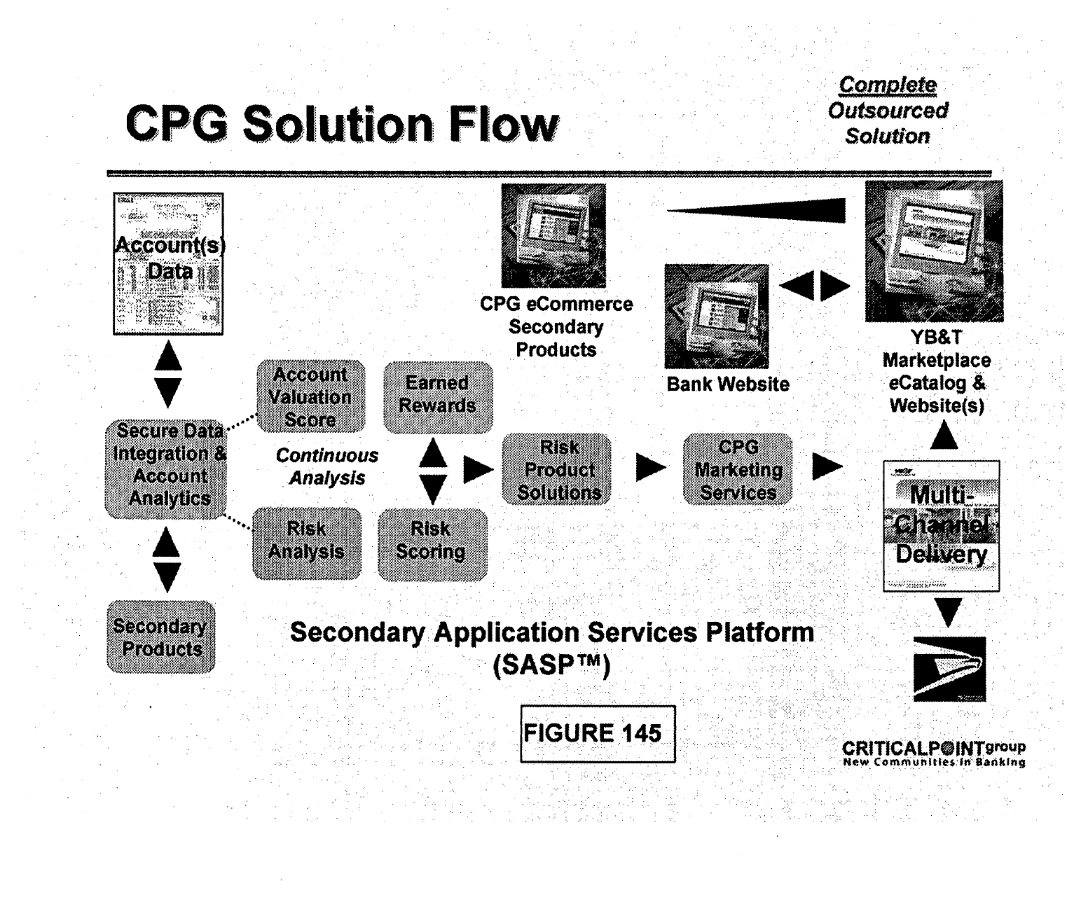

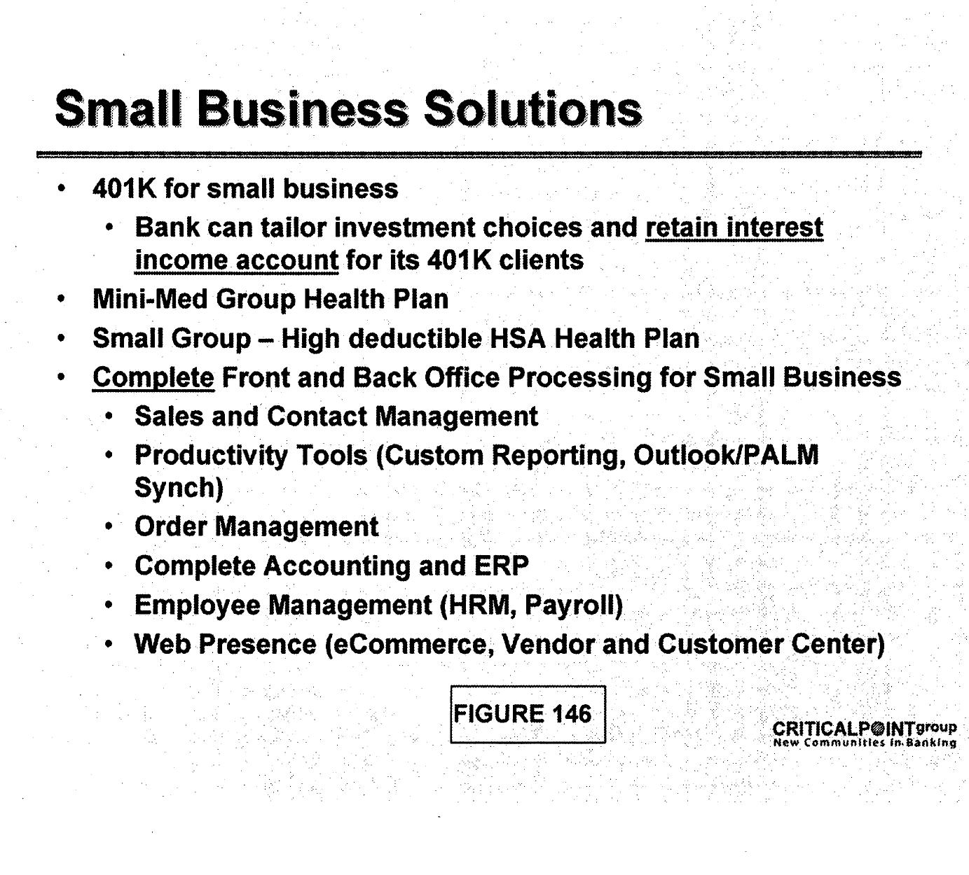

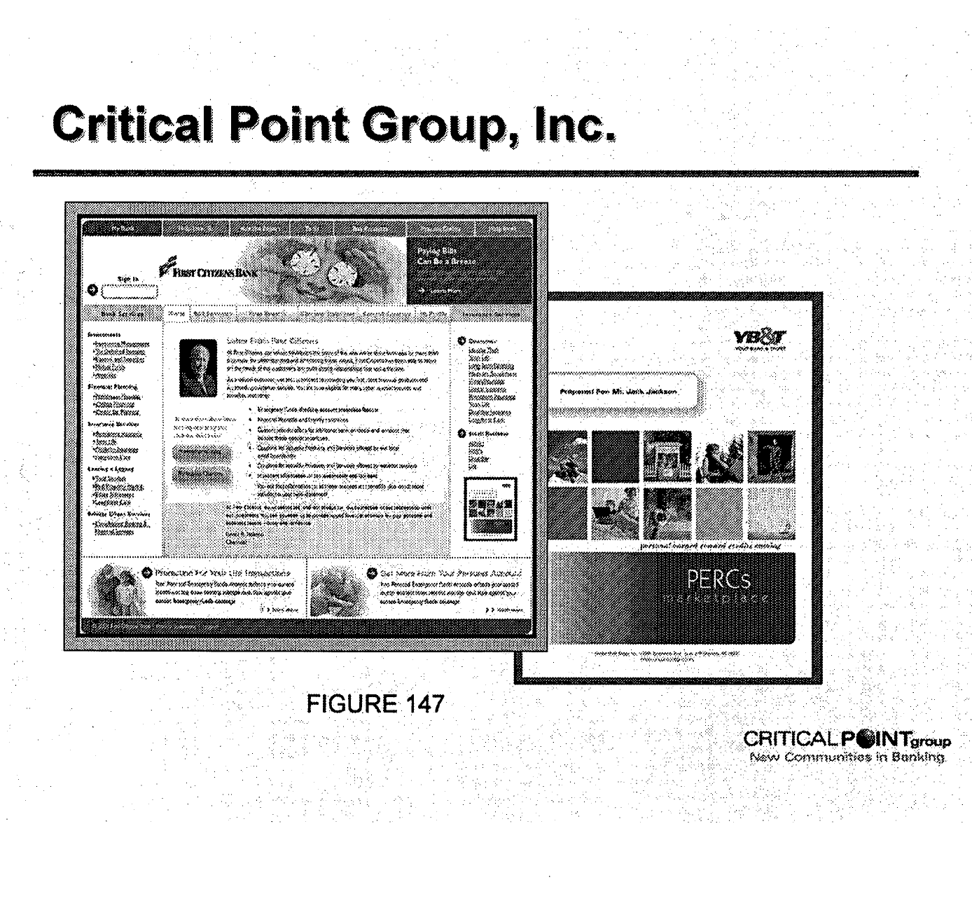

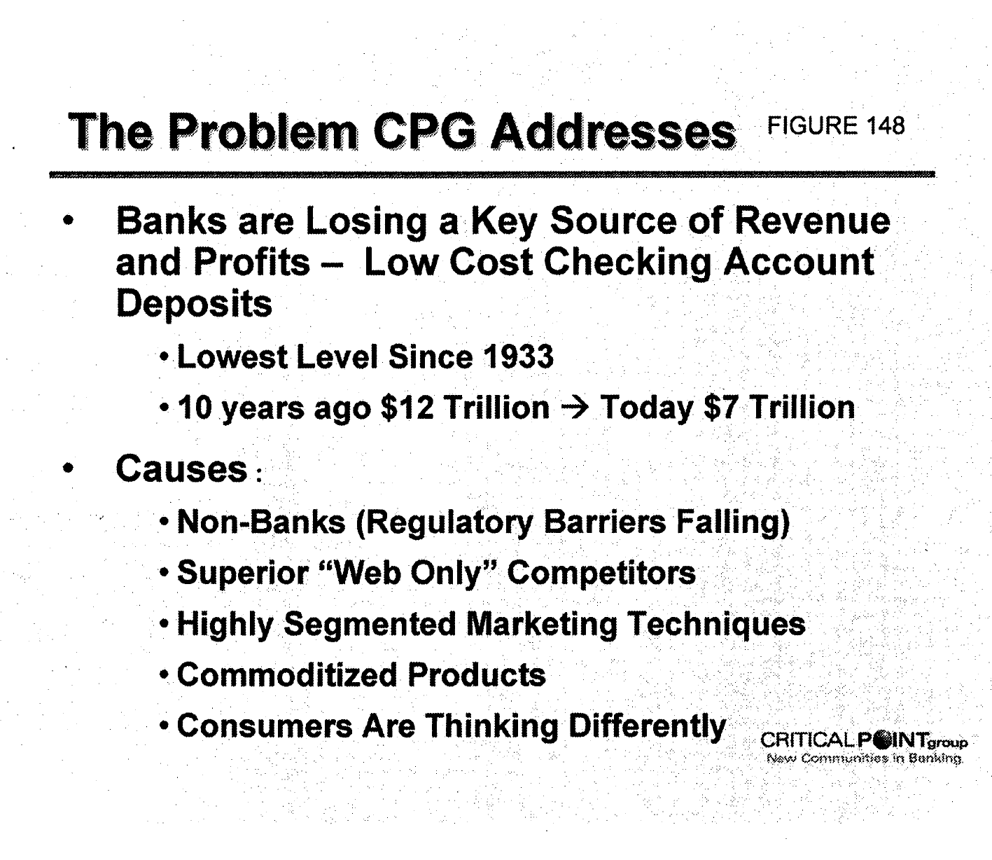

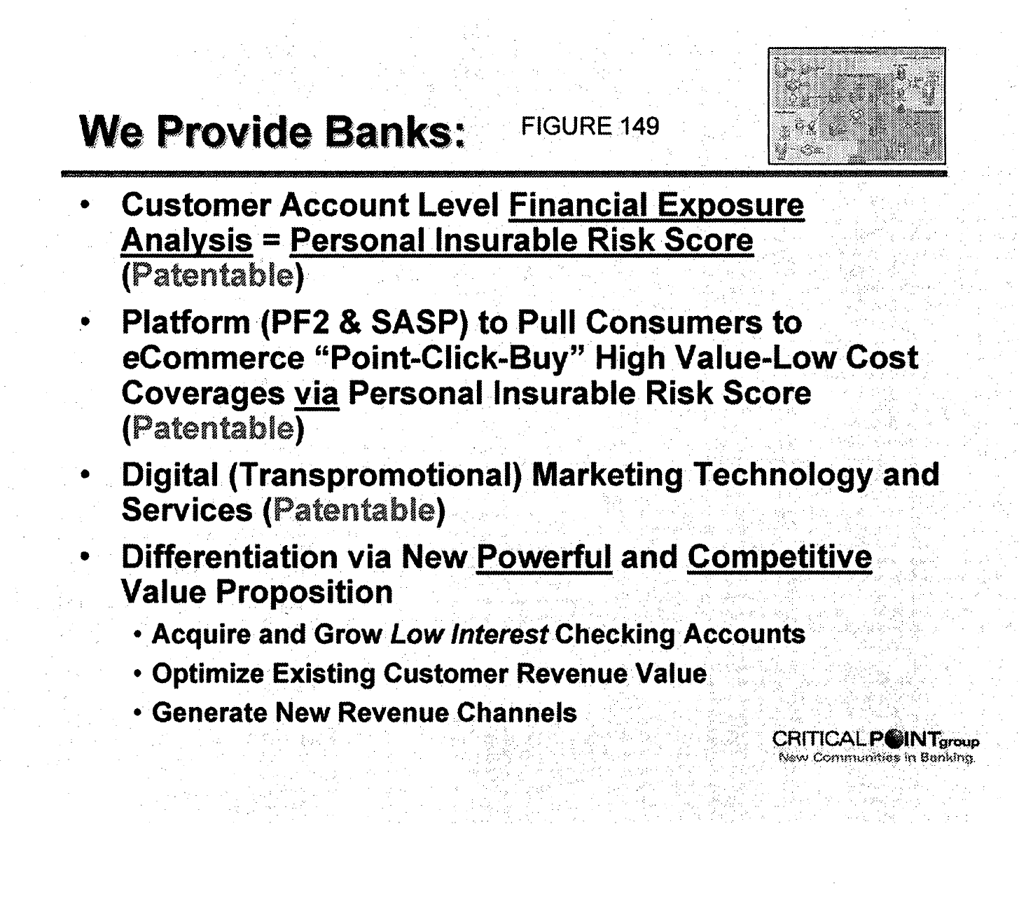

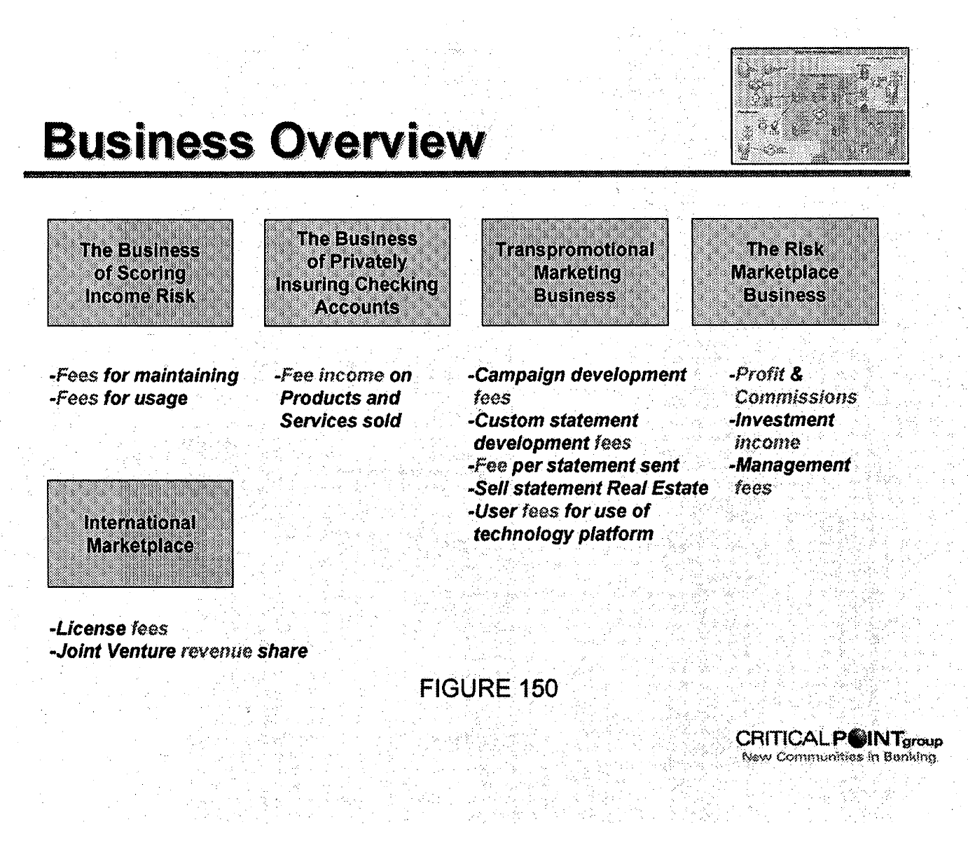

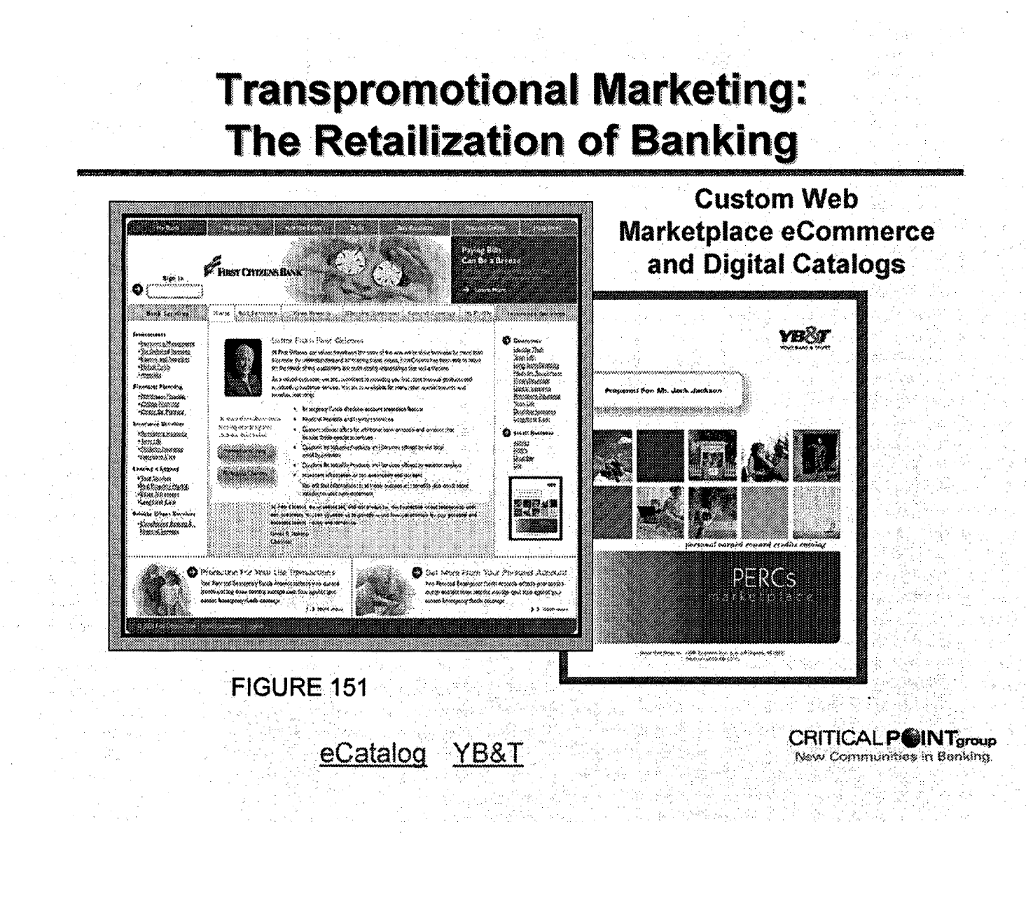

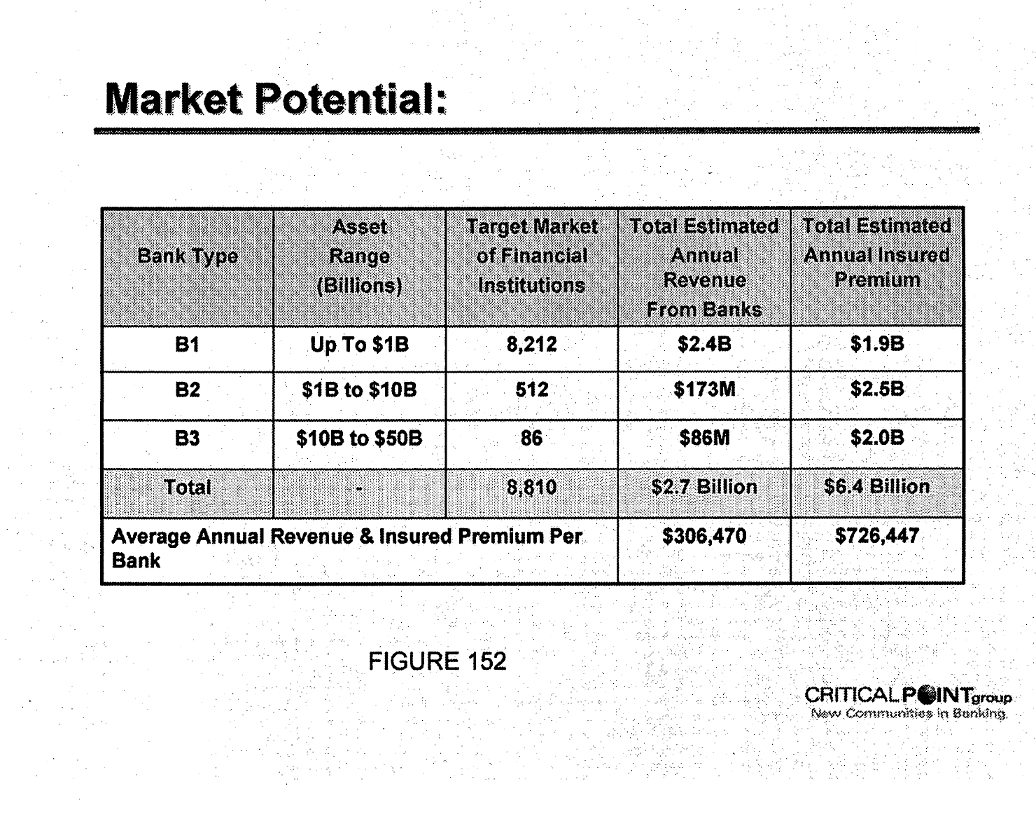

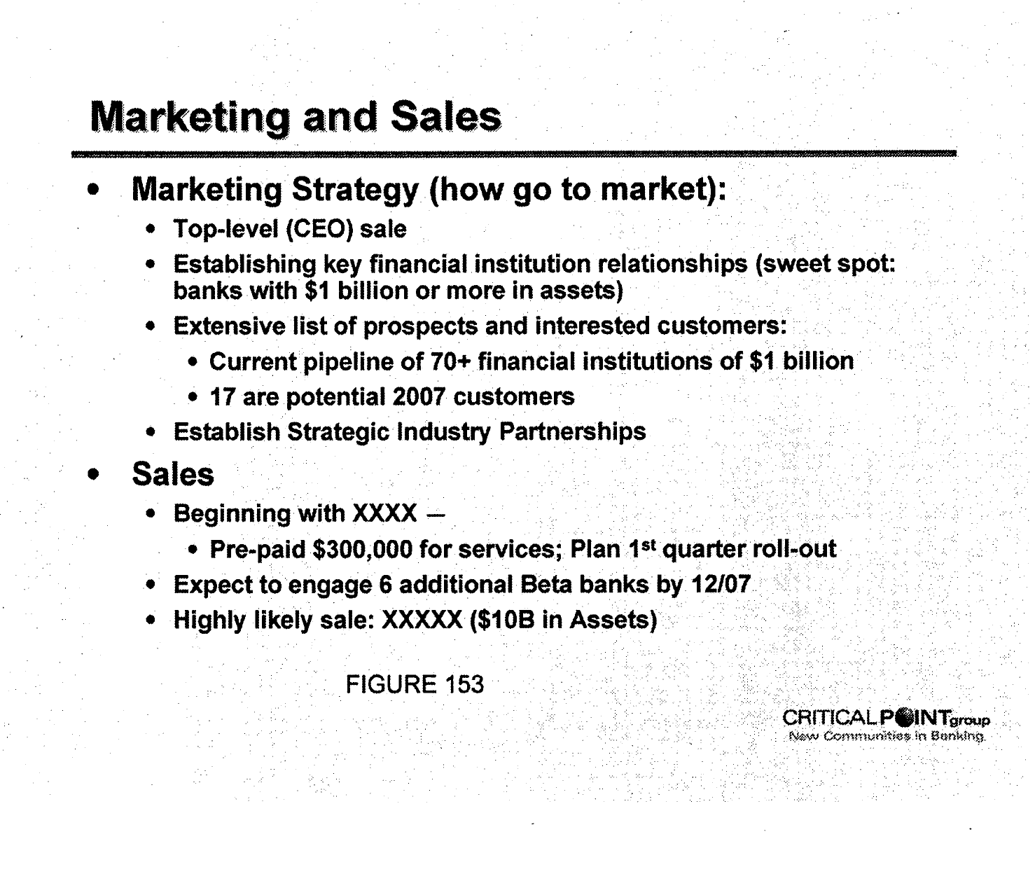

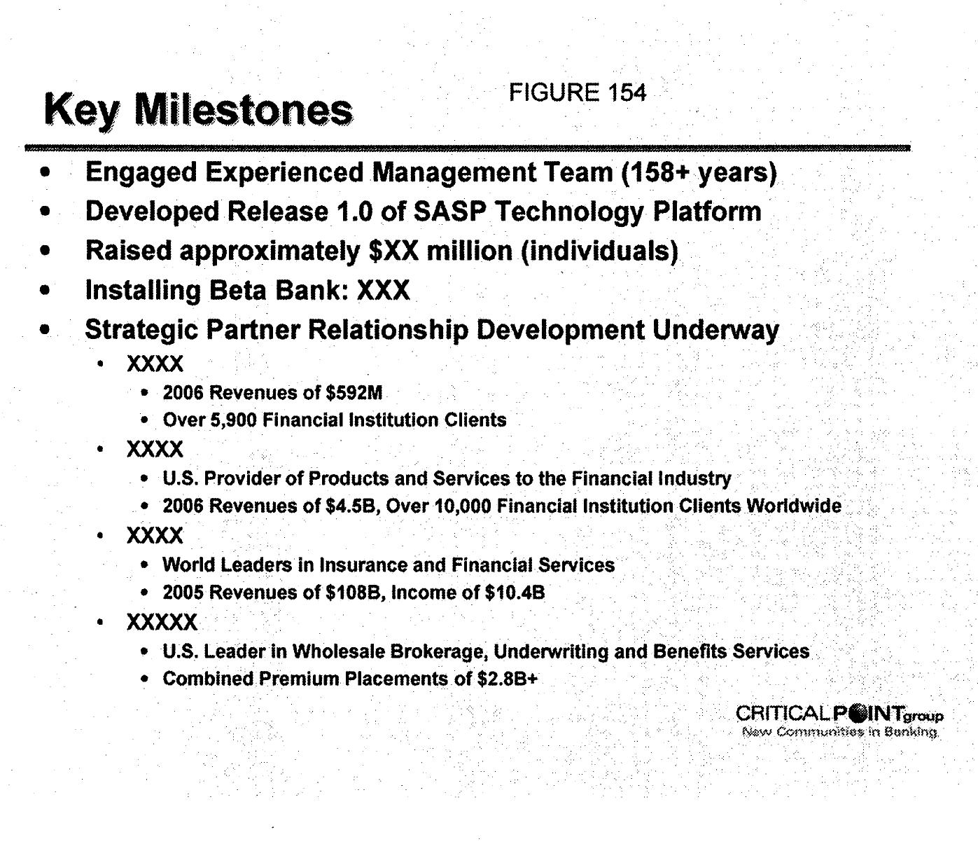

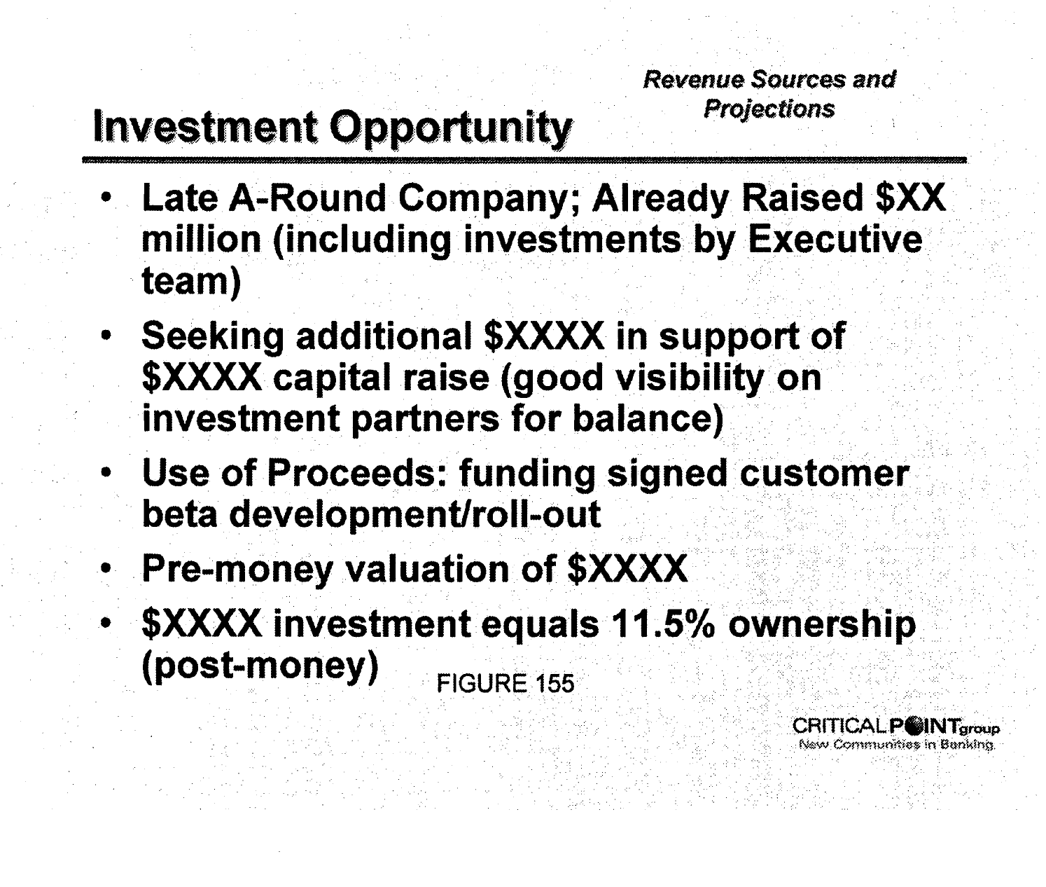

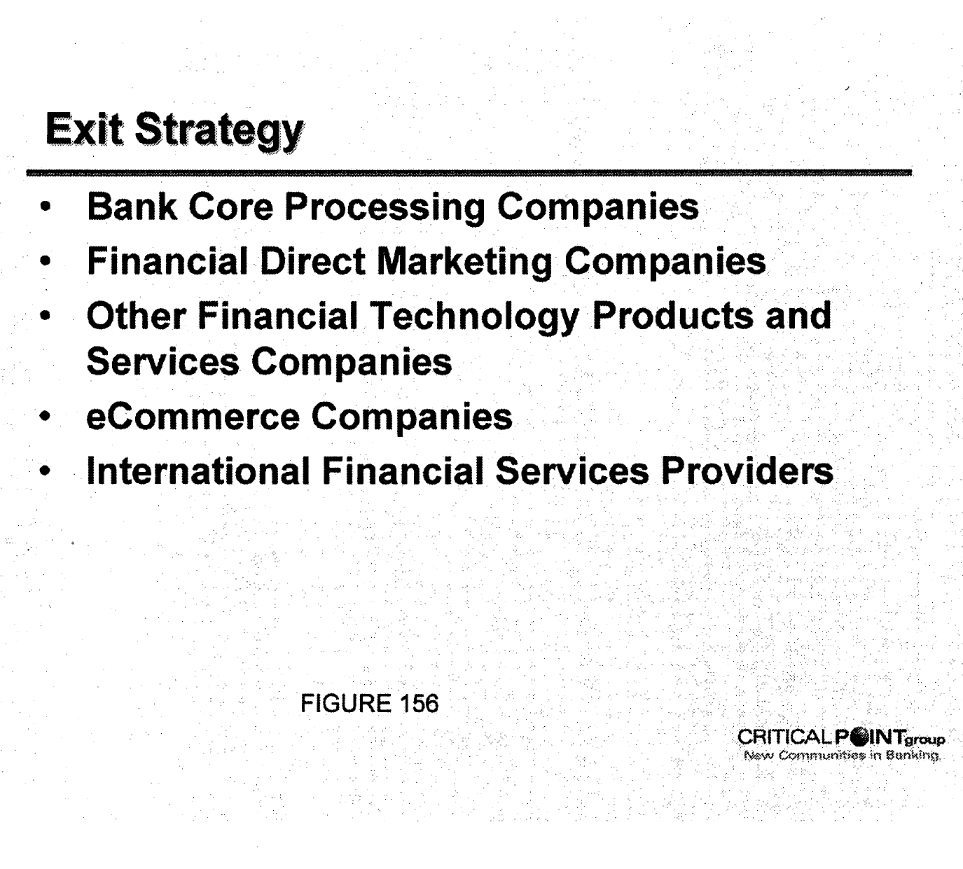

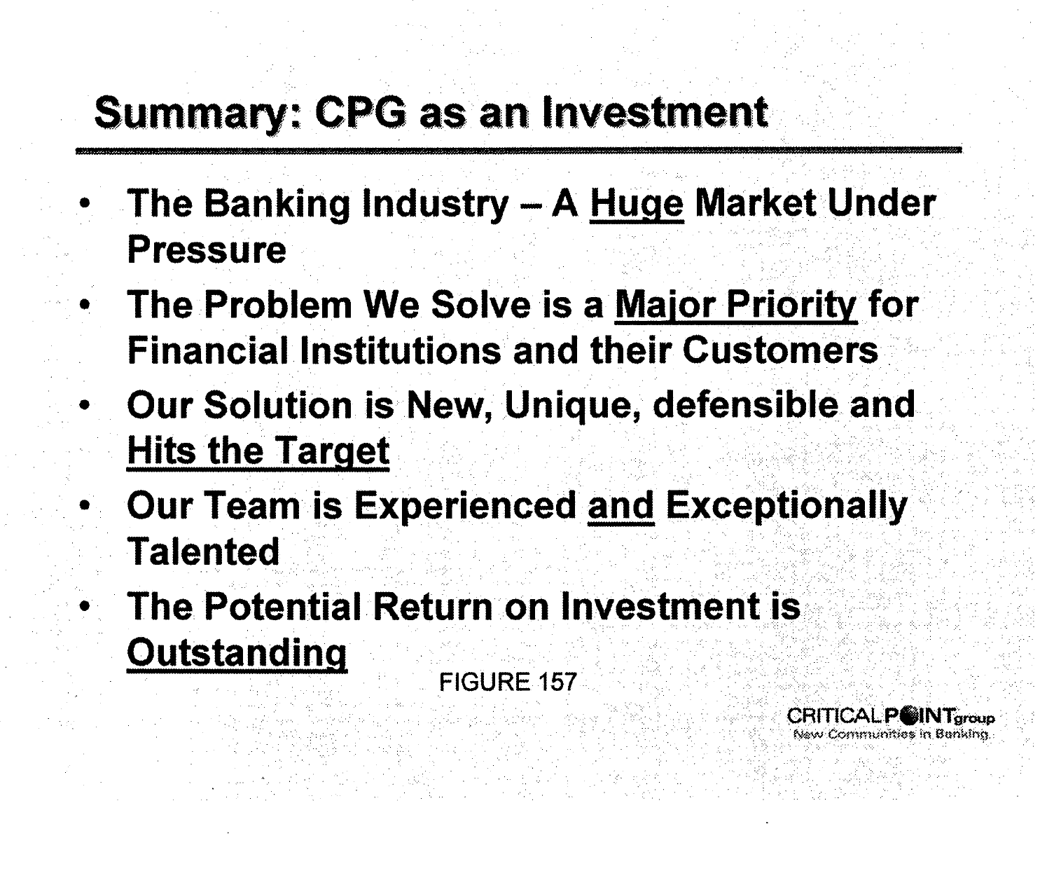

In yet another embodiment of the invention, a printed and mailed version of the Marketplace Catalog can serve in many different ways as an effective tool to migrate more customers to an online banking platform. An exemplary printed version of a Marketplace Catalog is attached as FIGS. 14-21. The printed version of this Catalog or statement may direct customers to visit online websites or banking systems in order to access detailed information on products and services. The statement may also include an Earned Purchase Credit Analysis that highlights the applicable earnings available for online banking usage. In addition, the statement may include an Income Interruption Projection Summary that reviews the consumer's “cash flow exposure” and the associated benefits he or she will receive by acquiring income interruption protection coverage for electronic transactions. Notably, as will be apparent to one of skill in the art, the features shown in FIGS. 14-21 concerning the printed Marketplace Catalog may also be applied to the electronic version of the Marketplace Catalog.

The Marketplace eCatalog and Catalog (printed and mailed version) may also serve as an improved sales tool by offering existing and prospective small business customers the opportunity to advertise and promote their products and services to institution customers. This not only produces additional fee income revenue for the institution, it also provides tremendous added value to existing small business customers and an incentive that may be offered to prospective small business customers.

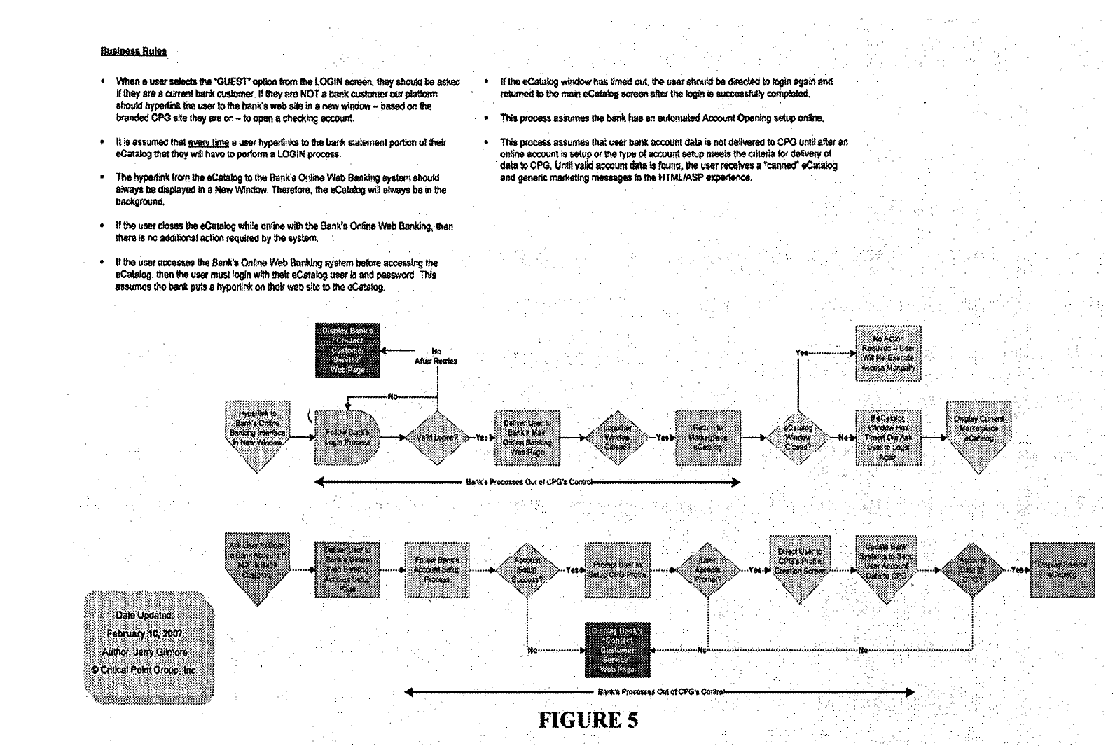

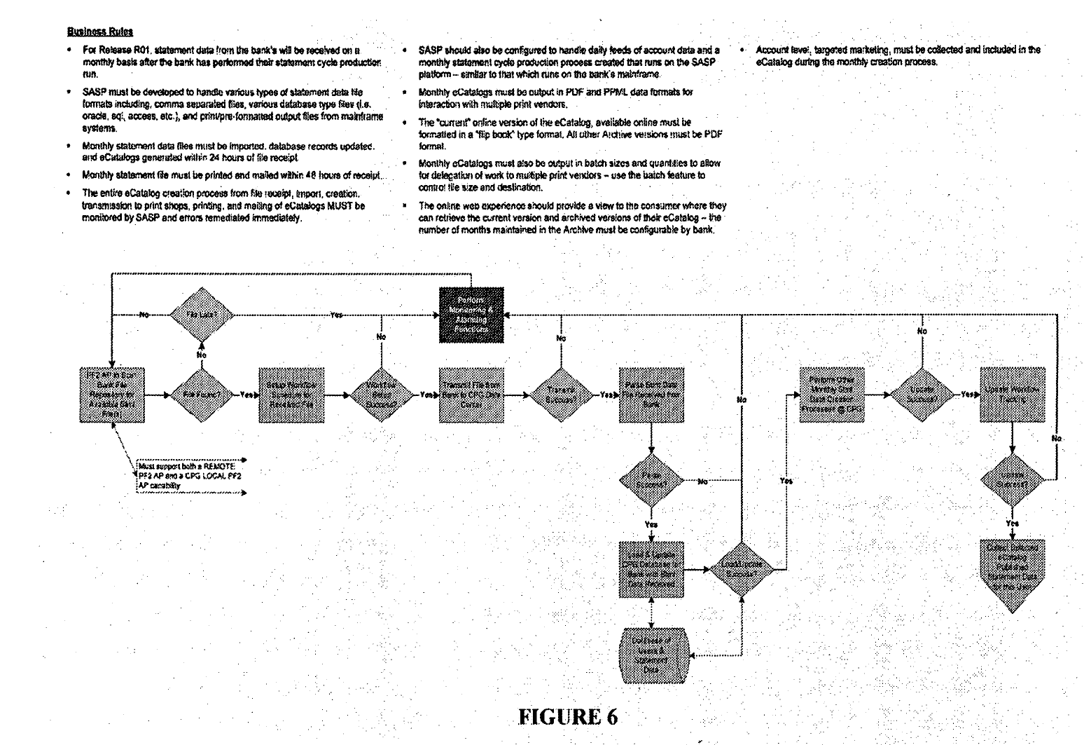

FIG. 5 is a schematic process flow diagram illustrating how an online user interface might be established for allowing a user to access an eCatalog in accordance with one embodiment of the invention. Notably, the depicted illustration outlines how an interface might be established for users who are existing bank customers as well as those who are not. FIG. 6 is a schematic process flow diagram illustrating monthly eCatalog bank statements might be created in accordance with one embodiment of the invention. In the depicted embodiment, one or more bank databases are periodically scanned by a SASP™ system server or processor (“PF2”). FIG. 9 is a schematic flow diagram illustrating how earned credits may be calculated and displayed to a user via an online platform, such as the Marketplace eCatalog, in accordance with one embodiment of the present invention.

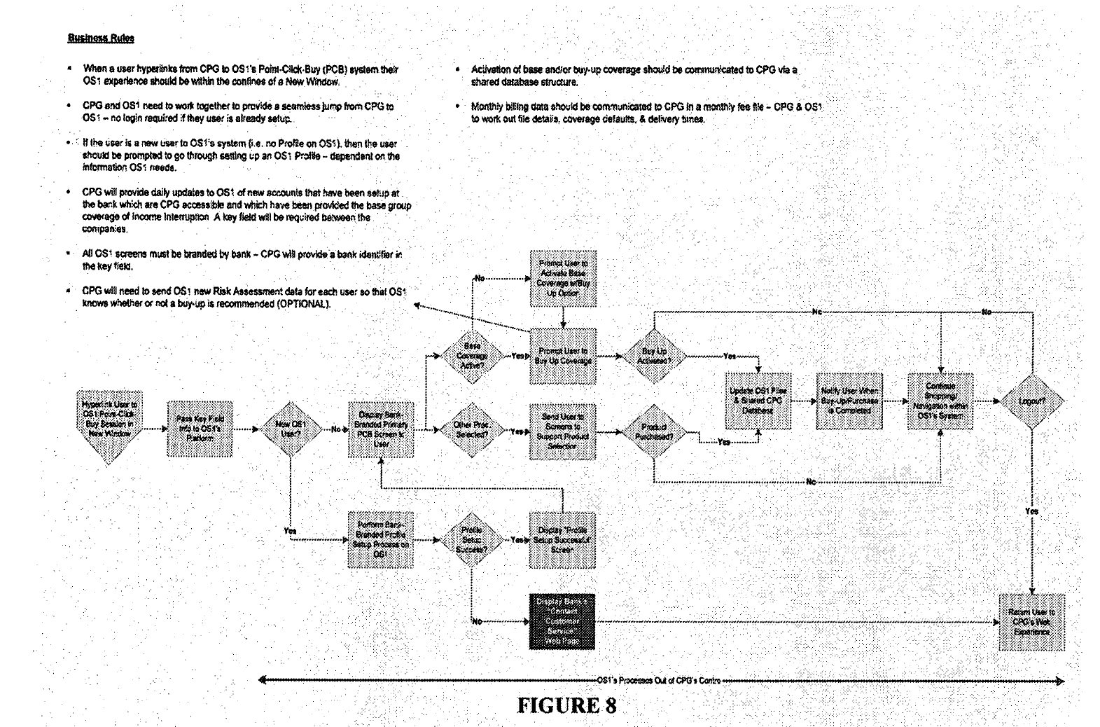

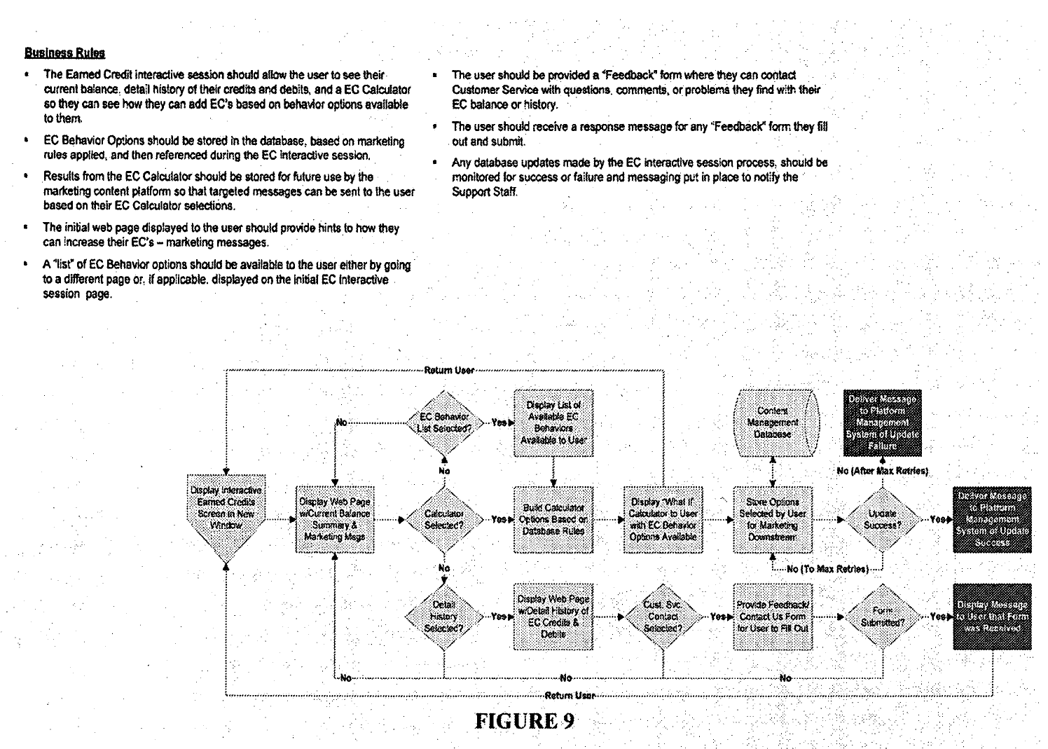

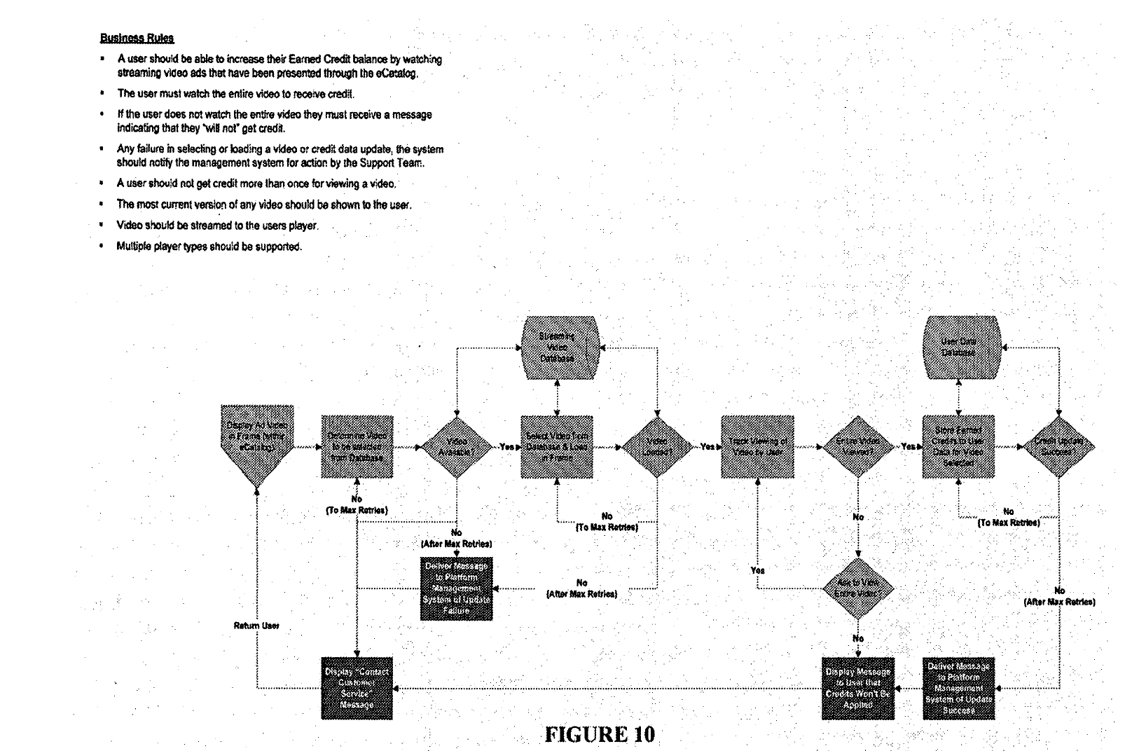

FIGS. 8 and 10 are schematic flow diagrams provided to illustrate how online platforms, such as the Marketplace eCatalog, might be adapted to offer products, services, advertising, and/or other messages. FIG. 8 illustrates an exemplary interface by which a user may be allowed to “point, click, and buy” products and/or services such as income protection insurance. The term “OS1” as used in FIG. 8 shall refer to a third party vendor of products and/or services. FIG. 10 illustrates an exemplary interface by which an enterprise might entice a consumer to watch advertising or other messages through allocation of earned credits. Such credits could then be used to purchase products or services offered by the enterprise or through the enterprise on behalf of third party.

Various embodiments of the present invention may be realized through the implementation of an Initiation Plan as described below. The Exemplary Initiation Plan set forth below is provided merely for illustration purposes and should not be viewed as limiting.

### Exemplary Initiation Plan

As described above, various embodiments of the invention may employ Secondary Application Services Platform (SASP™) technology. In one embodiment, SASP™ technology may implemented by a commercial enterprise, bank, and/or institution (“Customer”) through an outsourcing agent such as Critical Point Group (“CPG”). Said differently, the SASP™ technology and systems structured in accordance with various embodiments of the invention may be offered to banks, commercial enterprises, etc., by a company such as the present applicant, namely, CPG. Accordingly, references provided in the foregoing specification to CPG are intended to apply to any entity that is manufacturing, using, and/offering for sale systems structured in accordance with the various embodiments of the present invention. Listed below are a few steps/tasks that may be undertaken by such entities in accordance with one embodiment of the invention:

I. Establish SASP Platform
a. Secure Host Data Integration and Transfer
   i. CPG will work with Customer to develop the secure data transfer of Customer data to CPG's SASP platform.
   ii. CPG to provide SASP security specifications.
   iii. CPG to provide data integration specifications.
b. Core Checking Account Analytics
   i. Data received from Customer will be analyzed and processed. From this processing the SASP platform provides the following:
      1. Consumer business rules based checking account value based on specific performance characteristics to be established in cooperation with the Customer.
      2. Monthly calculation and reporting of consumer Earned Value Rewards based on business rules to be determined for account performance.
      3. Monthly calculation and reporting of consumer risk score based on the above and other commercially available third-party data.

II. Secondary CPG Products
a. Income Continuation Solution (ICS)
   i. CPG will work with Customer to develop a unique risk based ICS solution for its consumer customers.
   ii. Variations of ICS will be developed and marketed under Customer's brand.
   iii. CPG will provide the eCommerce interface to enable Customer's consumers to enroll for product and/or services and acquired ICS coverage upgrades.
      1. CPG will be responsible for establishing and maintaining this interface.
   iv. CPG will provide third party administration for ICS.
b. Other Products
   i. CPG will review with Customer any and all secondary products and services for possible promotion to its consumers and markets under its brand.
   ii. Customer's approval of the Other Products is required prior to CPG promotion or marketing of said products under its brand or as part of the services provided to the Customer.

III. Marketing Services
a. A first phase of the implementation may focus on a specific geographical market.
b. CPG will provide direct marketing services, including creative and fulfillment to the Customer.
   i. Customer will provide access to authorized personnel for proper and timely approval of all direct mail produced by CPG prior to fulfillment.
c. CPG will also develop custom “Marketplace” statements under Customers brand. This document will include information and news about Customer, Earned Value Rewards summary, ICS product coverage status and “buy-up” options, other CPG secondary products, third-party coupons, Customer products and services, and other information deemed valuable to the Customer's consumers.
   i. Customer will provide access to authorized personnel for proper and timely approval of all “Marketplace” statements produced by CPG prior to fulfillment.

Implementation of apparatuses, systems, and methods for offering products or services in accordance with various embodiments of the present invention may involve acquisition and analysis of various types of data. This data may include customer information file data, customer account data, branch/banking center zip code file—new mover data, prospect file data, commercial account file data, customer insurance coverage data, customer ACH billing data, and other types of data as described above or that will be apparent to one of skill in the art in view of this disclosure. Exemplary data of the type described above is provided below for illustration purposes. The “required” and “optional” notation associated with each type of data is provided to illustrate a specific implementation of a single embodiment of the invention and is not intended to limit all embodiments of the invention.

Customer Information File Data

| | (R)equired or |
|---|---|
| Data Variable | (O)ptional |
| Primary First Name | R |
| Primary Last Name | R |
| Primary Middle Name | O |
| Primary Street Address 1 | R |
| Primary Street Address 2 | O |
| Primary City | R |
| Primary State | R |
| Primary Zip code | R |
| Primary Social Security Number | R |
| Primary Credit Score | R |
| Primary Gender | R |
| Primary Marital Status | R |
| Primary Dependents | R |
| Primary Email Address | O |
| Primary Phone Number | O |
| Primary Preferred Language | O |
| Primary Country | O |
| Secondary First Name | R |
| Secondary Last Name | R |
| Secondary Middle Name | O |
| Secondary Street Address 1 | R |
| Secondary Street Address 2 | O |
| Secondary City | R |
| Secondary State | R |
| Secondary Zip code | R |
| Secondary Social Security Number | R |
| Secondary Credit Score | R |
| Secondary Gender | R |
| Secondary Marital Status | R |
| Secondary Dependents | R |
| Secondary Email Address | O |
| Secondary Phone Number | O |
| Secondary Preferred Language | O |
| Secondary Country | O |

Customer Account Data

| | (R)equired or |
|---|---|
| Data Variable | (O)ptional |
| Account Number | R |
| Account Name | R |
| Account Type Code | R |
| Account Type Name | R |
| Statement Date | R |
| Statement Period | R |
| Number of Days in period | R |
| Beginning Balance | R |
| Ending Balance | R |
| Average Available Balance for period | R |
| Average Daily Balance for period | R |
| Number of Deposit transactions for period | R |
| Amount of Deposit transactions for period | R |
| Number of Deposit transactions by teller for period | R |
| Amount of Deposit transactions by teller for period | R |
| Number of Direct Deposit transactions for period | R |
| Amount of Direct Deposit transactions for period | R |
| Number of ATM Deposit transactions for period | R |
| Amount of ATM Deposit transactions for period | R |
| Number of Debit transactions for period | R |
| Amount of Debit transactions for period | R |
| Number of Debit transactions by Check for period | R |
| Amount of Debit transactions by Check for period | R |
| Number of ATM withdrawals for period | R |
| Amount of ATM withdrawals for period | R |
| Number of OLB/ACH transactions for period | R |
| Amount of OLB/ACH transactions for period | R |
| Number of Signature based transactions for period | R |
| Amount of Signature based transactions for period | R |
| Number of PIN based transactions for period | R |
| Amount of PIN based transactions for period | R |
| Interest paid for the period | R |
| Service charge for the period | R |
| E-statement receipt | R |
| Multi-product indicator | R |
| Savings Account | R |
| Savings account balance | R |
| Credit Card indicator | R |
| Credit card balance | R |
| Mortgage indicator | R |
| Mortgage balance | R |
| Line of Credit Indicator | R |
| Line of Credit Balance | R |
| Investment Indicator | R |
| Investment balance | R |
| Insurance indicator | R |
| Insurance products | R |

Branch/Banking Center Zip Code File—New Mover Data

| | (R)equired or |
|---|---|
| Data Variable | (O)ptional |
| Branch/Banking Center Number | R |
| Branch/Banking Center Name | R |
| Zip codes Served (Multiple entries per branch) | R |

Prospect File Data

A monthly file update may be required to effectively personalize solicitations to the non-customers/prospects within a designated target market(s). In one embodiment, this file may include names and addresses of all prospects within a 5-mile radius of the target branch/banking centers.

| | (R)equired or |
|---|---|
| Data Variable | (O)ptional |
| First Name | R |
| Last Name | R |
| Middle Name | O |
| Street Address 1 | R |
| Street Address 2 | O |
| City | R |
| State | R |
| Zip code | R |

Commercial Account File Data

A monthly file update may be required to effectively personalize solicitations to the non-customers/prospects of commercial businesses within the designated target market(s). In one embodiment, this file should include names and addresses of all employees of existing commercial accounts for the target branch/banking centers.

| | (R)equired or |
|---|---|
| Data Variable | (O)ptional |
| First Name | R |
| Last Name | R |
| Middle Name | O |
| Street Address 1 | R |
| Street Address 2 | O |
| City | R |
| State | R |
| Zip code | R |

Bank Inbound Data Requirements

Customer Insurance Coverage Data

| | (R)equired or |
|---|---|
| Data Variable | (O)ptional |
| Primary First Name | R |
| Primary Middle Name | R |
| Primary Last Name | R |
| Primary Address | R |
| Primary City | R |
| Primary State | R |
| Primary Zip code | R |
| Account Number | R |
| Life Coverage Amount | R |
| Life Coverage Indicator | R |
| Life Coverage Product Type | R |
| Life Coverage Period | R |
| ID Theft Amount | R |
| ID Theft Indicator | R |
| ID Theft Product Type | R |
| ID Theft Coverage Period | R |
| Disability Coverage Amount | R |
| Disability Coverage Indicator | R |
| Disability Coverage Product Type | R |
| Disability Coverage Period | R |
| Unemployment Coverage Amount | R |
| Unemployment Coverage Indicator | R |
| Unemployment Coverage Product Type | R |
| Unemployment Coverage Period | R |
| Income Interruption Coverage Amount | R |
| Income Interruption Coverage Indicator | R |
| Income Interruption Coverage Product Type | R |
| Income Interruption Coverage Period | R |

Customer ACH Billing Data

| | (R)equired or |
|---|---|
| Data Variable | (O)ptional |
| Primary First Name | R |
| Primary Middle Name | R |
| Primary Last Name | R |
| Primary Address | R |
| Primary City | R |
| Primary State | R |
| Primary Zip code | R |
| Account Number | R |
| Debit Account Number | R |
| Credit Account Number | R |
| Debit Amount | R |
| Credit Amount | R |
| Transaction Date | R |

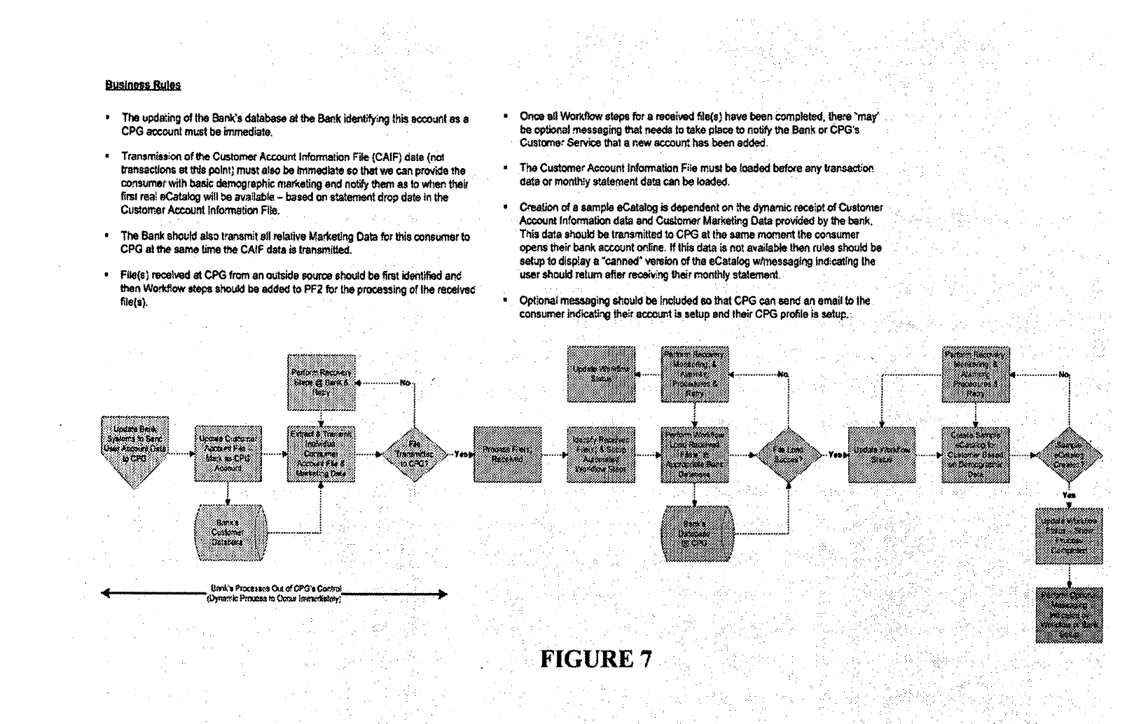

FIG. 7 is a schematic illustration of one exemplary process by which a bank may manage, transmit, and update data to CPG (i.e., the SASP™ system) in accordance with one embodiment of the present invention. The inventive concepts provided herein are not limited to the depicted data flow as multiple methods for ensuring such data transfer may be apparent to persons skilled in the art in view of this disclosure.

Another embodiment of the invention is directed to a system and product that includes the use of a bank checking account that can be connected to insurance coverage. For example, a banking consumer can purchase insurance coverage for unexpected events that may affect the historical deposits and withdrawals relating to the checking accounts. Additionally, insurance coverage other than that of the checking account itself can be included, such as life insurance, so long as the account remains active. Accordingly, the present embodiment can integrate the purchase of insurance into a positive banking experience.

This embodiment allows account holders to purchase through the checking account, coverage that provides for the continuation of the account's historic deposit levels, for a time they deem appropriate, in the event of unforeseen life emergencies. Additionally, the present embodiment can be completely automated and accessible through the Internet, such as through a centralized database.

One feature of this embodiment is the use of bank checking accounts in combination with insurance policies that can provide coverage for sustaining historic deposit levels. By allowing the account holder to purchase protection for their deposit flow (within the framework of the core checking account) in the event of a negative life event, the present embodiment provides the account holder with an incentive to consolidate deposit accounts from other institutions into the insured account by offering reduced coverage costs for increased deposit levels.

From the bank's perspective, banks want to move customers to internet banking and electronic bill pay. Further, anything that enhances customer loyalty, as well as growing deposits, is desirable to banks. Establishing and retaining new accounts at a low cost is also positive. Unique, high-value, easily sold, and quickly understood products are desirable. Getting a wealth management representative to a household first and ahead of a wealth transfer is desirable. Products that bring new prospects and existing account holders into the branches' lobby for financial counseling at a time when a deposit relationship may be at risk is desirable. Reducing “unnoticed” deposit evaporation is desirable. It is desirable for a bank's checking account and/or online banking services to be viewed as superior to competing products. Automatically converting basic checking accounts into elementary, but potentially high value asset accounts that provide the bank with an enhanced view of the account holders growing or diminishing appetite for additional financial products is also a good thing. Minimizing branch traffic that does not generate income, increase deposits, or create a sales opportunity is desirable. Turning obligatory customer service functions into revenue opportunities is desirable. Giving account holders high value reasons to consolidate other accounts from other banks into your bank is desirable. Banks would like to be viewed by the consumer as first among many available financial options. Banks would like to be the aggregator of its customer's money.

Generally, bank customers do not seek our life insurance, rather, it must be actively sold to them. One can go a long time without insurance without noticing the absence. One only needs it when something bad happens such as the death of a bread winner, a job loss, a divorce, a disability, or other income reducing event. Customers appreciate privacy, ease of purchase, straightforward product presentation, flexibility and control over features and benefits, rewards and benefits for being loyal and want maximum return for the deposits they keep with the bank, simple integrated statements with color, graphs, etc., bank branches and personal interaction, especially when they think they've got something important to talk about. The kinds of life events the present invention can provide benefits for can always bring the account holder into the branches. Those customers who use on-line banking and bill pay are loyal and usually a little more affluent than the average checking account customer. They also tend to have more than one relationship with the bank. Customers do not like the Check 21 law and the fees associated with courtesy overdraft protection.

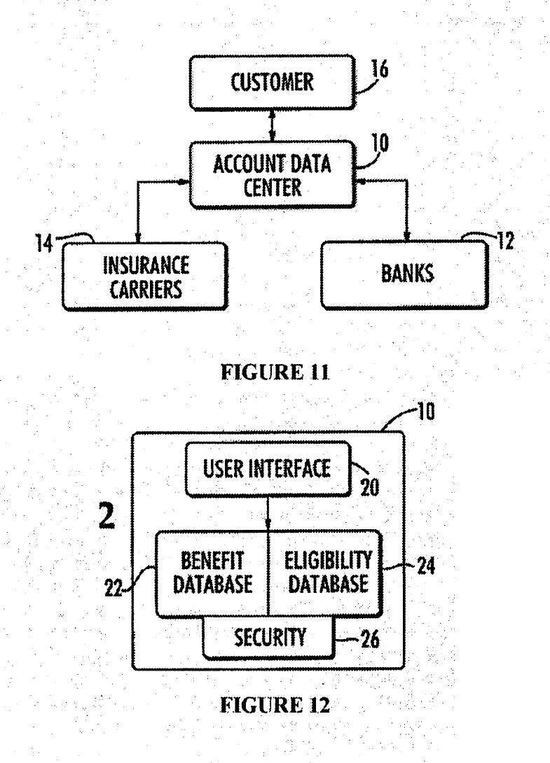

As illustrated in FIGS. 11-13, one embodiment of the present invention includes a checking account system. Notably, automation, networking, and near real time transaction updates have transformed the common checking account into an account that is a life mirror that moves in parallel to a customer's daily commercial activity. In many cases, this commercial activity is pushed very near the full extent of a consumer's personal financial resources. If an income interruption occurs, many consumers may not have sufficient funds on hand to support outstanding debts, life style commitments, etc.

In view of the above, one embodiment of the present invention provides a system whereby a customer 16 can purchase insurance coverage for their deposit flow. As illustrated, the customer 16 can be provided access to an account data center 10, which can include benefits and eligibility information in addition to the standard account information. Through a user interface 20, the customer 16 can access a benefits database 22 to obtain a customized coverage plan for their particular checking account. If eligible, the customer 16 can then be provided with a policy that is entered into and managed at the eligibility database 24. Both banks 12 and insurance carriers 14 can have access to the account data center 10 for purposes of generally managing the policies and accounts, as well as to continue to provide updated information about the policies and accounts. The accounts can include a security feature 26, whereby customers 16 enter their bank account code or password to access their insured accounts.

As discussed, a feature of the present invention is to provide a checking account that can be insured with a policy that provides coverage for deposit history. By allowing the account holder to assume responsibility for the unforeseen by purchasing protection for their deposit flow (from inside the core checking account) in the event of a negative life event, customers can buy time with “new cash” they do not have to pay back. The good news is that these account holders will get well, get hired, get focused, develop new relationships, and their hearts will heal. Their lives will go on. All they need is a little time to get their lives back together without their financial world collapsing around them bringing long term negative consequences.

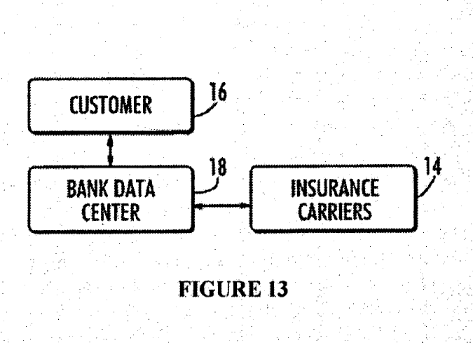

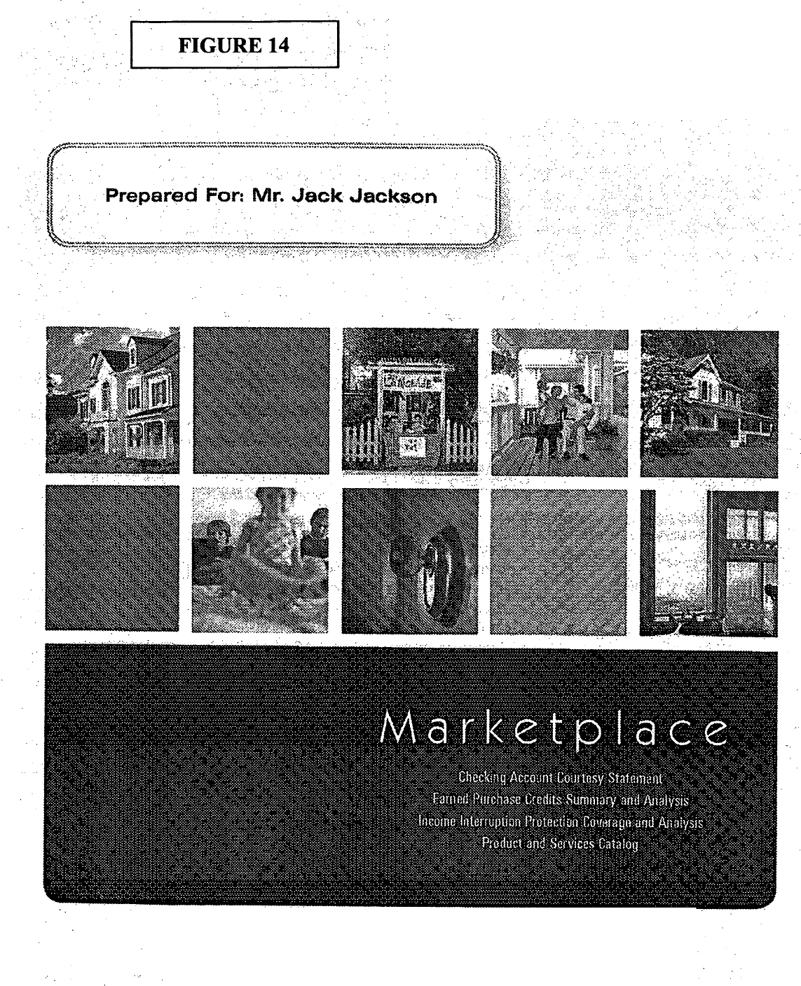

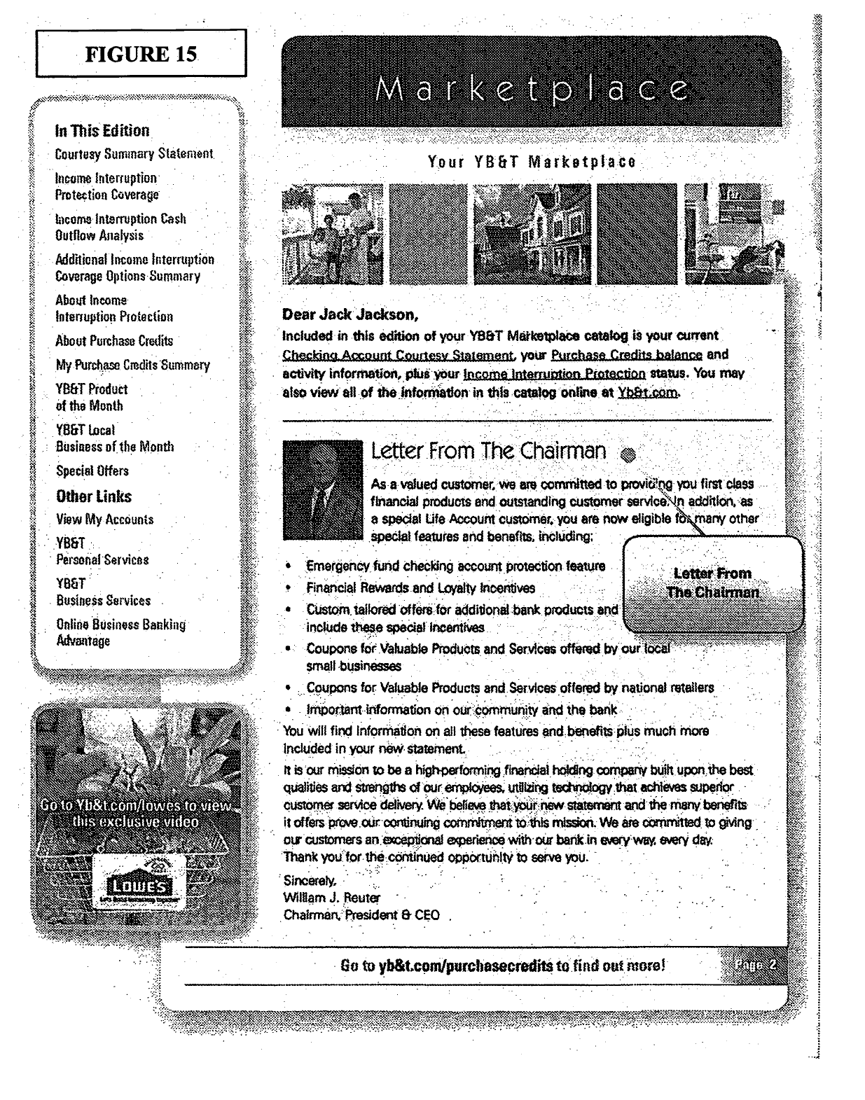

Some embodiments of the present invention provide for the conscious design of insurance offerings that require sophisticated business rules and client integration up front, and complex execution and fulfillment on the backend. Such embodiments can be completely automated and can take full advantage of digital print, email, and website presentation. Traditional low value AD&D/Life mass market mail offerings can be avoided. Furthermore, the checking accounts can be managed in a number of ways by a number of industries. A third party manager not associated with either banks 12 or insurance carriers 14 can provide the database. Alternatively, the banks 12 themselves can mange the accounts, as shown in FIG. 13. Because of potential for impact on deposit and revenue growth, the account information may also be handled by regular product development groups reporting to the CMO as opposed to the insurance department.

The present invention can include many alternative embodiments considering the complexities of both the banking and insurance industries. Accordingly, the following examples are provided for descriptive purposes only. First, the customer 16 can be provided with an offer or promotion. For example, the promotion can explain that loyalty in online banking community can be rewarded with personalized, high value, easy to acquire, easy to modify, and reasonably priced account protection for some of life's unforeseen events. The potential for income interruption resulting in a reduced quality of life can be brought on by at least four, if not more, difficult and stressing real life events is common to all family units today. These can be: death of one of the income producing joint account holders; temporary or long term disability of a joint account holder; divorce; salary interruption; and the like.

While employers may provide many of these benefits to help protect the family against some of these events, by and large, employees today are nervous about their employment status. They also often wonder about the real dollar value of various components of their company benefit package as well as all the rules that determine how and when they become eligible.

Traditionally, consumers can call an insurance agent and buy all sorts of insurance protections. However, typically, the average consumer seeks only the minimal insurance coverage possible. Therefore, many account holders drift for years with no real protection from the above referenced life disrupting events, as well as other events. Furthermore, two of the big four, divorce and salary interruption, are not provided for at all. Also, the account holder's required coverage may need to vary over time and their ability to pay for premiums may vary. Sometimes needs change almost on a month-to-month basis.

Studies indicate that one of the main reasons consumers 16 do not call an insurance agent is that they are afraid they will be sold too much of the wrong kind of coverage and wind up with a monthly premium they cannot afford, which leads to cancellations. One embodiment of the present invention provides a mechanism to achieve reasonable cost yet high value (in the mind of the account holder) benefits that match the account holder's needs, automatically, at any point in time for probable life emergencies. These benefits may not be intended to totally replace the requirement for the account holder to do proper financial planning, but rather to be considered a part of their total protection.

The above benefit packages can be monitored through an automated transaction account, because the core transaction (checking) is the only repository of all the account data necessary to process and maintain sophisticated variable benefit products of the present invention. Various embodiments of the present invention can be an add-on or a supplement to a bank checking account, preferably an online banking enabled account with automatic payroll deposit and electronic bill pay options. Managing the account holders benefit profile and automatic fulfillment of marketing and account materials can accomplished through a secure connection to the benefit database that can be housed in the account datacenter 10, or alternatively behind the bank's 12 firewall. At all times, the account holder, when online, can seamlessly branch to a series of Internet based screens hosted by web servers to read and print marketing materials, use benefit calculators, order additional coverages, and/or purchase various third party or bank supplied products or services. In one embodiment, the system will recommend minimum/maximum benefit amounts derived from an analysis of certain historical account data and offer add/change/delete benefit suggestions. In various embodiments, this functionality may be provided under the account holder's existing bank sign-in and password.

In the depicted embodiment, once the account holder has chosen a benefit and all approvals are done on-line, the system can add the account holder to the eligibility file 24 it manages. It is envisioned that this dynamic eligibility database 24 will only be housed by a single source provider. However, in alternate embodiments, multiple source providers may be used. Depending upon selected security protocols, authorized employees of the source providers, insurance carriers 14, and client banks 12 may be provided real-time remote access to system information. Further, the Internet can allow all parties to work from the same file in a secure manner.

In one embodiment, exemplary account holder criteria may include OLB customer for one year—currently active, joint account, automatic payroll deposit, average balance, transaction velocity, no NSF or OD history in the last year, eBill pay desirable, credit score, others such as Check Card, Credit Card, HELOC, Overdraft Protection.

The precise composition of the criteria selected for a given application may be a function of the requirements of the insurance underwriter's needs and the bank's analytics used to rate account holders for qualification in any program.

In one embodiment, there can be two eligibility files 24 managed by a single source provider. One for the “thank you” product and another for the more complicated variable benefit product buyers. The former requires daily feeds of new “accepts” and account maintenance such as dropping an account signatory or account closure. The latter will require interaction with the account statement-ing and service charge cycle, and data warehouse account record.

The local branch of banks 12 can be the point of notification for claims. Any of the life events we're discussing here now bring the account holder into the branch. For the most part, these visits are viewed as an expense and little effort is made to cause something positive to happen. In the present invention, these events can be used as “trip wires,” the first harbinger that the account is at risk and secondary wealth transfer events are probable. The present product and approach can make it virtually impossible for accounts to close and new wealth to wind up in another financial institution without the branch sales force having a chance to secure those deposits and services.

Death certificates and divorce papers can be presented everyday at bank branches to settle accounts, divide money up, drill safe deposit boxes, etc. Copies are often made for the bank's records. This is branch work that cannot be avoided, but various embodiments of the present invention can convert these chores into revenue generating opportunities. For example, the death certificate, divorce papers, termination papers, and medical temporary disability papers can be faxed to the single source provider by the branch. This will trigger two major activities. One will branch into an expedited claims process which will generate a series of triggers for automated new account setup, deposit transfer, automated calling officer appointments, and various notifications. Temporary check and debit card production along with marketing materials can also be mailed by the single source provider to the account holder.

The following describes a sample promotion configured in accordance with one embodiment of the present invention. An email is sent to each qualifying online banking (OLB) account holder advising them that they have qualified for a free gift of $5,000 in life insurance for each account holder just because the bank wants to reward such good customers. As long as they continue as good OLB customers, the insurance will remain in force. The email will also be crafted to point to a bank branded web site that will offer the expanded benefit coverage mentioned earlier and how to buy it.

In one embodiment, if the consumer accepts the free $5,000 benefit, they must check the Accept Box which is then routed to the single source provider. The single source can then extract the policy holders' individual account names, add them to the eligibility database, print the certificates, and mail them to the account holders. This benefit remains in force as long as both account holders are owners of the original account and they are active OLB users.

Those skilled in the art of banking and insurance systems will recognize that many substitutions and modifications can be made in the foregoing preferred embodiment with departing from the spirit and scope of the present invention.

That which is claimed:

1. A system comprising:
a processor;
a memory for storing data coupled to the processor, the memory comprising user data, user account data, and relationship data;
wherein the processor is configured for:
calculating an account valuation score based at least in part on the user data, user account data, or relationship data,
calculating a risk score based at least in part on the user data, user account data, or relationship data,
outputting a set of products or services based at least in part on the risk score, and
pricing the set of products or services based at least in part on the account valuation.

2. The system of claim 1, wherein the user data comprises at least one of the following: user name, address, social security number, credit score, gender, marital status, dependant information, email address information, phone number, and primary preferred language.

3. The system of claim 1, wherein the user account data comprises at least one of the following: account number, account name, account type, statement date, statement period, number of time intervals (hours, days, weeks, months, quarters, etc.) in the period, beginning balance, ending balance, average available balance for period, average daily balance for period, number of deposit transactions for period, amount of deposit transactions for period, number of deposit transactions by teller for period, amount of deposit transactions by teller for period, number of direct deposit transactions for period, amount of direct deposit transactions for period, number of automated teller (“ATM”) deposit transactions for period, amount of ATM deposit transactions for period, number of debit transactions for period, amount of debit transactions for period, number of debit transactions by check for period, amount of debit transactions by check for period, number of OLB/ACH transactions for period, amount of OLB/ACH transactions for period, number of signature based transactions for period, amount of signature based transactions for period, number of personal identification number (“PIN”) based transactions for period, amount of PIN based transactions for period, interest paid for period, service charge for period, E-statement receipt.

4. The system of claim 1, wherein the relationship data comprises at least one of the following: a multi-product indicator, savings account indicator, credit card indicator, mortgage indicator, line of credit indicator, other loan indicator, investment indicator, insurance indicator, insurance product information, total number of affiliated party transactions, type of affiliated party transactions, amount of affiliated party transactions, number of affiliated party transactions per period, average amount of affiliated party transactions per period, total number of third parties engaged, number of third parties engaged per period, number of third party transactions per period, frequency of third party transactions per period, product category indicators for third party transactions, and service category indicators for third party transactions.

5. The system of claim 1, wherein the set of products or services includes at least one of the following: financial products, financial services, insurance products, insurance services, consumer products, and consumer services.

6. The system of claim 1, wherein the processor further outputs a description of the set of products or services to a user interface such that a user may purchase one or more products or services from among the set of products or services.

7. The system of claim 6, wherein the user interface is an interactive Internet based account statement.

8. The system of claim 6, wherein the user interface is a static or printed account statement that is transmitted to a user at a periodic interval.

9. The system of claim 1, wherein pricing the set of products or services based at least in part on the account valuation comprises allocating earned credits based at least in part on the user data, the user account data, or the relationship data.

10. A system comprising:
a processor;
a memory for storing data coupled to the processor, the memory comprising user data, user account data, and relationship data;
wherein the processor is configured for:
calculating a risk score based at least in part on the user data, user account data, or relationship data,
outputting a set of products or services based at least in part on the risk score.

11. The system of claim 10, wherein the user data comprises at least one of the following: user name, address, social security number, credit score, gender, marital status, dependant information, email address information, phone number, and primary preferred language.

12. The system of claim 10, wherein the user account data comprises at least one of the following: account number, account name, account type, statement date, statement period, number of time intervals (hours, days, weeks, months, quarters, etc.) in the period, beginning balance, ending balance, average available balance for period, average daily balance for period, number of deposit transactions for period, amount of deposit transactions for period, number of deposit transactions by teller for period, amount of deposit transactions by teller for period, number of direct deposit transactions for period, amount of direct deposit transactions for period, number of automated teller (“ATM”) deposit transactions for period, amount of ATM deposit transactions for period, number of debit transactions for period, amount of debit transactions for period, number of debit transactions by check for period, amount of debit transactions by check for period, number of OLB/ACH transactions for period, amount of OLB/ACH transactions for period, number of signature based transactions for period, amount of signature based transactions for period, number of personal identification number (“PIN”) based transactions for period, amount of PIN based transactions for period, interest paid for period, service charge for period, E-statement receipt.

13. The system of claim 10, wherein the relationship data comprises at least one of the following: a multi-product indicator, savings account indicator, credit card indicator, mortgage indicator, line of credit indicator, other loan indicator, investment indicator, insurance indicator, insurance product information, total number of affiliated party transactions, type of affiliated party transactions, amount of affiliated party transactions, number of affiliated party transactions per period, average amount of affiliated party transactions per period, total number of third parties engaged, number of third parties engaged per period, number of third party transactions per period, frequency of third party transactions per period, product category indicators for third party transactions, and service category indicators for third party transactions.

14. The system of claim 10, wherein the set of products or services includes at least one of the following: financial products, financial services, insurance products, insurance services, consumer products, and consumer services.

15. The system of claim 10, wherein the processor further outputs a description of the set of products or services to a user interface such that a user may purchase one or more products or services from among the set of products or services.

16. The system of claim 15, wherein the user interface is an interactive Internet based account statement.

17. The system of claim 15, wherein the user interface is a static or printed account statement that is transmitted to a user at a periodic interval.

18. A method comprising:
establishing a user account that is associated with user data, user account data, and relationship data;
calculating a risk score based at least in part on the user data, user account data, or relationship data; and
outputting a set of products or services based at least in part on the risk score.

19. The method of claim 18, wherein the user data comprises at least one of the following: user name, address, social security number, credit score, gender, marital status, dependant information, email address information, phone number, and primary preferred language.

20. The method of claim 18, wherein the user account data comprises at least one of the following: account number, account name, account type, statement date, statement period, number of time intervals (hours, days, weeks, months, quarters, etc.) in the period, beginning balance, ending balance, average available balance for period, average daily balance for period, number of deposit transactions for period, amount of deposit transactions for period, number of deposit transactions by teller for period, amount of deposit transactions by teller for period, number of direct deposit transactions for period, amount of direct deposit transactions for period, number of automated teller (“ATM”) deposit transactions for period, amount of ATM deposit transactions for period, number of debit transactions for period, amount of debit transactions for period, number of debit transactions by check for period, amount of debit transactions by check for period, number of OLB/ACH transactions for period, amount of OLB/ACH transactions for period, number of signature based transactions for period, amount of signature based transactions for period, number of personal identification number (“PIN”) based transactions for period, amount of PIN based transactions for period, interest paid for period, service charge for period, E-statement receipt.

21. The method of claim 18, wherein the relationship data comprises at least one of the following: a multi-product indicator, savings account indicator, credit card indicator, mortgage indicator, line of credit indicator, other loan indicator, investment indicator, insurance indicator, insurance product information, total number of affiliated party transactions, type of affiliated party transactions, amount of affiliated party transactions, number of affiliated party transactions per period, average amount of affiliated party transactions per period, total number of third parties engaged, number of third parties engaged per period, number of third party transactions per period, frequency of third party transactions per period, product category indicators for third party transactions, and service category indicators for third party transactions.

22. The method of claim 18, wherein the set of products or services includes at least one of the following: financial products, financial services, insurance products, insurance services, consumer products, and consumer services.

23. The method of claim 18, further comprising outputting a description of the set of products or services to a user interface such that a user may purchase one or more products or services from among the set of products or services.

24. The method of claim 23, wherein the user interface is an interactive Internet based account statement.

25. The system of claim 23, wherein the user interface is a static or printed account statement that is transmitted to a user at a periodic interval.

26. The method of claim 18, further comprising:
calculating an account valuation based at least in part on the user data, user account data, or relationship data; and
pricing the set of products or services based at least in part on the account valuation.

27. The method of claim 26, wherein the user data comprises at least one of the following: user name, address, social security number, credit score, gender, marital status, dependant information, email address information, phone number, and primary preferred language.

28. The method of claim 26, wherein the user account data comprises at least one of the following: account number, account name, account type, statement date, statement period, number of time intervals (hours, days, weeks, months, quarters, etc.) in the period, beginning balance, ending balance, average available balance for period, average daily balance for period, number of deposit transactions for period, amount of deposit transactions for period, number of deposit transactions by teller for period, amount of deposit transactions by teller for period, number of direct deposit transactions for period, amount of direct deposit transactions for period, number of automated teller (“ATM”) deposit transactions for period, amount of ATM deposit transactions for period, number of debit transactions for period, amount of debit transactions for period, number of debit transactions by check for period, amount of debit transactions by check for period, number of OLB/ACH transactions for period, amount of OLB/ACH transactions for period, number of signature based transactions for period, amount of signature based transactions for period, number of personal identification number (“PIN”) based transactions for period, amount of PIN based transactions for period, interest paid for period, service charge for period, E-statement receipt.

29. The method of claim 26, wherein the relationship data comprises at least one of the following: a multi-product indicator, savings account indicator, credit card indicator, mortgage indicator, line of credit indicator, other loan indicator, investment indicator, insurance indicator, insurance product information, total number of affiliated party transactions, type of affiliated party transactions, amount of affiliated party transactions, number of affiliated party transactions per period, average amount of affiliated party transactions per period, total number of third parties engaged, number of third parties engaged per period, number of third party transactions per period, frequency of third party transactions per period, product category indicators for third party transactions, and service category indicators for third party transactions.

30. The method of claim 26, wherein the set of products or services includes at least one of the following: financial products, financial services, insurance products, insurance services, consumer products, and consumer services.

31. The method of claim 26, further comprising outputting a description of the set of products or services to a user interface such that a user may purchase one or more products or services from among the set of products or services.

32. The method of claim 31, wherein the user interface is an interactive Internet based account statement.

33. The method of claim 31, wherein the user interface is a static or printed account statement that is transmitted to a user at a periodic interval.

34. The method of claim 26, wherein pricing the set of products or services based at least in part on the account valuation comprises allocating earned credits based at least in part on the user data, the user account data, or the relationship data.
